(19) United States
(12) Patent Application Publication
(10) Pub. No.: US 2007/0248851 A1
(43) Pub. Date: Oct. 25, 2007

(54) Fuel cell power system having dock-type device, and technique for controlling and/or operating same

(76) Inventors: Andrew Paul Wallace, Davis, CA (US); Rodney Sparks, Sacramento, CA (US)

Correspondence Address: NEIL A. STEINBERG, 2665 MARINE WAY, SUITE 1150, MOUNTAIN VIEW, CA, 94043, US

(21) Appl. No.: 11/789,378

(22) Filed: Apr. 24, 2007

Related U.S. Application Data
(60) Provisional application No. 60/794,437, filed on Apr. 24, 2006.

(51) Int. Cl. H01M 8/00; H01M 8/24; H01M 2/02

(52) U.S. Cl. 429/13; 429/18; 429/34

(57) ABSTRACT

There are many inventions described and illustrated herein. In one aspect, the inventions relate to a fuel cell power system comprising (i) a plurality of removable fuel storage cartridges, each cartridge having a vessel to store hydrogen (for example, hydrogen, methanol and/or hydrogen containing compounds or substances from which hydrogen can be extracted on demand (e.g., a hydride)), and (ii) dock-type unit. The dock-type unit comprises a fluid bus, an electrical bus, and a plurality interfaces, each interface including a fluid portion coupled to the fluid bus and an electrical portion coupled to the electrical bus, wherein the each fuel storage cartridge is coupled to an associated interface. The dock-type unit further includes a fuel cell power unit, including a plurality of hydrogen fuel cells, connected to the fluid bus to (i) concurrently receive hydrogen from the plurality of fuel storage cartridges and (ii) generate unconditioned electrical power using the hydrogen. Control circuitry is disposed in/on the dock-type unit and electrically coupled to the fuel storage cartridges via the electrical bus to monitor the state of fill of each of the fuel storage cartridges during operation of the fuel cell power system.

### CROSS-REFERENCE TO RELATED APPLICATIONS

This application claims priority to U.S. Provisional Application Ser. No. 60/794,437, entitled “Fuel Cell Power System Having Dock-Type Device”, filed Apr. 24, 2006 (hereinafter “the Provisional Application”). The contents of the Provisional Application are incorporated by reference herein in their entirety.

### BACKGROUND OF THE INVENTION

This invention relates to fuel cell power and management systems, and techniques for controlling and/or operating such systems; and more particularly, in one aspect, to fuel cell power and management systems, for example, hydrogen and/or methanol based systems, as well as components, elements and/or subsystems therefore.

Generally, small portable electrical and electronic devices often employ batteries as a power source. However, conventional batteries have limited energy storage capacity and must either be discarded or recharged after they have depleted their limited energy storage capacity. If thrown away, conventional batteries present environmental hazards because of the toxic material used in manufacturing the batteries. If recharged, the recharging process of conventional batteries is time consuming and as the age of these batteries increases it becomes more and more difficult to determine the state of charge of the battery. In this regard, the life becomes unpredictable and unreliable, and so the user/operator often discards the batteries before the useful life is complete, thus incurring additional cost by the user/operator having to carry extra batteries. Applications like professional video cameras, laptop computers, and cell phones often require longer runtimes than conventional batteries can provide.

In addition to battery based systems, fuel cell systems may be employed to provide a portable source of electrical power. In one embodiment, fuel cell systems employ, for example, hydrogen, hydrogen rich gas, hydrogen containing compound or a substance from which hydrogen can be extracted on demand (i.e., a hydride storage cartridge). Such fuel cell systems typically include an anode end for splitting hydrogen atoms into electrons and protons, a current bearing portion providing a pathway for the electrons, a medium such as a proton exchange membrane providing a pathway for the protons, and a cathode end for combining the electrons and protons with oxygen from, for example, the surrounding atmosphere, thereby forming water. Conventional fuel cells often generate electricity over a longer time period than conventional batteries, provided that the fuel (for example, hydrogen) in the storage container is periodically refreshed. (See, for example, U.S. Pat. Nos. 5,683,828, 5,858,567, 5,863,671 and 6,051,331).

### SUMMARY OF THE INVENTIONS

There are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein.

In one aspect, the present inventions (as claimed in this application) are directed to a fuel cell power system comprising (1) a plurality of removable fuel storage cartridges, each cartridge having a vessel to store hydrogen, and (2) a dock-type unit. The dock-type unit in this aspect of the present inventions includes (i) a fluid bus, (ii) an electrical bus, (iii) a plurality interfaces, each interface including a fluid portion coupled to the fluid bus and an electrical portion coupled to the electrical bus, wherein the each fuel storage cartridge is coupled to an associated interface, (iv) a fuel cell power unit, including a plurality of hydrogen fuel cells, connected to the fluid bus to (a) concurrently receive hydrogen from the plurality of fuel storage cartridges and (b) generate unconditioned electrical power using the hydrogen, and (v) control circuitry, disposed in/on the dock-type unit and electrically coupled to the fuel storage cartridges via the electrical bus, to monitor the state of fill of each of the fuel storage cartridges during operation of the fuel cell power system.

In one embodiment, the control circuitry monitors the state of fill of each fuel storage cartridge during operation of the fuel cell power system using an initial state of fill provided by the plurality of fuel storage cartridges. In another embodiment, the control circuitry calculates an amount of hydrogen that each fuel storage cartridge outputs during operation of the fuel cell power system.

Notably, each fuel storage cartridge may include a memory and wherein, during operation of the fuel cell power system, the control circuitry calculates the state of fill of each fuel storage cartridge and stores the state of fill in the memory associated therewith. For example, the control circuitry periodically stores the state of fill of each fuel storage cartridge in the memory associated with the fuel storage cartridge.

In yet another embodiment, the control circuitry calculates the state of fill of each fuel storage cartridge during operation of the fuel cell power system using an initial state of fill provided by the plurality of fuel storage cartridges. In this embodiment, the control circuitry may calculate an amount of hydrogen that each fuel storage cartridge outputs during operation of the fuel cell power system using the initial state of provided by the plurality of fuel storage cartridges. Further, the each fuel storage cartridge, in this embodiment, may include a memory and wherein, during operation of the fuel cell power system, the control circuitry stores (for example, periodically, intermittently, and/or in response to one or more predetermined events) the state of fill of each fuel storage cartridge in the memory associated with the fuel storage cartridge.

Indeed, in yet another embodiment, the control circuitry calculates an amount of hydrogen that each fuel storage cartridge outputs during operation of the fuel cell power system.

The dock-type unit may include a fluid manifold having a plurality of inputs coupled to the fluid portion of each interface of the dock-type unit and at least one fluid output coupled to the fuel cell power unit to provide hydrogen to fuel cell power unit. The dock-type unit may further includes at least one pressure regulator, coupled to the fluid bus, to regulate the pressure of the hydrogen input to the fuel cell power unit. In another embodiment, the dock-type unit further includes a plurality of pressure regulators, wherein at least one regulator is coupled to each fluid portion of the plurality interfaces of the dock-type unit to regulate the pressure of the hydrogen input to the fluid bus from each fuel storage cartridge connected to the plurality interfaces.

Notably, the fuel cell power unit may include conditioning circuitry (for example, voltage and/or power conditioning circuitry), coupled to the plurality of hydrogen fuel cells, to generate conditioned electrical power using the unconditioned electrical power.

In another principal aspect, the present inventions (as claimed in this application) are directed to a fuel cell power system comprising a plurality of removable fuel storage cartridges, each cartridge having a vessel to store hydrogen and a non-volatile memory to store data which is representative of the state of fill of hydrogen in the vessel. The fuel cell power system of this aspect further includes a dock-type unit comprising (i) a fluid bus, (ii) an electrical bus, (iii) a plurality interfaces, each interface including a fluid portion coupled to the fluid bus and an electrical portion coupled to the electrical bus, wherein the each fuel storage cartridge is coupled to an associated interface, (iv) a fuel cell power unit and (v) control circuitry.

The fuel cell power unit includes a plurality of hydrogen fuel cells, connected to the fluid bus to (a) concurrently receive hydrogen from the plurality of fuel storage cartridges and (b) generate unconditioned electrical power using the hydrogen. Further, the control circuitry is disposed in/on the dock-type unit and is electrically coupled to the fuel storage cartridges via the electrical bus, to (a) calculate the state of fill of each of the fuel storage cartridges during operation of the fuel cell power system and (b) store data which is representative of the state of fill of fuel in the vessel of the fuel storage cartridge in the non-volatile memory associated with the fuel storage cartridge.

In one embodiment, the control circuitry calculates the state of fill of each fuel storage cartridge during operation of the fuel cell power system using an initial state of fill provided by the plurality of fuel storage cartridges. In another embodiment, the initial state of fill of the fuel storage cartridge is stored in the non-volatile memory associated with the fuel storage cartridge.

The control circuitry may calculate an amount of hydrogen that each fuel storage cartridge outputs during operation of the fuel cell power system. The control circuitry may calculate the amount of hydrogen that each fuel storage cartridge outputs during operation of the fuel cell power system using the initial state of provided by the plurality of fuel storage cartridges.

The control circuitry may store (for example, periodically, intermittently, and/or in response to one or more predetermined events) the state of fill of each fuel storage cartridge in the non-volatile memory associated therewith.

In one embodiment, the dock-type unit further includes a fluid manifold having a plurality of inputs coupled to the fluid portion of each interface of the dock-type unit and at least one fluid output coupled to the fuel cell power unit to provide hydrogen to fuel cell power unit. The dock-type unit may also include at least one pressure regulator, coupled to the fluid bus, to regulate the pressure of the hydrogen input to the fuel cell power unit. Indeed, the dock-type unit may include a plurality of pressure regulators, wherein at least one regulator is coupled to each fluid portion of the plurality interfaces of the dock-type unit to regulate the pressure of the hydrogen input to the fluid bus from each fuel storage cartridge connected to the plurality interfaces.

Notably, the fuel cell power unit may include conditioning circuitry (for example, voltage and/or power conditioning circuitry), coupled to the plurality of hydrogen fuel cells, to generate conditioned electrical power using the unconditioned electrical power.

Again, there are many inventions, and aspects of the inventions, described and illustrated herein. This Summary of the Inventions is not exhaustive of the scope of the present inventions. Moreover, this Summary of the Inventions is not intended to be limiting of the inventions and should not be interpreted in that manner. While certain embodiments have been described and/or outlined in this Summary of the Inventions, it should be understood that the present inventions are not limited to such embodiments, description and/or outline, nor are the claims limited in such a manner. Indeed, many others embodiments, which may be different from and/or similar to the embodiments presented in this Summary, will be apparent from the description, illustrations and claims, which follow. In addition, although various features, attributes and advantages have been described in this Summary of the Inventions and/or are apparent in light thereof, it should be understood that such features, attributes and advantages are not required whether in one, some or all of the embodiments of the present inventions and, indeed, need not be present in any of the embodiments of the present inventions.

### BRIEF DESCRIPTION OF THE DRAWINGS

In the course of the detailed description to follow, reference will be made to the attached drawings. These drawings show different aspects of the present inventions and, where appropriate, reference numerals illustrating like structures, components, materials and/or elements in different figures are labeled similarly. It is understood that various combinations of the structures, components, materials and/or elements, other than those specifically shown, are contemplated and are within the scope of the present inventions.

Moreover, there are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed or illustrated separately herein.

FIGS. 1A and 1D are block diagram representations of an exemplary fuel cell power and management systems, including fuel cell power unit having one or more fuel cell power units and a dock-type device/unit having an interface (for example, fluid, mechanical and/or electrical) for one or more fuel storage canisters or cartridges, according to certain aspects of the present inventions;

FIG. 1B is a block diagram representation of an exemplary interface of the dock-type device/unit which includes a mechanical portion that facilitates physically mating with the fuel storage canisters or cartridges, an electrical portion that allows for, among other things, communication with circuitry disposed on the fuel storage canisters or cartridges, and a fluid portion that provides for fluid communication between the fuel storage canisters or cartridges and the fuel cell power unit;

FIG. 1C is an exemplary interface of the dock-type device/unit which includes a “twist-on” mechanical portion that facilitates mating with the fuel storage canisters or cartridges, an electrical portion that allows for communication with circuitry disposed on the fuel storage canisters or cartridges, and a fluid portion that provides for fluid communication between the fuel storage canisters or cartridges and the fuel cell power unit;

FIG. 2 is a block diagram representation of an exemplary fuel cell power and management system, including fuel cell power unit having one or more fuel cell power units and a dock-type device/unit having a fluid manifold unit coupled to two or more fuel storage canisters or cartridges, according to certain aspects of the present inventions;

FIGS. 3A-3G are block diagram representations of exemplary fluid manifold units which outputs fuel to the fuel cell unit from one or more fuel storage canisters or cartridges, according to certain aspects of the present inventions; notably the fluid manifold unit may comprise a significant portion of or integral with the chassis or housing of the dock-type device/unit;

FIGS. 4A-4F are block diagram representations of exemplary fuel cell power and management systems, including fuel cell power unit having one or more fuel cell power units and a dock-type device/unit having control circuitry connected to an electrical bus, according to certain aspects of the present inventions;

FIGS. 5A and 5B are block diagram representations of an exemplary fuel cell power and management systems having control circuitry which is connected to a user or operator interface unit, according to certain aspects of the present inventions;

FIGS. 6A-6C are block diagram representations of exemplary fuel cell power and management systems, including one or more input ports having one or more external connectors which facilitate connection to the fluid bus of the dock-type device/unit (FIGS. 6A and 6B) and/or electrical bus of the dock-type device/unit (FIGS. 6A and 6C);

FIGS. 6D-6J are block diagram representations of exemplary fuel cell power and management systems, including an external connector which facilitate connection of a first dock-type device/unit to one or more buses of a second dock-type device/unit, for example, the electrical bus (FIGS. 6D and 6G), the fluid bus (FIGS. 6E, 6H and 6J) and/or electrical and fluid busses (FIGS. 6F and 6I) of the second dock-type device/unit;

FIGS. 7A-7G are block diagram representations of exemplary fuel cell power units which may include one or more fuel cell power sub-units, each having one or more fuel cell stacks which generate electrical power using fuel from one or more fuel storage canisters or cartridges, in accordance with certain aspects of the present inventions;

FIGS. 8A-8L are block diagram representations of exemplary fuel cell power units which may include one or more fuel cell power sub-units, each having one or more fuel cell stacks which generate electrical power using fuel from one or more fuel storage canisters or cartridges, coupled to a voltage conditioning unit, including one or more voltage conditioning sub-units which output one or more conditioned voltages, in accordance with certain aspects of the present inventions;

FIGS. 9A-9E are block diagrams representations of exemplary external power interfaces including one or more interfaces, in accordance with certain aspects of the present inventions;

FIGS. 10A-10H are block diagrams representations of exemplary fuel storage cartridges or canisters including a fuel vessel to store or maintain a fuel, in accordance with certain aspects of the present inventions;

FIGS. 11A-11C are block diagrams representations of exemplary fuel storage cartridges including a plurality of fuel vessels to store or maintain one or more fuels therein, in accordance with certain aspects of the present inventions;

FIGS. 12A-12E are block diagrams representations of exemplary fuel cell power and management systems, including fuel cell power unit and a dock-type device/unit having an interface (for example, fluid, mechanical and/or electrical) for one or more fuel storage canisters or cartridges, according to certain aspects of the present inventions;

FIGS. 13A-13C, 14A and 14B are various views of an exemplary fuel cell power and management system, including fuel cell power unit having one or more fuel cell power units and a dock-type device/unit having an interface (for example, fluid, mechanical and/or electrical) for one or more fuel storage canisters or cartridges, according to an aspect of the present inventions; and

FIG. 15 is an exemplary flow diagram for determining, calculating and/or monitoring the state of fill of one or more fuel storage canisters or cartridges (employing a metal hydride or the like storage technology) by control circuitry in a fuel cell power and management system (for example, control circuitry in/on the dock-type device/unit, fuel cell power unit and/or the fuel storage canister or cartridge);

FIG. 16 is a block diagram representation of an exemplary fuel cell power and management system, including communication circuitry to facilitate remote communication with a user/operator or external circuitry, according to an aspect of the present inventions;

FIG. 17 is a block diagram representation of an exemplary fuel cell power and management system, including visual and/or audible alert circuitry, according to an aspect of the present inventions;

FIGS. 18A and 18B are block diagram representations of fluid/fuel flow control, sensing and/or regulating devices/mechanisms in conjunction with a fluid manifold unit which outputs fuel to the fuel cell unit from one or more fuel storage canisters or cartridges, according to certain aspects of the present inventions; and

FIGS. 19A-19C are block diagram representations of exemplary fuel cell power and management systems, including a reservoir, according to an aspect of the present inventions.

### DETAILED DESCRIPTION

There are many inventions described and illustrated herein. In one aspect, the present inventions are directed to (i) fuel cell power system, (ii) a dock-type device/unit which includes (1) an interface (for example, fluid, mechanical and/or electrical) for one or more fuel storage canisters or cartridges, employing the same or different fuel storage technologies (hereinafter “fuel storage canisters or cartridges”), and (2) one or more fuel cell power units, and (iii) methods of controlling and operating same. In one embodiment, the fuel cell power system includes a dock-type device/unit having N number of input ports for fuel storage canisters or cartridges (wherein N is greater than or equal to 2) to provide fuel to a fuel cell power unit having, for example, M number of fuel cell power sub-units (where M is greater than or equal to 1). For example, in one exemplary embodiment, the dock-type device/unit includes six input ports for fuel storage canisters or cartridges (here, N=6) to supply fuel to one fuel cell power unit having one fuel cell power sub-unit (here, M=1). As such, in this exemplary embodiment, six fuel storage canisters or cartridges may be connected to the dock-type device/unit to provide fuel (for example, hydrogen, in gas or liquid form, and/or hydrogen which is derived from a hydrogen containing compound) to one fuel cell power unit (for example, a fuel cell power unit having one or more fuel cell stacks).

Notably, while certain aspects of the application are couched in the context of a hydrogen or methanol fuel, it is to be understood that the inventions are applicable to other fuels and associated management systems.

The dock-type device/unit of the present inventions includes the ability to have increased, scalable run time via access of fluid or fuel from one or more fuel storage canisters or cartridges, including the selective and/or simultaneous access of fuel from a plurality of fuel storage canisters or cartridges (which may be the same or different types of canisters or cartridges having the same or different fuel storage technologies, for example, metal hydride, liquid or solid chemical hydride, methanol, or other primary or secondary sources of hydrogen fuel). In addition, the dock-type device/unit includes control circuitry that may provide for or facilitate the control of access to the fuel from one, some or all of the fuel storage canisters or cartridges. Indeed, as discussed in more detail below, control of fuel access may be accomplished through actively-controlled fuel valves or direct control of a fuel generating or actuating mechanism (for example, pumps, igniters (resistive or pyrotechnic), etc). As discussed in detail below, the control circuitry may also provide, calculate, determine and/or maintain the state of fill of the one or more or all fuel storage canisters or cartridges while the fuel storage canisters or cartridges provide/supply fuel to the fuel cell power unit (which may include one or more fuel cell power sub-units).

The dock-type device/unit may include a standard interface (mechanical, electrical and/or fluid) for the fuel storage canisters or cartridges. The dock-type device/unit may also include a standard interface for the one or more fuel cell power sub-units. A fluid manifold disposed in the dock-type device/unit may facilitate and/or enable fluid communication of a plurality of fuel storage canisters or cartridges to the fuel cell power unit or components thereof (for example, fuel cell power sub-units). The fluid manifold may be a significant portion of or integral with the chassis or housing of the dock-type device/unit.

Notably, the dock-type device/unit may include one or more unique or dedicated interfaces (mechanical, electrical and/or fluid) to accommodate one or more unique fuel storage canisters or cartridges (having, for example, a particular fuel storage technique, such as a chemical-type). Moreover, the dock-type device/unit may also include a fixed, unique and/or dedicated interface for the fuel cell power unit and/or one or more fuel cell power sub-units (or sub-assemblies thereof, such as fuel cell stacks).

The dock-type device/unit also includes an enclosure, chassis or housing to protect such fuel storage canisters or cartridges and fuel cell power unit from inadvertent damage and provide a compact, portable and/or configurable fuel cell power system.

As noted above, the fuel cell power unit generates electrical power from fuel provided by the one or more fuel storage canisters or cartridges. In one embodiment, the fuel cell power unit includes one or more fuel cell stacks. The fuel cell power unit may include, for example, one or more fuel cell power sub-units, each including one or more fuel cell stacks. In this embodiment, the fuel cell stacks are arranged in groups according to one or more fuel cell power sub-units. As such, in this embodiment, the fuel cell power sub-units generate electrical power from fuel provided by the one or more fuel storage canisters or cartridges wherein the output electrical power of the fuel cell power unit may be distributed, allocated and/or partitioned according to one or more fuel cell power sub-units.

The fuel cell power unit may further include a voltage and/or power conditioning unit which includes one or more electrical components (for example, DC-DC converter(s) or DC-AC inverter device(s)) to condition the output electrical power of the one or more fuel cells. In one embodiment, each fuel cell stack of the fuel cell power unit is electrically connected to a common voltage and/or power conditioning device (for example, a DC-DC converter or a DC-AC inverter device) which generates conditioned electrical power from the output of each fuel cell stack.

In one embodiment, the voltage and/or power conditioning unit includes one or more voltage and/or power conditioning sub-units, each including one or more electrical components (for example, DC-DC converter(s) or DC-AC inverter device(s)) to condition the output electrical voltage and/or power of the one or more fuel cells. In this embodiment, one or more fuel cell stacks may be connected to an associated or dedicated voltage and/or power conditioning sub-unit wherein the associated or dedicated voltage and/or power conditioning sub-unit provides or outputs conditioned power using the output of the associated fuel cell stacks. In this regard, the associated fuel cell stacks may be the fuel cell stacks of one or more fuel cell power sub-units. Notably, any combination or architecture of fuel cell stack to voltage conditioning device is intended to fall within the scope of the present inventions. For example, any combination or architecture of fuel cell stack to voltage and/or power conditioning device that (i) address the desired and/or required voltage and/or power characteristics (for example, amplitude, ripple, and/or timing) and/or (ii) satisfy the requirements of subsequent power conditioning stages (if any), to control output voltage, for example, (i) to charge one or more ultra-capacitors, batteries in a hybrid topology, and/or (ii) to dynamically balance loading between parallel-connected fuel cell stacks as a response to changes in the output characteristics of the fuel cell unit or fuel cell sub-units (for example, due to aging thereof).

The fuel cell power unit may further include a control circuitry to monitor, manage and/or control the generation of electrical power by the one or more fuel cells or fuel cell stacks. In one exemplary embodiment, the control circuitry in the fuel cell power unit may monitor, manage and/or control the generation of power by one or more fuel cell power sub-units to address the demands of the load. In another exemplary embodiment, the control circuitry may engage or allocate one or more fuel cell power sub-units to provide one or more outputs have programmed or pre-programmed characteristics.

As noted above, the dock-type device/unit may include control circuitry that controls the flow of fuel from one, some or all of the fuel storage canisters or cartridges to the fuel cell power unit or fuel cell power sub-units thereof. In one exemplary embodiment, the control circuitry may control the flow of fuel based on, for example, pre-programmed operations and/or user/operator inputs (for example, the user/operator programs, designates and/or selects the one or more fuel storage canisters or cartridges to provide fuel (which may also be temporally based). In one embodiment, the control circuitry may control the operation of the system based on predetermined variables or considerations, for example, (i) the fuel or fuel storage type of cartridge or canister, (ii) the amount of fuel stored or remaining in the cartridge or canister, and/or (iii) the desired run-time and/or power consumption/output. The control circuitry may also consider balancing the demand on fuel storage canisters or cartridges based on the fuel storage technologies of the installed fuel storage canisters or cartridges in conjunction with providing or ensuring that the fuel storage canisters or cartridges having disparate fuel storage technologies function or operate properly when the dock-type device/unit includes a common fluid manifold.

As noted below, the control circuitry, and the operations performed thereby, may be located or distributed in one or more of the dock-type device/unit, the fuel cell power unit, one or more of the fuel storage cartridges, and/or by external circuitry. As such, the control circuitry, and the operations performed thereby, may be disposed exclusively in/on the dock-type device/unit or the fuel cell power unit. Alternatively, the control circuitry, and the operations performed thereby, may be distributed in one or more of the dock-type device/unit, the fuel cell power unit, one or more of the fuel storage cartridges, and/or by external circuitry. All permutations and combinations are intended to fall within the scope of the present inventions.

In another embodiment, the user/operator may also program, designate and/or select the amounts (for example, on a percentage basis) of fuel drawn from the one or more fuel storage canisters or cartridges. Indeed, the user/operator may configure supply of fuel from the one or more fuel storage canisters or cartridges on a temporal basis. In this regard, the dock-type device/unit may be programmed to supply fuel to the fuel cell power unit from a first group of one or more fuel storage canisters or cartridges at a first time and at second time, supply fuel to the fuel cell power unit from a second group of one or more fuel storage canisters or cartridges (which may include one or more fuel storage canisters or cartridges that at least partially overlap with the first group of one or more fuel storage canisters or cartridges). In addition thereto, or in lieu thereof, the user/operator may program, designate and/or select the amounts (for example, on a percentage basis) of fuel drawn from the one or more fuel storage canisters or cartridges to change over time.

In one embodiment, fluid/fuel flow control devices (for example, electrically controlled valves) may be disposed within the fluid path of one, some or all of the fuel storage canisters or cartridges. In this way, the control circuitry may control the fuel flow therefrom. For example, the fuel flow control devices may be disposed in the fluid interface of the dock-type device/unit. The fuel flow control devices may also be disposed further “upstream”, for example, in a fluid manifold or before the input of a fluid manifold. In another embodiment, the fuel flow control device may be disposed within the fuel storage canister or cartridge. The fuel flow control device may be a flow value in, for example, a valve assembly of the storage canister or cartridge that is controlled via electrical signals from the control circuitry.

In addition thereto, or in lieu thereof, the fuel flow control device may be an actuation-type device (for example, a pump or an igniter (such as, for example, a resistive or pyrotechnic igniter)) that causes the fuel to be available, generated and/or released from the fuel storage canister or cartridge and into the fluid interface of the dock-type device/unit. In this embodiment, the control circuitry may issue a command or instruction to the fuel storage canister or cartridge and in response thereto, the fuel storage canister or cartridge cause the fuel to be available (for example, generate from a compound including the fuel) and/or release the fuel from the fuel storage canister or cartridge to the dock-type device/unit.

Notably, any type of fuel flow control devices (as well as architecture or configuration thereof) is intended to fall within the scope of the present inventions.

In one embodiment, the control circuitry does not control the flow of fuel from one, some or all of the fuel storage canisters or cartridges to the fuel cell power unit or fuel cell power sub-units thereof. In this embodiment, the control may be viewed as “passive” and the flow of fuel from the fuel storage canisters or cartridges may be based on relative output pressures of the fluid from the one or more fuel storage canisters or cartridges. Notably, this embodiment may employ check valves at the inputs of the fuel storage canisters or cartridges to facilitate use of embodiments having multiple fuel storage canisters or cartridges. In this regard, the check valves may be integrated into the fuel storage canisters or cartridges or disposed on/in the interface of the dock-type device/unit, for example, at the input of the fluid manifold (if any).

The fluid flow control may be “manual” in that the user/operator may enable or activate the availability, generation and/or flow of fuel via a manual switch device on/in the fuel storage canister or cartridge. In one embodiment, the user/operator may enable or activate the availability and/or generation of the fuel from, for example, a compound which includes the fuel. In this regard, the fuel may be stored in a first state or condition (for example, sodium borohydride) that requires generation within the fuel storage canister or cartridge to second state or condition (in this example, hydrogen). Once enabled or activated, the flow of fuel (from the fuel storage canister or cartridge to the dock-type device/unit) may be controlled using any of the embodiments described and/or illustrated herein.

In addition to any of the embodiments herein, or in lieu thereof, the fluid flow control may be manual switch device on/in the interface, fluid path or fluid manifold of the dock-type device/unit. In this embodiment, the user/operator may manually control the state of the switch device to facilitate flow of fluid/fuel to the fuel cell power unit.

The control circuitry may also determine, calculate, monitor, manage, maintain and/or control the state of fill of the one or more or all fuel storage canisters or cartridges while the one or more fuel storage canisters or cartridges provide/supply fuel to the fuel cell power unit or the one or more fuel cell power sub-units. In this embodiment, the control circuitry may determine, calculate, monitor, manage, maintain and/or control the state of fill of the one or more or all fuel storage canisters or cartridges using data provided by the one or more or all fuel storage canisters or cartridges to the control circuitry. In this regard, a fuel storage canister or cartridge may provide the “initial” state of fill to the control circuitry and using that data, the control circuitry may determine, calculate, monitor, manage, maintain and/or control the state of fill of the fuel storage canister or cartridge based on usage and/or operating parameters (for example, pressure and/or temperature). Notably, the state of fill may be representative of the amount of fuel remaining in the fuel storage canister or cartridge and/or consumed from the fuel storage canister or cartridge.

In one embodiment, the control circuitry may determine, monitor, manage and/or control the state of fill based on an amount of time the fuel storage canister or cartridge has been connected to and providing fuel to fuel cell power unit. The control circuitry may employ the “initial” state of fill of the fuel storage canister or cartridge to determine an absolute measure, for example, based on an amount of time the fuel storage canister or cartridge has been connected to and providing fuel to fuel cell power unit. In addition to, or in lieu thereof, in another embodiment, the control circuitry may receive, sample and/or acquire data from sensors (for example, temperature, pressure and/or flow rate type sensors) disposed on, in or near fuel storage canister or cartridge and, using such data, calculate, determine and/or estimate the state of fill of one or more of fuel storage canisters or cartridges. The control circuitry may calculate, determine and/or estimate the state of fill using mathematical relationships, empirical data and/or modeling. For example, control circuitry may obtain data which is representative of the temperature and pressure of the fuel in the fuel storage canister or cartridge and, based thereon, calculate/estimate the amount of fuel consumed from and/or remaining therein.

In another embodiment, the control circuitry may obtain data which is representative of the flow rate of fluid (i) through a valve assembly on/in the fuel storage canister or cartridge, and/or (ii) into the fluid interface and/or manifold of the dock-type device/unit. The sensors may be discrete elements, such as one or more microelectromechanical devices, temperature sensors, pressure sensors, and/or flow rate sensors. Such sensors may be integrated into one or more other components of the fuel storage canister or cartridge and/or dock-type device/unit (for example, one or more pressure or temperature elements integrated into and disposed within the walls of the fuel vessel of the fuel storage canister or cartridge or in a valve assembly of the fuel storage canister or cartridge, interface of the dock-type device/unit, and/or the input of the fluid manifold). Notably, any type of sensor, whether now known or later developed, which may be employed to provide information to the control circuitry may be implemented herein; indeed, all such sensors are intended to fall within the scope of the present inventions.

In another embodiment, the control circuitry may determine, monitor, manage and/or control the state of fill of the fuel storage canister or cartridge (among other things) by assessing the output power characteristics of the fuel cell unit, for example, the output current thereof. In this embodiment, the control circuitry may use data from one or more sensors (for example, current sensor), mathematical relationships, empirical data and/or modeling. In short, the control circuitry may estimate, calculate and/or infer the state of fill of the fuel storage canister or cartridge from the output power characteristics of the fuel cell unit, for example, the output current thereof.

The control circuitry, in another embodiment, may obtain data which is representative of the state of fill of the fuel storage canister or cartridge and, in response, may calculate a weighted sum of fluid/fuel use by the fuel cell power unit. The control circuitry may then report the weighted average to, for example, external circuitry and/or the user/operator (via for example, the user/operator interface).

Notably, in one embodiment, the control circuitry may receive instructions and/or data from circuitry external to the system, for example, from the user/operator via an external device (computer or PDA). In this regard, the control circuitry may be instructed to, for example, determine, measure, sample one or more operating parameters (for example, the state of fill of one or more fuel storage canisters or cartridges, the rate of fuel consumption, the output power of the fuel cell power unit and/or the temperature of the fuel in fuel vessel of a fuel storage canister or cartridge). The control circuitry may be instructed to control and/or manage the operation of fuel cell power unit (or sub-units thereof) to, for example, adjust and/or modify the output power and/or rate of fuel consumption. Indeed, the control circuitry may be instructed to control and/or manage the operation of other aspects of the system, for example, the temperature of the fuel in fuel vessel of a fuel storage canister or cartridge via engaging a thermal management unit (for example, a cooling and/or heating unit) disposed on or near the system (or components thereof).

The control circuitry may also store the state of fill of the fuel storage canister or cartridge in memory disposed therein or thereon. In this regard, the memory may retain the state of fill of the fuel storage canister or cartridge when disengaged from the dock-type device/unit. In this way, when or if the fuel storage canister or cartridge is engaged with the dock-type device/unit, the control circuitry may access the memory and obtain information which is representative of the current state of fill.

In addition to storing the state of fill of the fuel storage canister or cartridge in memory on/in the fuel storage canister or cartridge, or in lieu thereof, the control circuitry may output the state of fill of the fuel storage canister or cartridge to an external device and/or the user/operator, via, for example, an interface disposed on the dock-type device/unit.

Notably, the memory may further store data which is representative of one or more unique characteristics of the fuel storage canister or cartridge. The one or more unique characteristics of the fuel storage canister or cartridge may include at least one of a serial number of the canister or cartridge, date of manufacture and/or assembly thereof, the type of fuel contained in fuel storage canister or cartridge and capacity thereof, maximum flow rate, minimum flow rate, start-up time (if any), shut-down time (if any), required instructions/commands/voltages, and/or the number of refill operations the canister or cartridge has undergone. The one or more unique characteristics may also include a data log of the operation of the fuel cell unit and/or system during the “life” of that canister or cartridge, as well as a data log of operating parameters of that canister or cartridge (temperatures, pressures, etc) to, for example, debug canister or cartridge or other components of the system in the event of a failure. Notably, such data logs may be analyzed to determine such historical canister or cartridge usage or historical system operational characteristics.

The data which is representative of one or more characteristics of the fuel storage canister or cartridge may be accessed by or provided to the control circuitry, user/operator and/or an external device in the same manner as described above with respect to the state of fill. For the sake of brevity, such discussions will not be repeated.

In addition thereto, or in lieu thereof, the control circuitry may determine the type of fuel contained in fuel storage canister or cartridge and capacity thereof based on the attributes or signature of the cartridge or canister interface (for example, the interface of a cartridge or canister containing a metal-hydride includes one or more attributes that are different from the interface of a cartridge or canister containing an ammonia borane). In this regard, the mechanical interface of the canister or cartridge may be representative of the fuel type and/or capacity of the canister or cartridge. In this way, when the canister or cartridge is mechanically coupled to the dock-type interface, the control circuitry may determine the type of fuel contained in fuel storage canister or cartridge and capacity thereof based on one or more attributes or a signature of the mechanical interface of the cartridge or canister.

In addition to a manifold to provide fluid to route fluid/fuel to the fuel cell power unit, the dock-type device/unit may also include a fluid/fuel reservoir which facilitates continuation and uninterrupted operation of the fuel cell power unit without supply of fluid/fuel from one or more of the fuel storage canisters or cartridges, for example, when “new” or different fuel storage canisters or cartridges are being substituted for such one or more of the fuel storage canisters or cartridges which is/are disengaged. Such a configuration accommodates fuel storage canisters or cartridges having fuels that require a measurable and/or significant start-up time (for example, sodium borohydride hydrogen generation system or methanol reforming fuels) and/or facilitates “hot swapping” of the fuel storage canisters or cartridges. The reservoir may be a storage tank in the dock-type device/unit or the fuel cell power unit. In this regard, during normal operation one or more of the fuel storage canisters or cartridges may be connected to the reservoir, which is maintained in a filled state from the fuel storage canisters or cartridges. In this embodiment, the fuel storage canisters or cartridges may provide the fuel/fluid directly to the fuel cell power unit or indirectly via the reservoir. When, however, the one or more fuel storage canisters or cartridges is/are removed from the dock-type device/unit, the fuel cell power unit may continue operation at the same or an uninterrupted level/condition using the fuel/fluid which is stored in the reservoir. In one embodiment, the reservoir provides the user/operator with a sufficient amount of the time to (i) replace a “spent” or empty canister or cartridge with a “new” canister or cartridge, and/or (ii) to accommodate the “start-up” time for certain fuels that require a measurable start-up time.

Where the system includes a pressure regulator to accommodate a high pressure fuel/fluid source, the reservoir may be connected between the canister or cartridge and a pressure regulator on either the high or low pressure side. Where the reservoir is disposed on the high pressure side, a check valve may be employed to ensure that the fluid/fuel stored in the reservoir does not flow back to the canister or cartridge.

The reservoir may be a bladder or cavity in the fluid path within the dock-type device/unit. (See, for example, Arikara et al., U.S. application Ser. No. 10/328,709, “Forced Air Fuel Cell Power System.” Notably, the discussions therein regarding the reservoir, and components and/or features related thereto, are incorporated by reference herein. Where the reservoir is an expandable bladder that expands when filled with hydrogen and collapses as the hydrogen gas is consumed by the fuel cell power unit. The bladder may be contained within the cavity in the control block thus limiting its maximum capability to expand. The bladder may ensure that the pressure of fluid/fuel output by the reservoir to the one or more fuel cell stacks of the fuel cell power unit is at a relatively constant pressure.

Notably, one or more of the fuel storage canisters or cartridges may be employed as a reservoir. In this regard, the control circuitry may “assign” or “designate” one or more of the fuel storage canisters or cartridges. Such a reservoir fuel storage canister or cartridge provides the user/operator with a sufficient amount of the time to (i) replace a “spent” or empty canister or cartridge with a “new” canister or cartridge, and/or (ii) to accommodate the “start-up” time for certain fuels that require a measurable start-up time. The reservoir fuel storage canister or cartridge may be coupled to the interface of the dock-type device/unit in the manner discussed above. Alternatively, the fuel storage canister or cartridge may be fixed to or within the dock-type device/unit and fixedly connected to the fluid bus. The reservoir fuel storage canister or cartridge may automatically provide fuel to the fuel cell power unit and/or may, in response to commands/instructions from the control circuitry and/or user/operator, provide fuel to the fuel cell power unit.

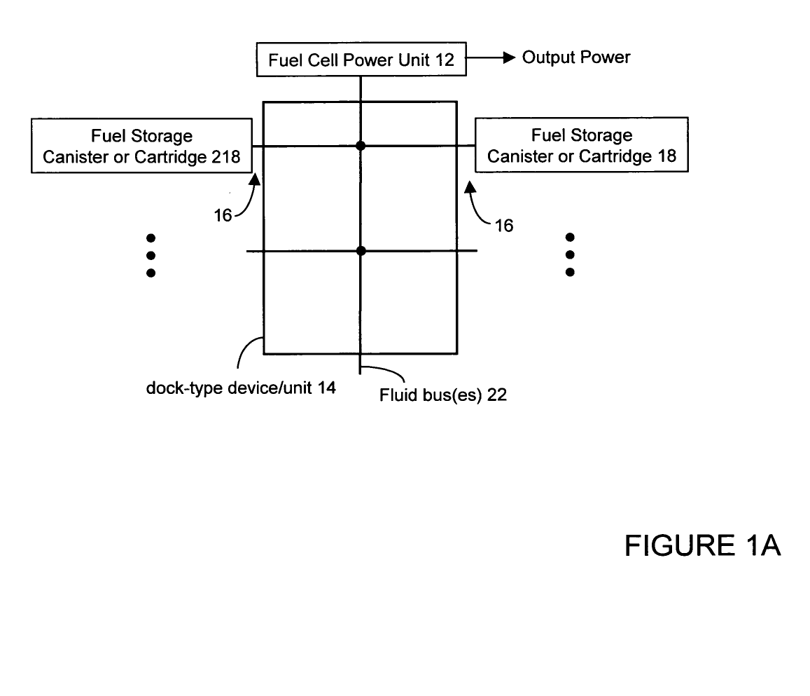

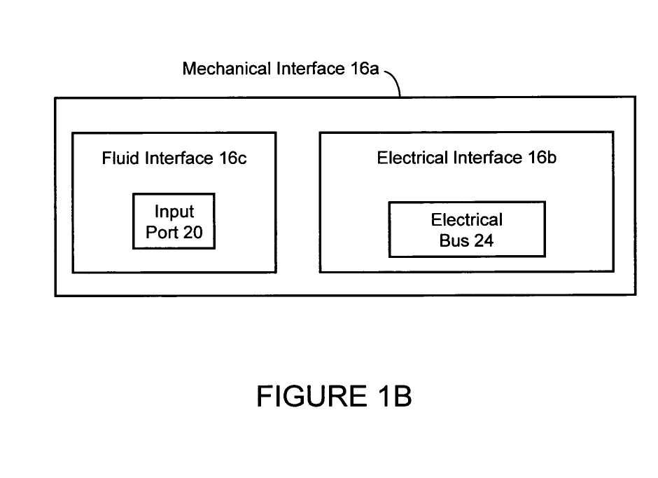

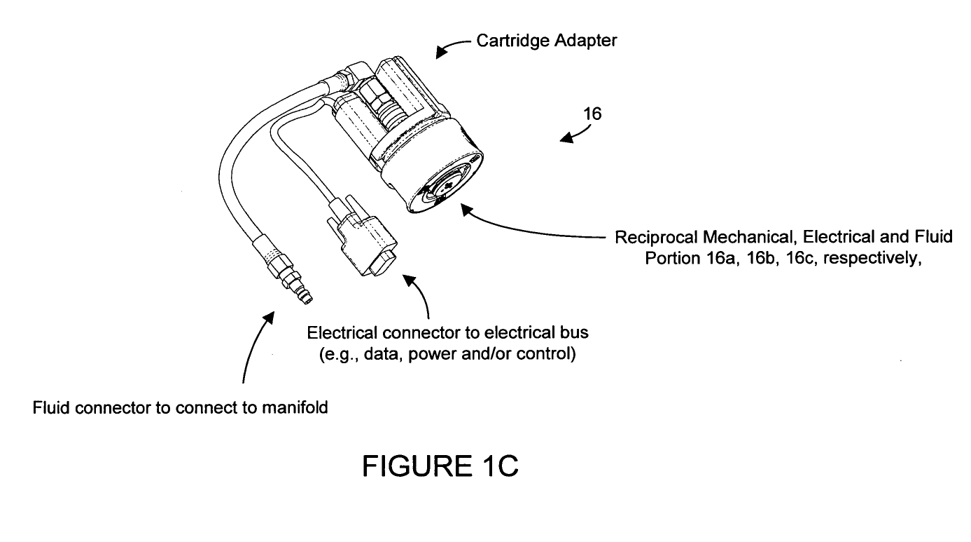

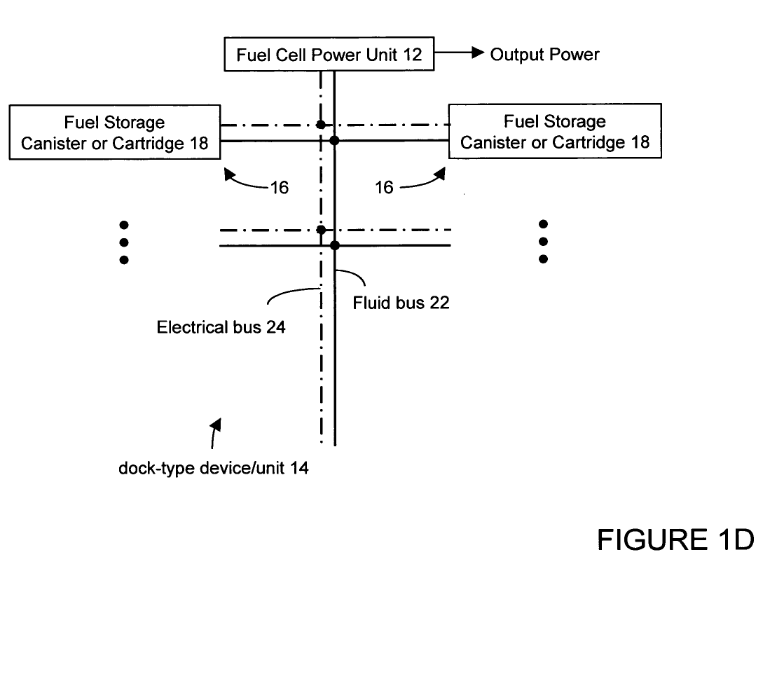

With reference to FIGS. 1A and 1B, in one exemplary embodiment, the fuel cell power system 10 may include a fuel cell power unit 12 (which may include one or more fuel cell power sub-units) and a dock-type device/unit 14 that includes an interface 16 (mechanical, electrical and/or fluid) that facilitates connection with a plurality of fuel storage canisters or cartridges 18. In one embodiment, the interface 16 of the dock-type device/unit 14 may include a mechanical portion 16a that facilitates “twist-on” or “slide-on” mating with the fuel storage canisters or cartridges, an electrical portion 16b that allows for, among other things, communication with circuitry (if any) disposed on the fuel storage canisters or cartridges 18, and a fluid portion 16c that provides for fluid communication between the fuel storage canisters or cartridges 18 and the fuel cell power unit 12. (See, for example, FIG. 1C).

With continued reference to FIGS. 1A and 1B, the fluid portion 16c of the interface includes a fluid input port 20 connected to a fluid bus 22 to facilitate acquisition of fluid or fuel from the fuel storage canisters or cartridges 18. The fluid portion 16c of the interface 16 may include a fluid output port to, for example, facilitate exchange of fluid between the dock-type device/unit and the fuel storage canister or cartridge and/or to facilitate discharge of fluid from the fuel cell power unit 12. For example, the fluid employed in a fuel cell power unit such as direct methanol, direct sodium borohydride, or internal reforming fuel cell power unit, may flow both to and from a fuel cell power unit and/or to and from a fuel cell canister or cartridge. In addition thereto, or in lieu thereof, the fluid interface may also include a heat exchange fluid loop which facilitates heat exchange (removing or adding) with various components of the system (for example, the fuel cell power unit and/or one or more fuel storage canisters or cartridges). In this regard, the fluid (for example, liquid or liquid vapor) in the heat exchange fluid loop may increase or decrease an operating temperature of one or more components of the system.

With reference to FIGS. 1B and 1C, the electrical portion 16b of the interface 16 electrically couples to an electrical bus 24 to facilitate communication between one or more fuel cell canisters or cartridges and (i) control circuitry in/on the dock-type device/unit (if any) and/or (ii) control circuitry in the fuel cell power unit (if any). Where the electrical bus 24 is wired, the electrical portion 16b of the interface 16 connects to an electrical bus 24 which includes one or more lines that provide for electrical communication of data, power and/or control.

The electrical bus 24 in the dock-type device/unit 14 may also enable control circuitry (i) in/on the dock-type device/unit and/or (ii) control circuitry in the fuel cell power unit to monitor, control and/or manage the operation or performance of the system or components thereof (for example, the fuel cell power unit). Notably, the electrical bus may be any type, technology or architecture whether now known or later developed (for example, wired, wireless, point-to-point, multiplexed, non-multiplexed, distributed, dedicated, etc). Indeed, the electrical bus may be comprised of a plurality of discrete busses, for example, a first bus connected between control circuitry in/on the dock-type device/unit and the fuel cell power unit and one or more other buses connected between control circuitry and one or more fuel cell canisters or cartridges. Again the electrical bus may be any type or architecture whether now known or later developed.

The fuel canisters or cartridges may include a reciprocal mating mechanism, design and/or type. In one embodiment, the fuel canisters or cartridges and the dock-type device/unit include the reciprocal mating mechanisms, designs and/or types of any embodiment described and/or illustrated in Non-Provisional patent application Ser. No. 11/036,240, filed Jan. 14, 2005, entitled “Fuel Cell Power and Management System, and Technique for Controlling and/or Operating Same” (hereinafter “the Fuel Cell Power and Management System Patent Application.” The Fuel Cell Power and Management System Patent Application is incorporated by reference herein in its entirety.

Notably, any mechanical interface may be employed and all mechanical interfaces (whether employing “twist-on”, “slide-on” and/or “screw-on” mating) are intended to fall within the scope of the present inventions. For example, the mechanical interface may be a quick-release type mechanical interface. Indeed, the mechanical interface may include a plurality of interface portions, for example, a fluid portion of the interface that is a quick-release type and an electrical portion that includes male-female connector that is secured via a “twist-on” action. All combinations of mechanical interfaces are intended to fall within the scope of the present inventions.

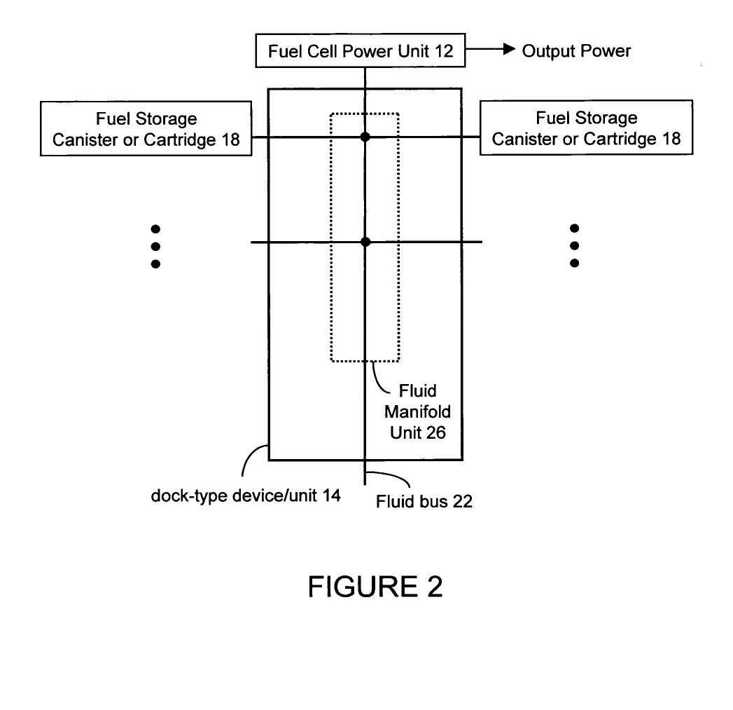

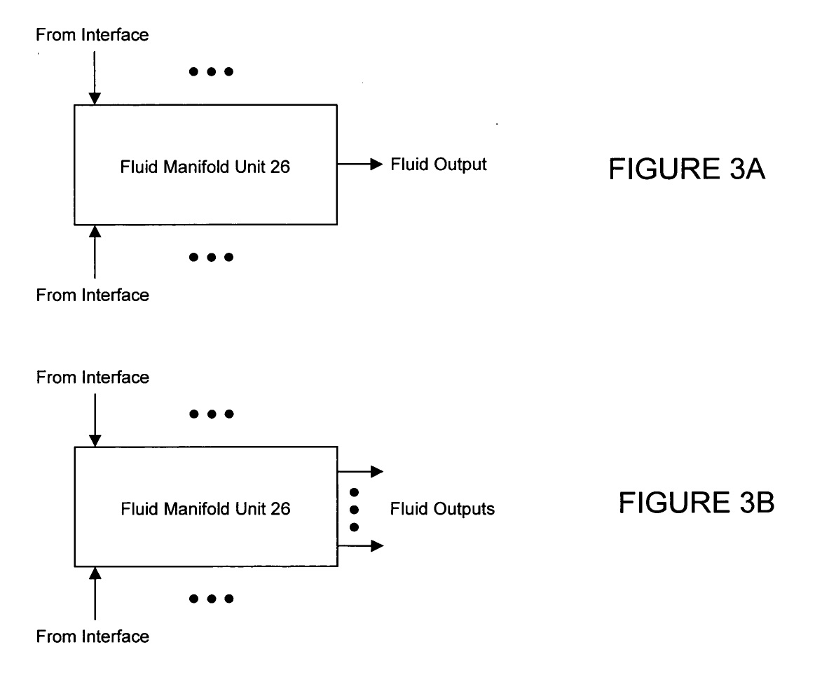

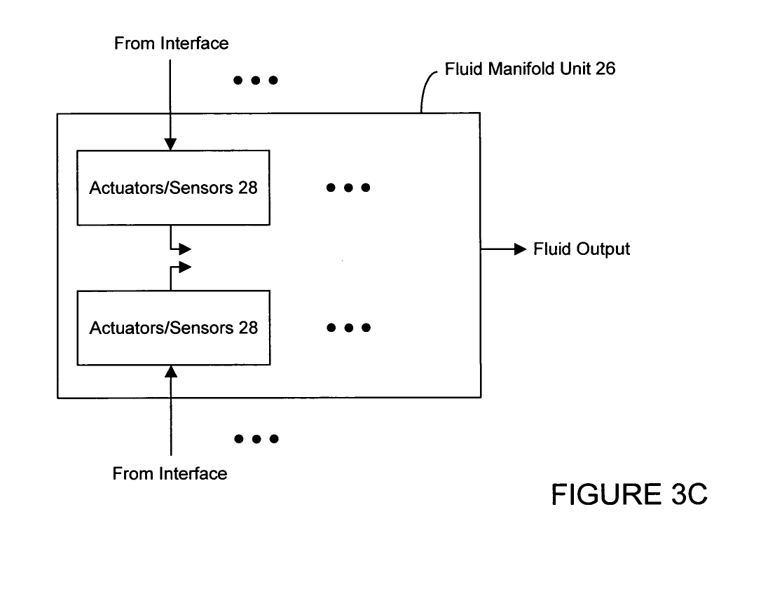

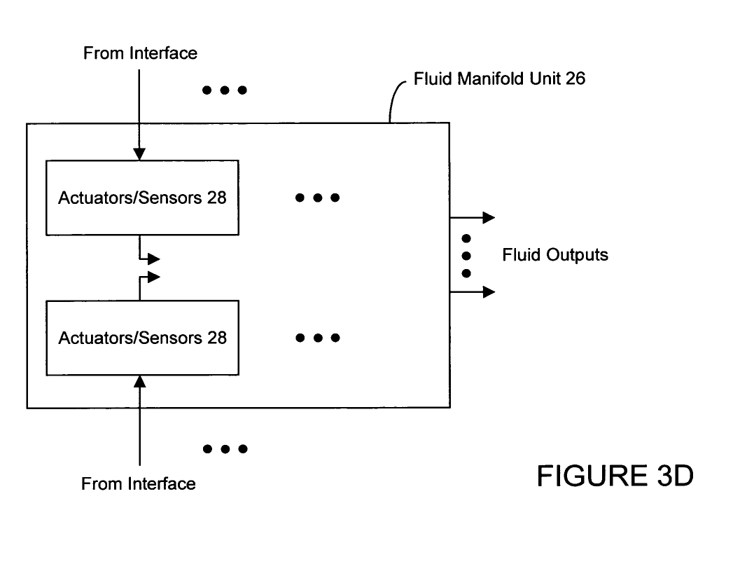

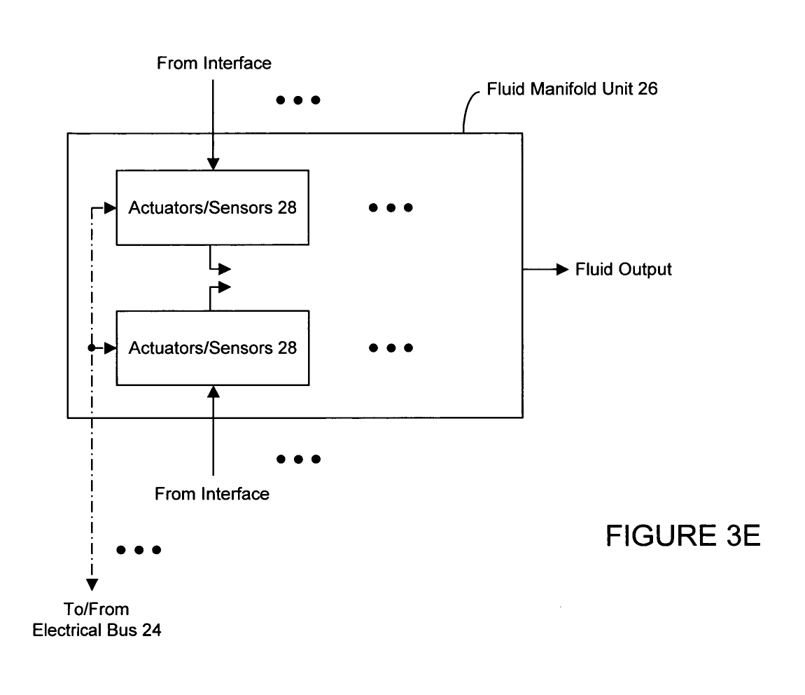

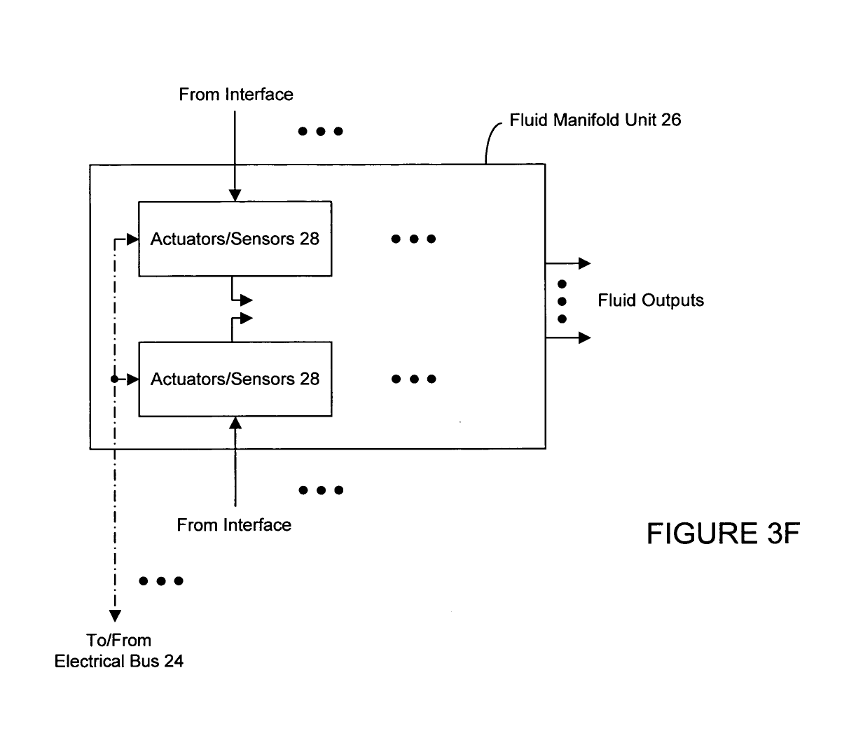

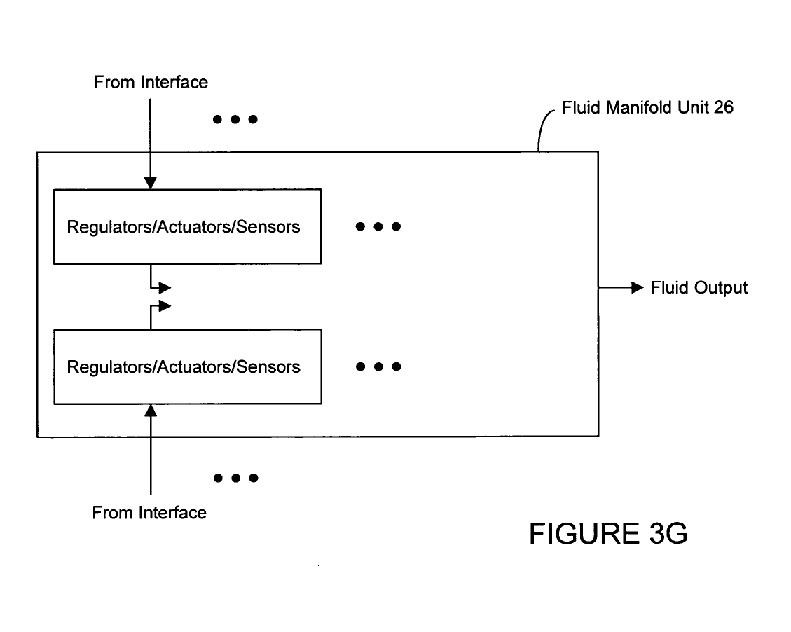

With reference to FIGS. 2 and 3A, in one embodiment, the dock-type device/unit 14 may include a fluid manifold unit 26 to provide, facilitate and/or enable fluid communication between a plurality of fuel storage canisters or cartridges 18 and the fuel cell power unit 12 or components thereof (for example, fuel cell power sub-units). In this way, a plurality of cartridges or canisters 18 may be connected/disconnected thereby permitting rapid adjustment of the available fuel. The dock-type device/unit may employ any type of fluid manifold now known or later developed; all such manifolds are intended to fall within the scope of the present invention.

For example, with reference to FIG. 3B, the fluid manifold unit 26 may include a plurality of fluid outputs. In this regard, fluid from the one or more fuel cartridges or canisters may be individually and controllably routed and/or provided to the fuel cell power unit or components thereof (for example, fuel cell power sub-units). The fluid paths within the fluid manifold unit may be fixed and/or configurable (for example, in situ). In this way, fluid from the one or more fuel cartridges or canisters 18 may be routed to a subset of fuel cell power sub-units (i.e., one or more fuel cell power sub-units) of the fuel cell power unit.

Notably, the fluid manifold unit 26 may include sensors and/or actuators (or valves, for example, check, shut-off and/or distributing valves) 28 to implement the routing, control, management and sensing techniques described and/or illustrated herein. (See, for example, FIGS. 3C-3F). The sensors may be flow sensors, flow rate sensors, temperature sensors, pressure sensors and/or leak sensors. The valves may be electrically controlled (for example, by the control circuitry and/or external circuitry) and/or manually controlled (for example, via the user/operator).

The fluid manifold unit 26 may also include a regulator (for example, a pressure regulator) in order to regulate, control and/or reduce the delivery pressure of the hydrogen gas to a level acceptable to the fuel cell power unit (for example, one or more of the fuel cell stacks). The regulator may be disposed on the fluid input of the manifold unit 26. (See, for example, FIG. 3G). Moreover, under those circumstances where multiple fuel cell canisters or cartridges are advantageous to provide a sufficient flow requirement, the dock-type device/unit 14 may include regulators to manage the delivery pressure of the fluid/fuel to the fuel cell power unit 12. Notably, this may be obtained by internal gas regulation in the dock-type unit (for example, FIG. 3G) or by communicating to the canister or cartridge the pressure required for proper control. Indeed, in one exemplary embodiment, the fuel storage canisters or cartridges may be controlled to output the same pressure. In another exemplary embodiment, the canisters could be controlled by a method comparable to pulse-width-modulation, where the fuel storage canisters or cartridges having varying pressure outputs insuring the desired average flow is obtained from each of the respective canisters or cartridges.

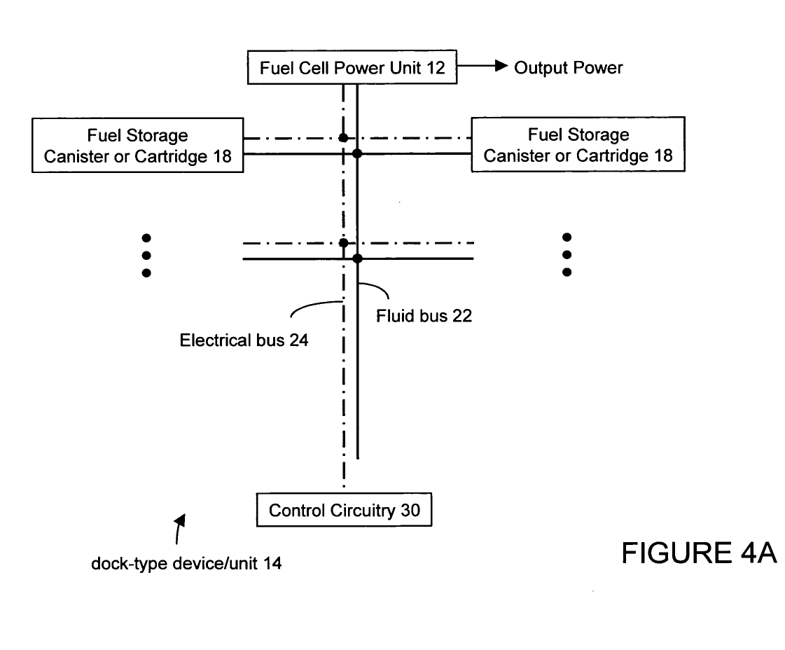

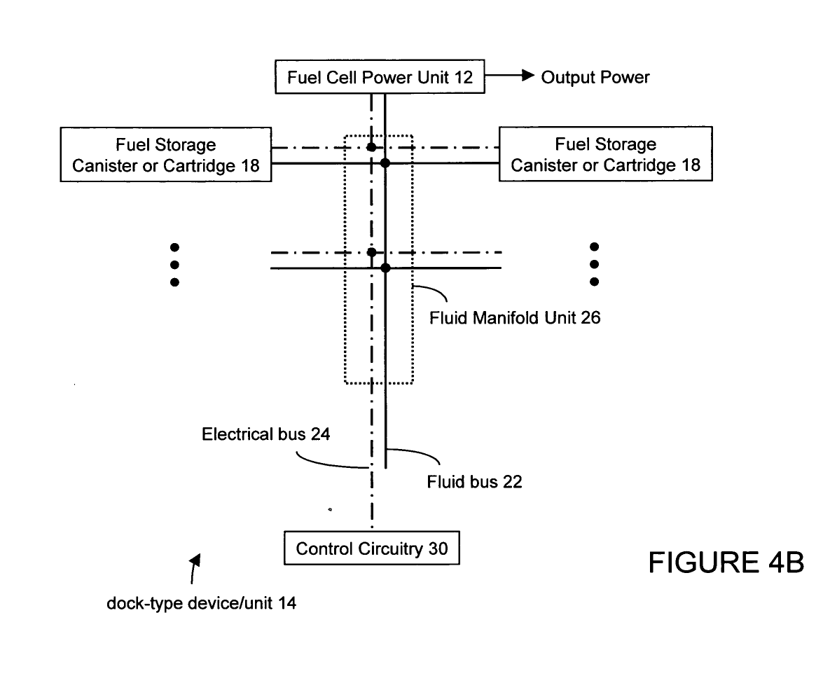

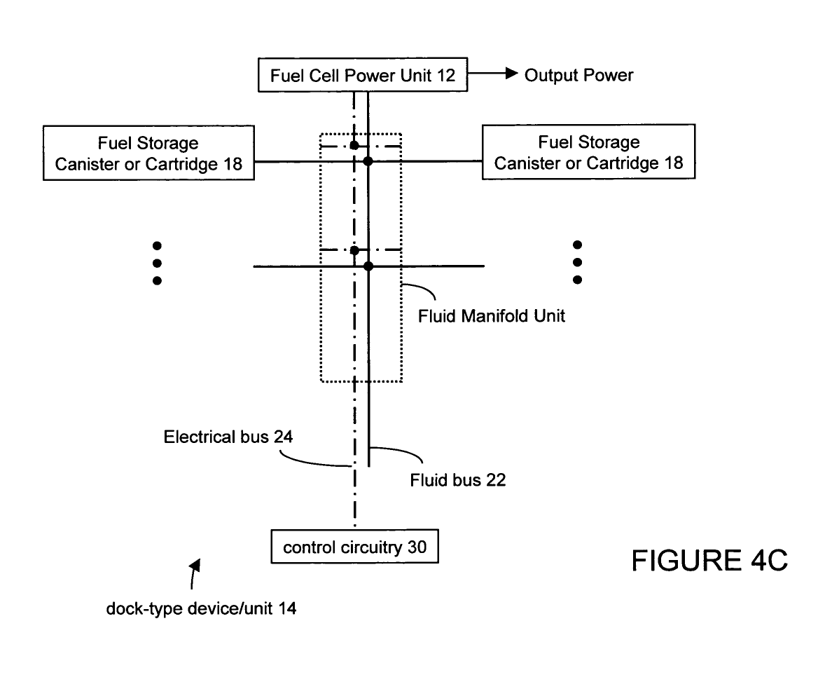

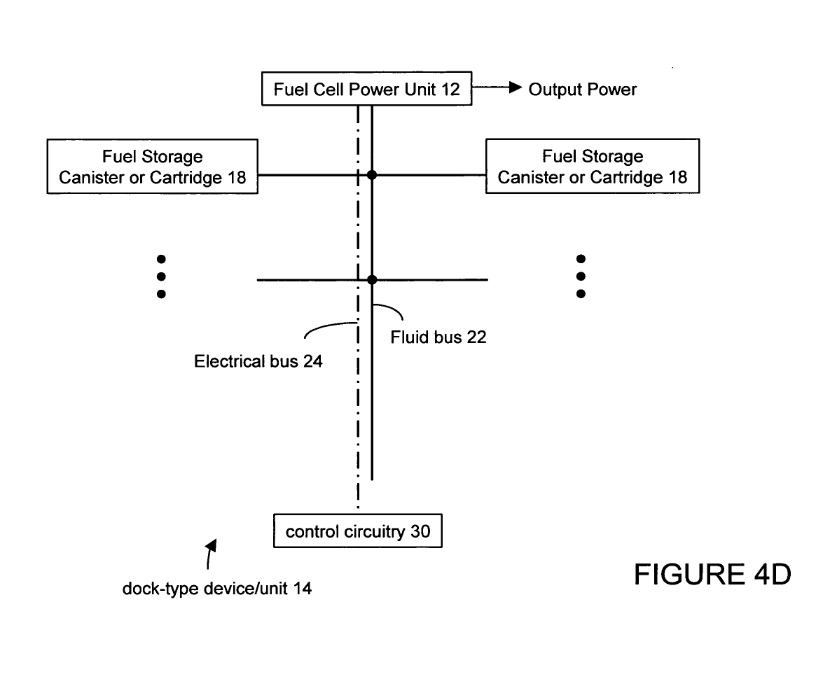

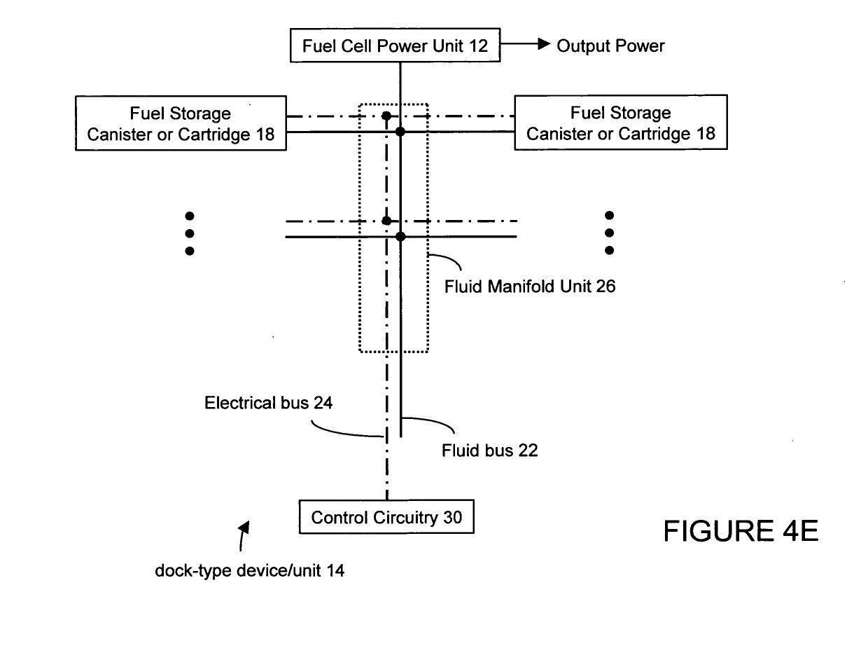

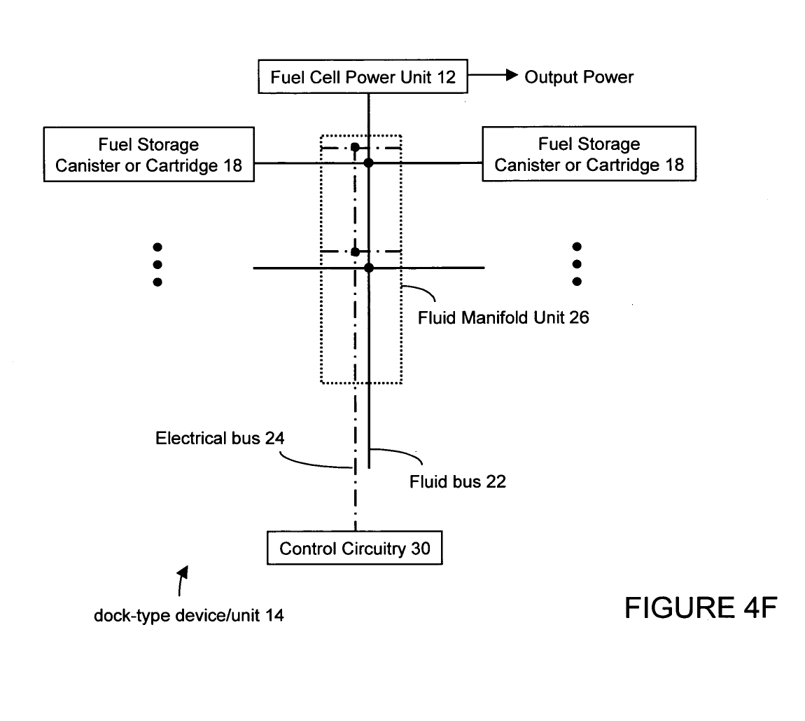

With reference to FIGS. 4A and 4B, the dock-type device/unit may include control circuitry 30 (including a controller or processor that is coupled to the electrical bus) which manages and/or controls the operation of the system and/or provides an interface with the user/operator. For example, in one embodiment, the control circuitry 30 manages the use of fuel (for example, the fuel provided by the fuel cartridge(s) or canister(s) to the fuel cell power unit) as well as determines the state of fill of the fuel in the canisters or cartridges (and/or changes therein), on an individual canister or cartridge basis and/or a collective basis.

The control circuitry 30 which is resident on or in the dock-type device unit may control the flow of fuel from one, some or all of the fuel storage canisters or cartridges to the fuel cell power unit (or fuel cell power sub-units thereof). The control circuitry may control the flow of fuel based on, for example, pre-programmed operations and/or in situ user/operator inputs (for example, the user/operator programs, designates and/or selects the one or more fuel storage canisters or cartridges to provide fuel (which may also be temporally based). In one embodiment, the user/operator may also program, designate and/or select the amounts (for example, on a percentage basis) of fuel drawn from the one or more fuel storage canisters or cartridges.

The control circuitry may temporally adjust or control the rate of fuel consumption from the one or more fuel storage canisters or cartridges. In this regard, the dock-type device/unit may be programmed to supply fuel to the fuel cell power unit from a first group of one or more fuel storage canisters or cartridges at a first time and at second time, supply fuel to the fuel cell power unit from a second group of one or more fuel storage canisters or cartridges (which may include one or more fuel storage canisters or cartridges that at least partially overlap with the first group of one or more fuel storage canisters or cartridges). In addition thereto, or in lieu thereof, the user/operator may program, designate and/or select the amounts (for example, on a percentage basis) of fuel drawn from the one or more fuel storage canisters or cartridges to change over time.

In one embodiment, control circuitry employs the fluid/fuel flow control devices (for example, electrically controlled valves) which are disposed within the fluid path of one, some or all of the fuel storage canisters or cartridges. (See, for example, FIG. 4B). In this way, the control circuitry may control the fuel flow from such fuel storage canisters or cartridges. For example, the fuel flow control devices may be disposed in the fluid interface of the dock-type device/unit. The fuel flow control devices may also be disposed further “upstream” in, for example, a fluid manifold. (See, for example, FIGS. 3E, 3F, 4C and 4F). In another embodiment, the fuel flow control device may be disposed within the fuel storage canister or cartridge. The fuel flow control device may be a flow value in, for example, a valve assembly of the storage canister or cartridge that is controlled via electrical signals from the control circuitry.

As noted above, in addition thereto, or in lieu thereof, the fuel flow control device may be an actuation-type device that causes the fuel to be available, generated and/or released from the fuel storage canister or cartridge and into the fluid interface of the dock-type device/unit (for example, a canister or cartridge having sodium borohydride hydrogen generation system or methanol reforming fuels). In this embodiment, the control circuitry may issue one or more commands or instructions to the fuel storage canister or cartridge and in response thereto, the fuel storage canister or cartridge cause the fuel to be available (for example, generate from a compound including the fuel) and/or release the fuel from the fuel storage canister or cartridge to the dock-type device/unit.

Notably, any type of fuel flow control devices (as well as architecture or configuration thereof) is intended to fall within the scope of the present inventions.

The control circuitry may also determine, calculate, monitor, manage, maintain and/or control the state of fill of the one or more or all fuel storage canisters or cartridges while the one or more fuel storage canisters or cartridges provide/supply fuel to the fuel cell power unit or the one or more fuel cell power sub-units. The state of fill may be representative of the amount of fuel remaining in the fuel storage canister or cartridge and/or consumed from the fuel storage canister or cartridge.

The control circuitry may determine, monitor, manage and/or control the state of fill based on an amount of time fuel storage canister or cartridge has been connected to and providing fuel to fuel cell power unit. In another embodiment, in addition thereto, or in lieu thereof, control circuitry may receive, sample and/or acquire data from sensors (for example, temperature, pressure and/or flow rate type sensors) disposed on, in or near fuel storage canister or cartridge and, using such data, calculate, determine and/or estimate the state of fill of one or more of fuel storage canisters or cartridges. The control circuitry may calculate, determine and/or estimate the state of fill using mathematical relationships, empirical data and/or modeling. For example, control circuitry may obtain data which is representative of the temperature and pressure of the fuel in the fuel storage canister or cartridge and, based thereon, calculate/estimate the amount of fuel consumed from and/or remaining therein.

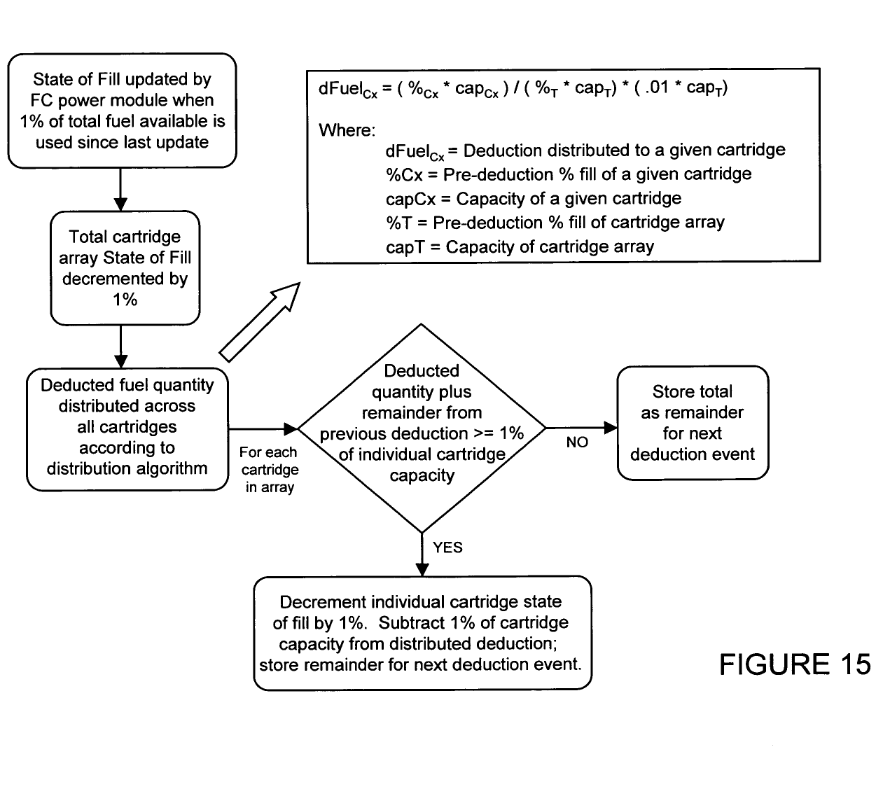

In one embodiment, the control circuitry may determine, calculate, monitor, manage, maintain and/or control the state of fill of the one or more or all fuel storage canisters or cartridges using state of fill data provided to the control circuitry by the one or more or all fuel storage canisters or cartridges to the control circuitry. In this regard, a fuel storage canister or cartridge may provide the “initial” state of fill to the control circuitry and using that data, the control circuitry may determine, calculate, monitor, manage, maintain and/or control the state of fill of the fuel storage canister or cartridge based on usage and/or operating parameters (for example, pressure and/or temperature). (See, for example, FIG. 15 in those instances where the fuel storage canister or cartridge employs a metal hydride storage technology). As noted above, the state of fill may be representative of the amount of fuel remaining in the fuel storage canister or cartridge and/or consumed from the fuel storage canister or cartridge.

The control circuitry may employ the “initial” state of fill of a fuel storage canister or cartridge to determine an absolute measure, for example, based on an amount of time the fuel storage canister or cartridge has been connected to and providing fuel to fuel cell power unit. In addition to, or in lieu thereof, in another embodiment, the control circuitry may receive, sample and/or acquire data from sensors (for example, temperature, pressure and/or flow rate type sensors) disposed on, in or near fuel storage canister or cartridge and, using such data, calculate, determine and/or estimate the state of fill of one or more of fuel storage canisters or cartridges. As noted above, the control circuitry may calculate, determine and/or estimate the state of fill using mathematical relationships, empirical data and/or modeling.

In another embodiment, the control circuitry may obtain data which is representative of the flow rate of fluid (i) through a valve assembly on/in the fuel storage canister or cartridge, and/or (ii) into the fluid interface and/or manifold of the dock-type device/unit. The sensors may be discrete elements, such as one or more microelectromechanical devices, temperature sensors, pressure sensors, and/or flow rate sensors. Such sensors may be integrated into one or more other components of the fuel storage canister or cartridge and/or dock-type device/unit (for example, one or more temperature elements integrated into and disposed within the walls of the fuel vessel of the fuel storage canister or cartridge or in a valve assembly of the fuel storage canister or cartridge and/or interface of the dock-type device/unit. Notably, any type of sensor, whether now known or later developed, which may be employed to provide information to the control circuitry may be implemented herein; indeed, such sensors are intended to fall within the scope of the present inventions.

In addition to, or in lieu of the techniques described above, in other embodiments, the control circuitry may obtain data which is representative operating characteristics of the chemical-type fuel storage canister or cartridge. In one embodiment, the control circuitry may receive data which is representation of the number of revolutions or output of a pump (within the chemical-type fuel storage canister or cartridge). In another embodiment, the control circuitry may receive data which is representation of the number of actuation pellets “fired” by, for example, the control circuitry of chemical-type fuel storage canister or cartridge. Based on this operating characteristic/parameter data, control circuitry in the dock-type device/unit may determine, calculate, monitor, manage, maintain and/or control the state of fill of a fuel storage canister or cartridge.

The operating characteristic/parameter data may be provided to the control circuitry before operation (for example, when connected to the interface of the dock-type device/unit) and thereafter the state of fill may be determined, calculated and/or monitored by the control circuitry in the dock-type device/unit. Thus, in these embodiment, in addition to pressure and/or temperature related data, or in lieu thereof, the control circuitry may employ other operating characteristic/parameter data to determine, calculate, monitor, manage, maintain and/or control the state of fill of a fuel storage canister or cartridge (for example, chemical-type).

Notably, the control circuitry, in another embodiment, may obtain data which is representative of the state of fill of the fuel storage canister or cartridge and, in response, may calculate a weighted sum of fluid/fuel use by the fuel cell power unit. The control circuitry may then report the weighted average to, for example, external circuitry and/or the user/operator (via for example, the user/operator interface). Moreover based on the state of fill reported by the fuel storage canister or cartridge, the control circuitry may implement a pre-programmed fuel consumption strategy. For example, one or more fuel storage canisters or cartridges may be first consumed and thereafter one or more other fuel storage canisters or cartridges. Alternatively, the consumption of the one or more of the fuel storage canisters or cartridges may be weighted so that all of the one or more of the fuel storage canisters or cartridges is consumed at the same or substantially the same time.

The control circuitry (for example, controller or processor) resident in or on the dock-type device/unit may include one or more (or all) of the designs, types and/or features, as well as perform one or more (or all) of the functions and operation/control techniques of any embodiment of the resident controller described and illustrated in Non-Provisional patent application Ser. No. 11/340,158, filed Jan. 26, 2005, entitled “Modular Fuel Cell Power System, and Technique for Controlling and/or Operating Same” (hereinafter “the Modular Fuel Cell Power System Patent Application”). The Modular Fuel Cell Power System Patent Application is incorporated by reference herein in its entirety. For the sake of brevity, those discussions/illustrations are incorporated by reference herein.

In addition to determining, calculating, monitoring, managing, maintaining and/or controlling one or more parameters (for example, the state of fill) of the fuel storage canister or cartridge (see, for example, FIGS. 4A-4C and 4E), or in lieu thereof (see, for example, FIG. 4D), the control circuitry may control the operation of the fuel cell power unit (or components thereof, for example, one or more of the fuel cell power sub-units or voltage regulator circuitry). In this embodiment, the control circuitry may control the characteristics and amount of electrical power generated by the fuel cell power unit and/or the characteristics and amount of electrical power output by the fuel cell power unit. In this embodiment, the control circuitry may manage, limit and/or control the amount of power generated or output by the fuel cell power unit (or one or more of the fuel cell power sub-units) via more direct control of the fuel cell stack(s) and/or voltage regulator unit or sub-units. For example, in those embodiments where the fuel cell power unit includes power circuitry with embedded variable resistors, the control circuitry (for example, a processor or controller) may change the effective resistance, resulting in a specific output voltage or a specific current limit based on the specific value(s) of digital resistor(s). All circuitry, mechanisms and techniques for managing, limiting and/or controlling the amount of power generated or output by the fuel cell power unit, whether now known or later developed, are intended to fall within the scope of the present inventions.

The control circuitry of the dock-type device/unit may receive data which is representative of the operating parameters or characteristics of the fuel cell power unit (or components thereof) including suitable/permissible/required fuel type(s), fuel consumption rate, maximum consumption rate of the fuel, minimum consumption rate of the fuel, maximum power, minimum power, start-up time, and shut-down time. For example, in those situations where one or more fuel storage canisters or cartridges require a “higher” hydrogen flow rate to start-up a reactor therein in order to attain a sufficiently high reactor temperature, a “request flag” may be set to cause a purge in the fuel cell power unit. The control circuitry may check the status of the request flag and pass requests to the fuel cell power unit (or components thereof, for example, one or more fuel cell power sub-units associated with such fuel storage canisters or cartridges). In response, the fuel cell power unit (or components thereof) may perform a purge operation resulting in a momentarily high flow-rate.

Notably, the dock-type device/unit may also include a purge valve to facilitate this request. Indeed, purging may also be advantageous to “clear” the fluid bus/lines to, for example, remove air trapped in the bus/lines and/or fuel storage canisters or cartridges, this is primarily a start-up condition. In this way, the control circuitry may provide an enhanced, optimum, pre-programmed and/or suitable performance of the system.

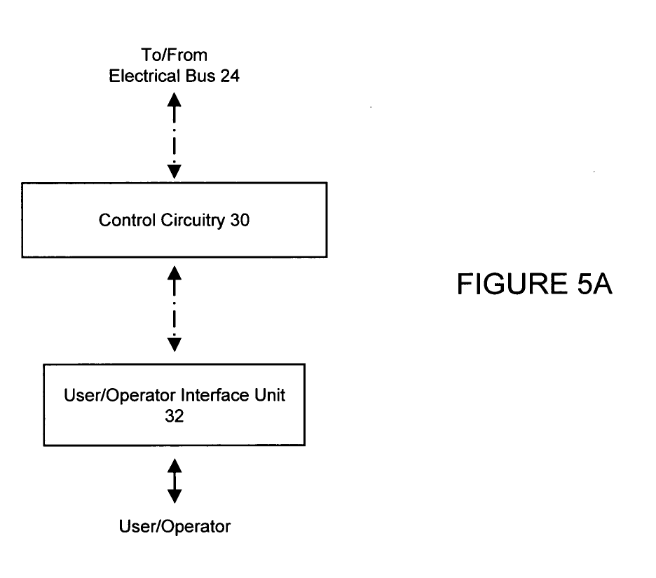

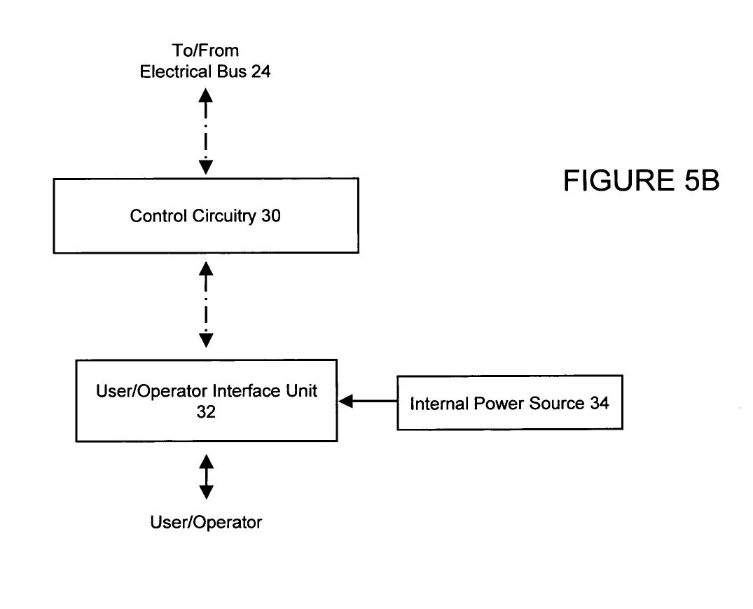

The control circuitry (for example, controller or processor) may connect to a user/operator interface unit 32 for the user/operator to receive input commands or instructions (for example, to control the operation of the system) and to output data or information to the user/operator. (See, for example, FIG. 5A). In this embodiment, the system includes a user/operator interface unit (for example, having input mechanisms (such as switches and buttons) and output mechanisms (such as a display screen and/or audible generating device)) to facilitate communications with the user/operator.

Notably, the dock-type device/unit may include an internal power source 34 which is distinct from the fuel cell power unit. (See, for example, FIG. 5B). For example, the dock-type device/unit may include a battery (for example, rechargeable), solar panel or 110/220V AC which provides power to the user/operator interface unit. In this way, when the fuel cell power unit is not in operation, the user/operator interface unit is powered and prepared to receive inputs and provide outputs (for example, of the current state of the system or components thereof (such as, the state of fill of one or more of the fuel storage canisters or cartridges and/or the aggregate thereof)).

The internal power source may be employed to facilitate enabling or activating generation of the fuel in one or more of the fuel storage canisters or cartridges. For example, where one or more of the fuel storage canisters or cartridges contains a sodium borohydride fuel (where, for example, fuel cell power unit includes sodium borohydride fuel cells) or a sodium borohydride hydrogen generation system (where, for example, fuel cell power unit includes hydrogen fuel cells), the internal power source (for example, battery) may provide the necessary/sufficient power to the pump in the fuel storage canister or cartridge for the reactor to heat-up and begin generating hydrogen.

Indeed, the internal power source (for example, battery) may be employed to buffer the output power from the fuel cell power unit for either start-up or transient conditions. In this embodiment, the internal power source may be permanently or temporarily connected in the output power path of the dock-type device/unit. Notably, the internal power source may be fixed, removable or partially removable in the dock-type device/unit. Where the internal power source is a battery, the battery may be rechargeable (via an external device or the fuel cell power unit) or non-rechargeable.

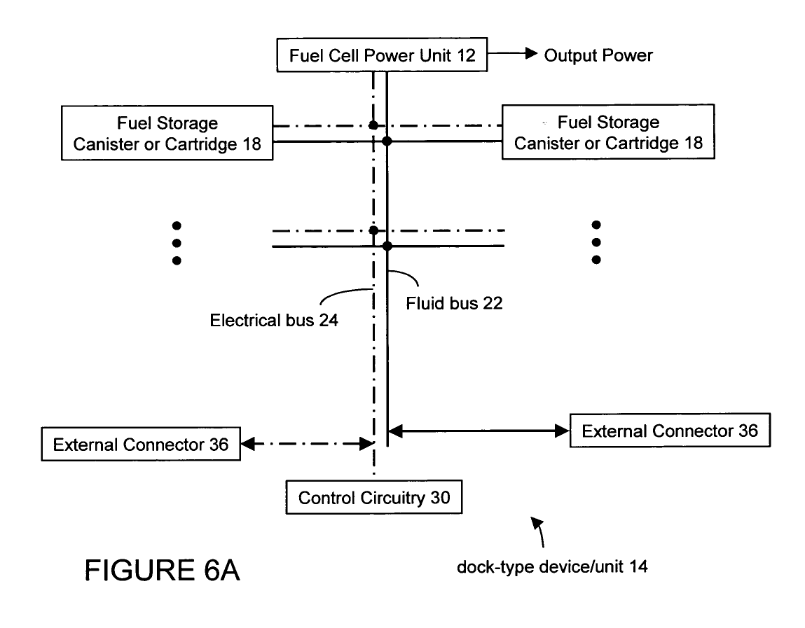

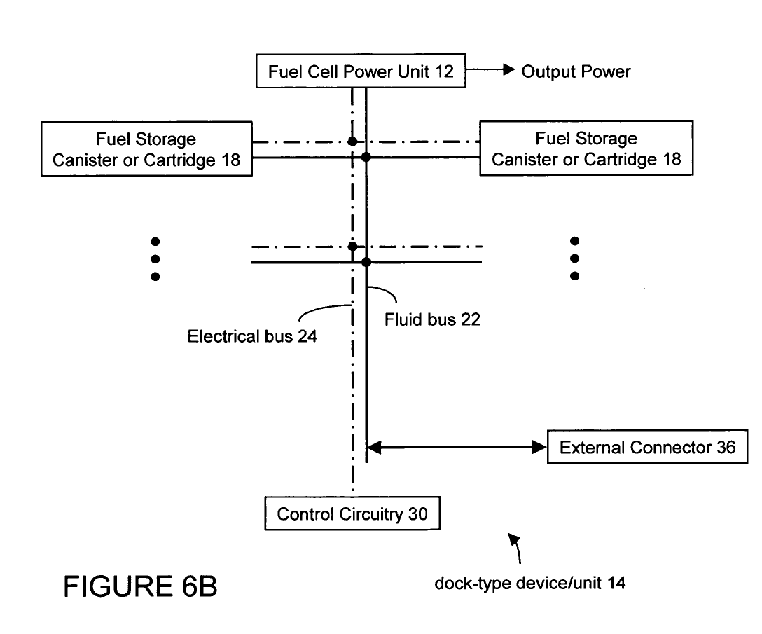

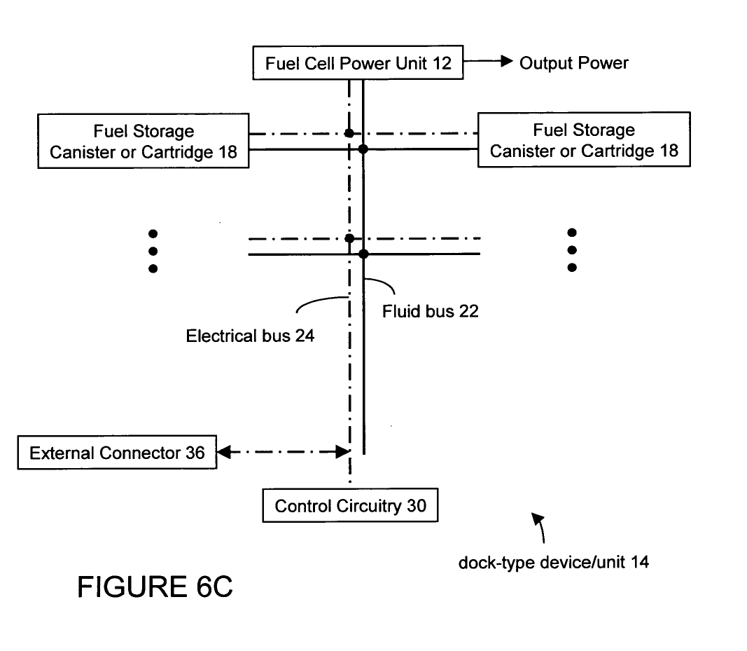

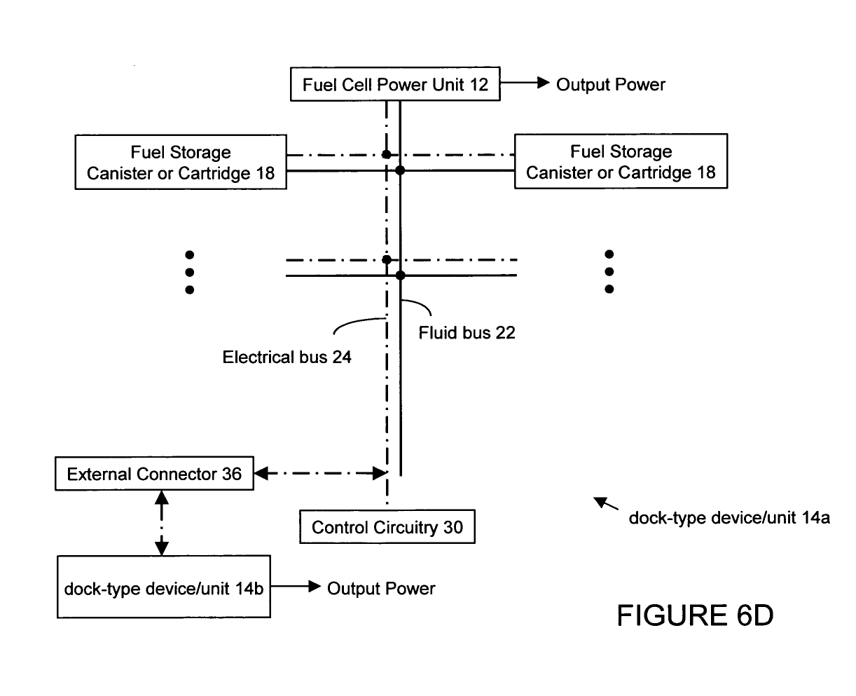

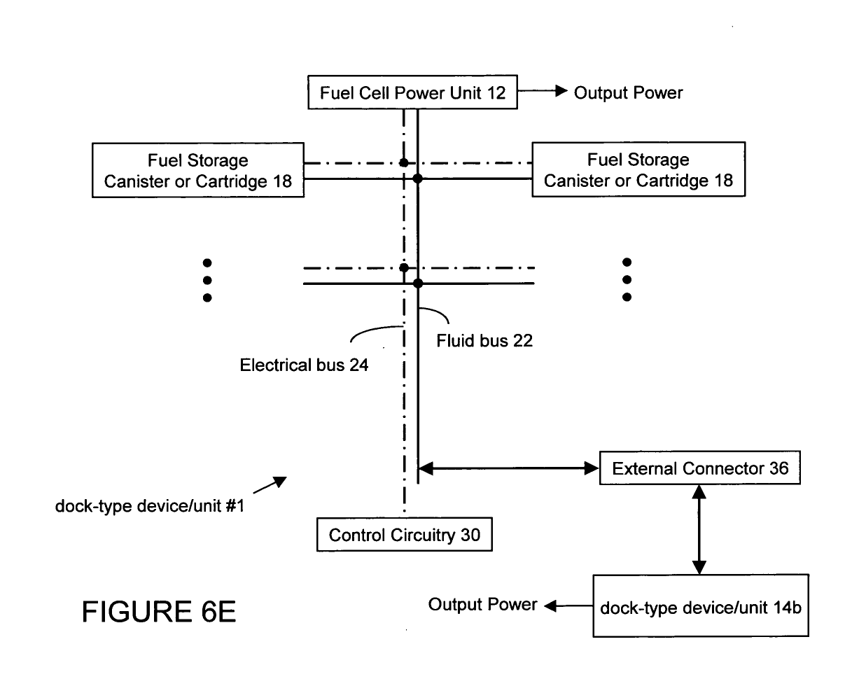

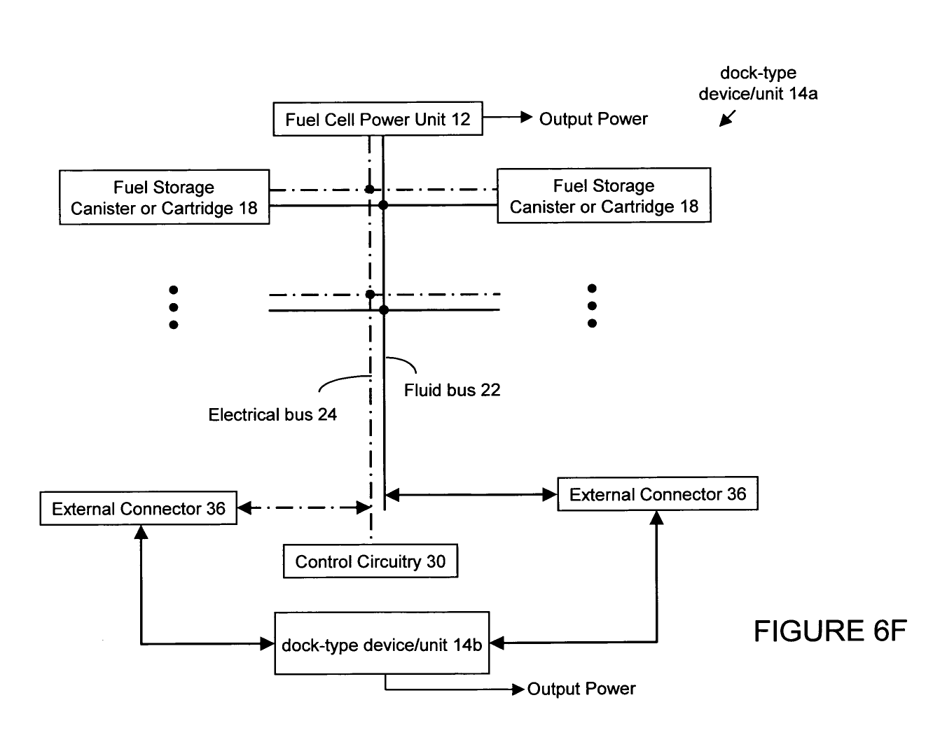

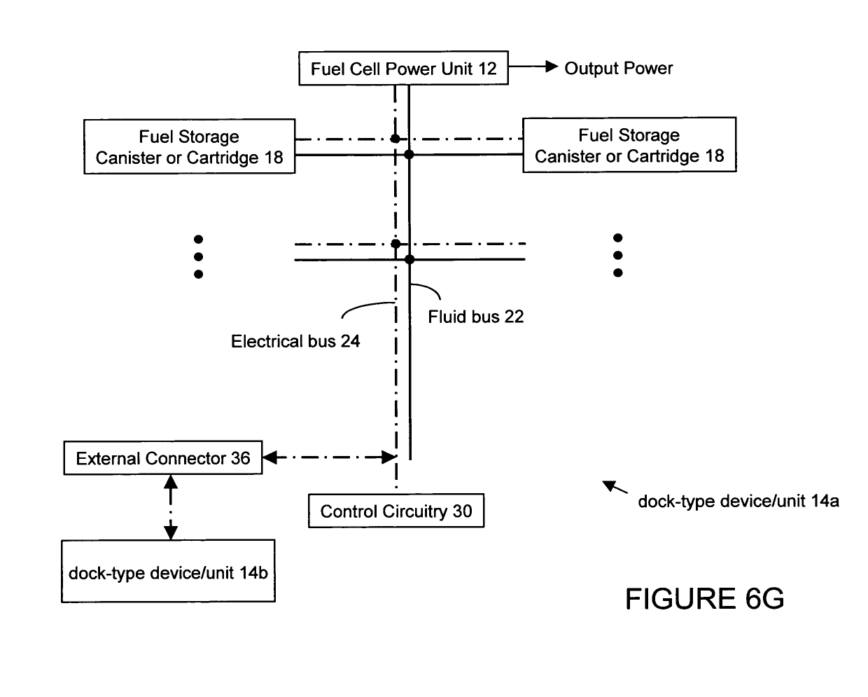

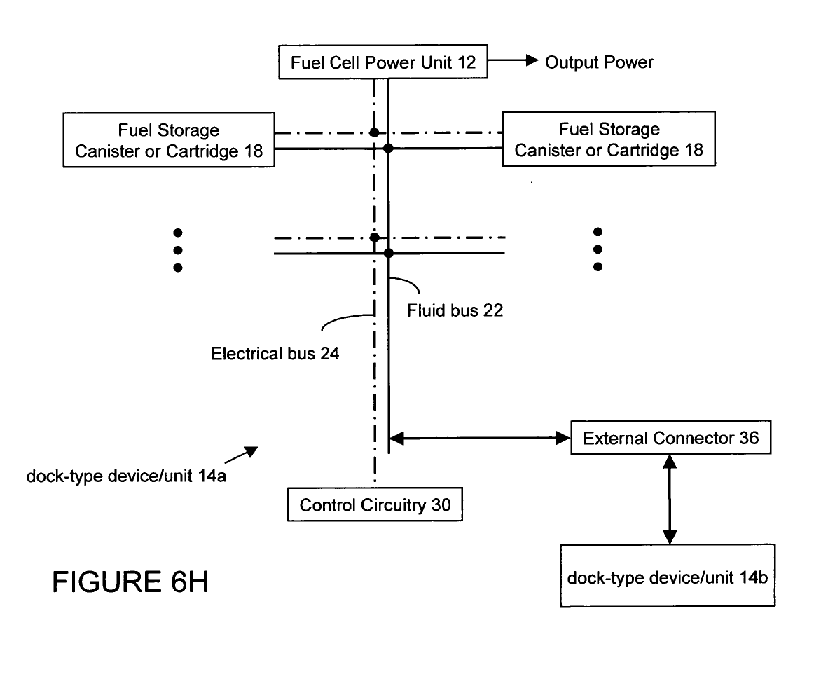

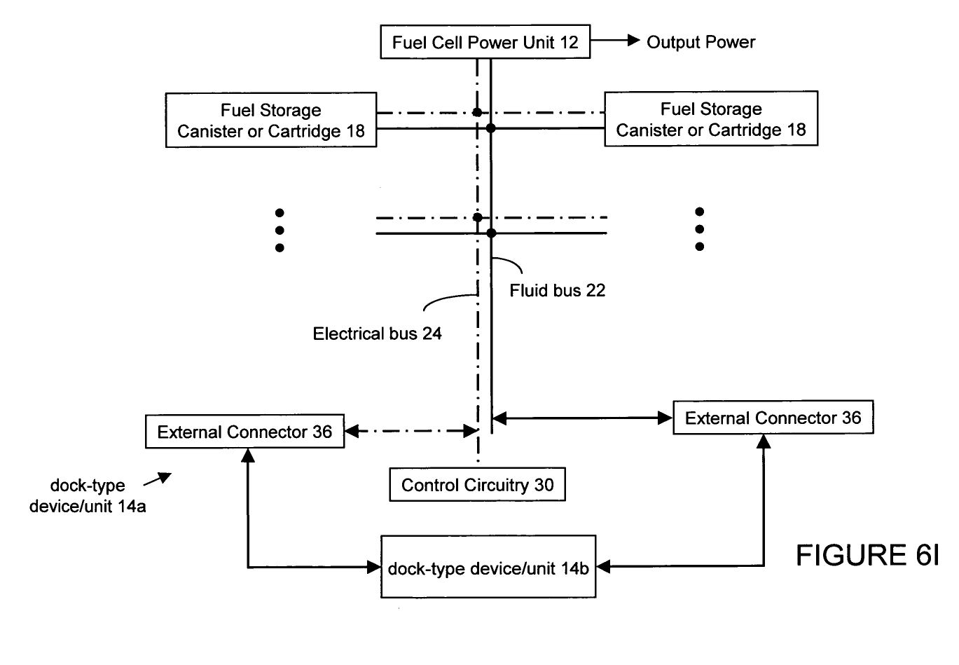

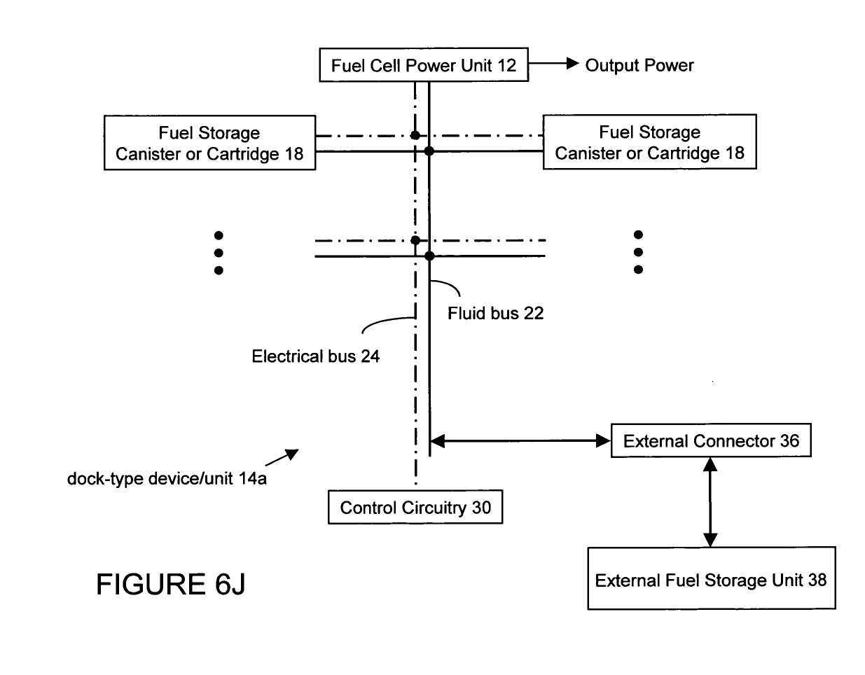

With reference to FIGS. 6A-6C, the system may also include one or more input ports having one or more external connectors 36 which facilitate connection to the fluid and/or electrical bus of the dock-type device/unit. The one or more external connectors 36 may be disposed on an outer surface of the dock-type device/unit and provide for fluid and/or electrical communication with an external unit (for example, a fuel source, fuel cell, fuel cell power unit, control circuitry (for example, processor or controller), and/or a second dock-type device/unit (see, for example, FIGS. 6D-6I). Where two or more dock-type device/units interconnected, such dock-type device/units may provide, a distributed network for redundant power sources, fault-tolerant systems and/or load sharing between the plurality of interconnected dock-type devices/units). In this embodiment, the external electrical connector facilitates electrical communication between the plurality of dock-type device/units. (See, for example, FIGS. 6D and 6F). Where the external connector 36 is a fluid type connector, the external fluid connector may connect to the fluid bus of the dock-type device/unit, for example, before the fluid manifold or connect directly to the fuel cell power unit (i.e., “downstream” from the fluid manifold). (See, for example, FIGS. 6E and 6F).

Notably, although the two or more dock-type device/units interconnected, the second dock-type device/unit may not provide output power. (See, for example, FIGS. 6G-6I). In this embodiment, the second dock-type device/unit may be a fault-tolerant unit or an additional or back-up supply of fuel (via the fuel contained in the fuel storage canisters or cartridges connected to the second dock-type device/unit.

In addition, the external fluid connector 36 may connect to an external fuel storage unit 38 (for example, an external fuel tank such as a K-bottle size fuel tank). The external connector of this embodiment facilitates fluid communication with the fuel cell power unit, for example, one or more of the fuel cell stacks of one or more of the fuel cell power sub-units. (See, for example, FIG. 6J)

Notably, the external fluid connector may be employed to refill the fuel storage canister or cartridge. In this regard, an external fuel source may be connected to the external fluid connector and the fluid manifold may be operated in a manner that fluid/fuel is output to the fuel storage canister or cartridge. In one embodiment, the system remains in operation (i.e., electrical power is generated) while refilling one or more fuel storage canisters or cartridges. In this embodiment, the fuel cell power unit may receive fuel from the external fuel source and/or from one or more fuel storage canisters or cartridges which are not being refilled. In another embodiment, the system does not remain in operation (i.e., the fuel cell power unit is disabled) while refilling one or more fuel storage canisters or cartridges. In another embodiment one of the ports of the dock type device may be connected to a hydrogen source in a manner that allows it to refill the fuel cartridges or canisters in the other ports of the dock type device. There are several strategies that can be employed to accomplish the capability to refill the fuel cartridges or canisters and are considered known to one skilled in the art based on the above embodiments.

In those circumstances where the external connector is an electrical type connector, an external electrical/electronic device (for example, a computer, PDA and/or mobile communication device) may access and/or communicate with the control circuitry, one or more of the fuel cartridges or canisters, and/or the fuel cell power unit (or components thereof, for example, one or more of the fuel cell power sub-units). The external connector may provide wireless (for example, optical (such as IR), RF, low-frequency inductive coupling), and/or wired communications. The external connector of this embodiment facilitates communication with one or more portions of the electrical bus of the dock-type device/unit. For example, the external connector may provide for an external communications or power port that may be used to monitor the state, status or “health”, and/or operation of the fuel cell power unit (or components thereof), and/or fuel storage canister(s) or cartridge(s). Thus, in this embodiment, the user/operator may access the system (for example, one or more of the fuel cartridges or canisters, the control circuitry and/or the fuel cell power unit) using external circuitry or an external device (for example, a computer or PDA).

Notably, the dock-type device/unit may implement any of the embodiments, circuitry, features, functions, techniques and/or operations described and/or illustrated in the Modular Fuel Cell Power System Patent Application. As stated above, the Modular Fuel Cell Power System Patent Application is incorporated by reference herein in its entirety.

As mentioned above, the fuel cell power unit generates electrical power from fuel provided by the one or more fuel storage canisters or cartridges. In one embodiment, the fuel cell power unit includes one or more fuel cell stacks. The fuel cell power unit may include, for example, one or more fuel cell power sub-units, each including one or more fuel cell stacks. In this embodiment, the fuel cell stacks are arranged in groups according to one or more fuel cell power sub-units. As such, in this embodiment, the fuel cell power sub-units generate electrical power from fuel provided by the one or more fuel storage canisters or cartridges wherein the output electrical power of the fuel cell power unit may be distributed, allocated and/or partitioned according to one or more fuel cell power sub-units.

The fuel cell power unit may include a voltage conditioning unit to generate one or more conditioned voltages (for example, 110V AC or 220V AC) from the electrical power output by the fuel cell power unit. The voltage conditioning unit includes one or more electrical components (for example, DC-DC converter(s) or DC-AC inverter device(s)) to condition the output electrical power of the one or more fuel cells. In one embodiment, each fuel cell stack of the fuel cell power unit is electrically connected to a common voltage conditioning device (for example, a DC-DC converter or a DC-AC inverter device) which generates conditioned electrical power from the output of each fuel cell stack.

In one embodiment, the voltage conditioning unit includes one or more voltage conditioning sub-units, each including one or more electrical components (for example, DC-DC converter(s) or DC-AC inverter device(s)) to condition the output electrical power of the one or more fuel cells. In this embodiment, one or more fuel cell stacks may be connected to an associated or dedicated voltage conditioning sub-unit wherein the associated or dedicated voltage conditioning sub-unit provides or outputs conditioned power using the output of the associated fuel cell stacks. In this regard, the associated fuel cell stacks may be the fuel cell stacks of one or more fuel cell power sub-units. Notably, as mentioned above, any combination or architecture of fuel cell stack to voltage conditioning device is intended to fall within the scope of the present inventions.

The system (for example, the control circuitry resident on/in the dock-type device/unit) may implement sequential or simultaneous use of the fuel in the one or more fuel canisters or cartridges. Such use may be temporally based in that during a first time the system implements a sequential use of the fuel in the fuel canisters or cartridges and during a second time, the system implements a simultaneous use of the fuel in the fuel canisters or cartridges.

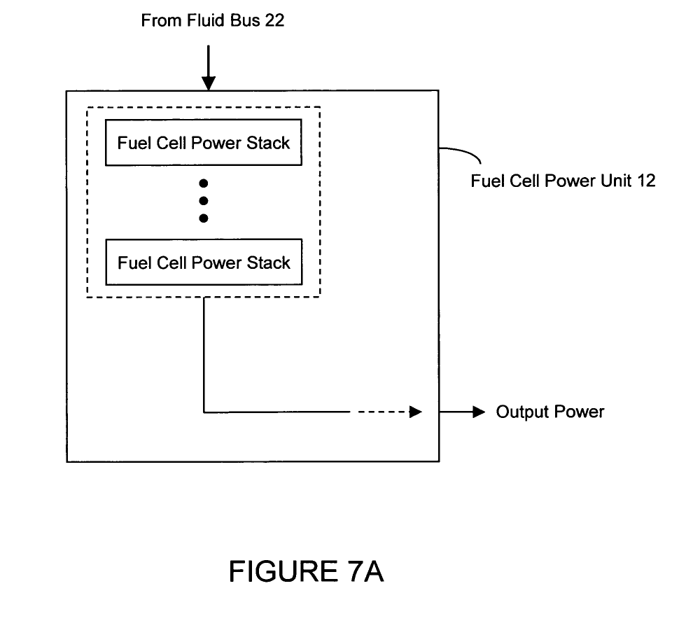

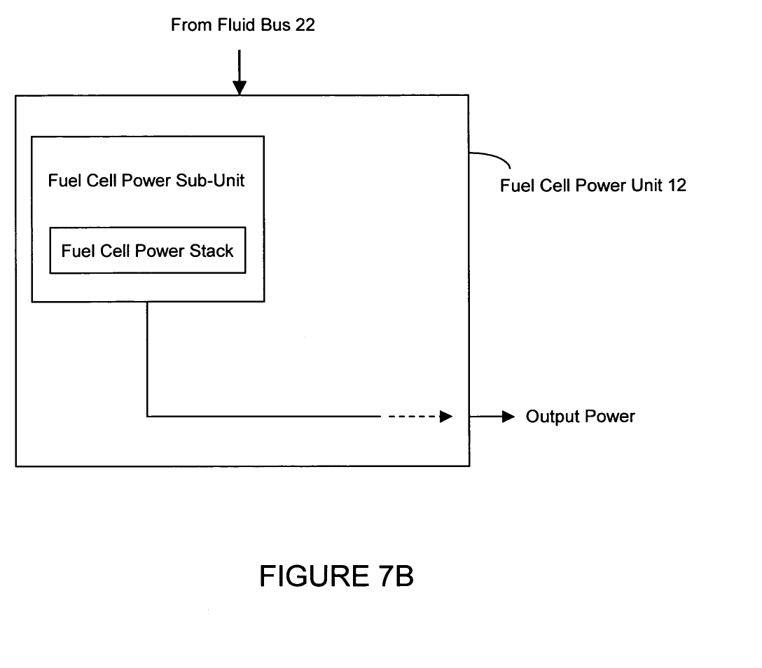

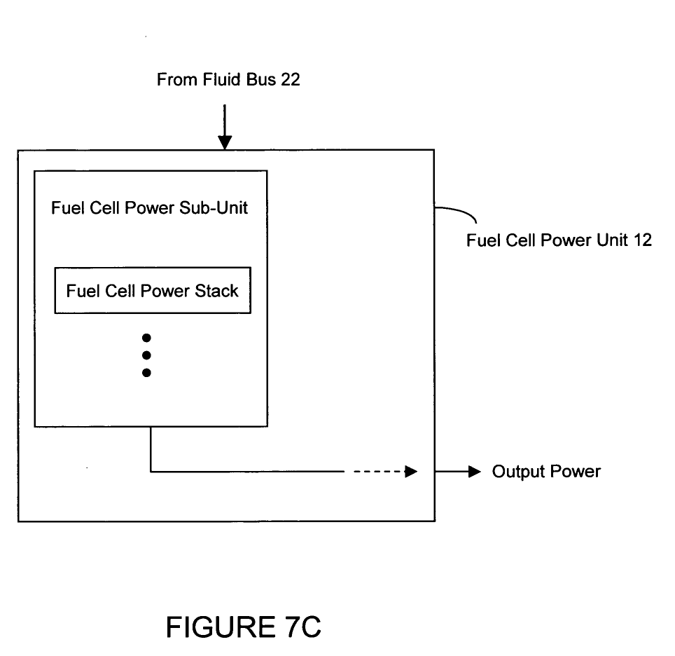

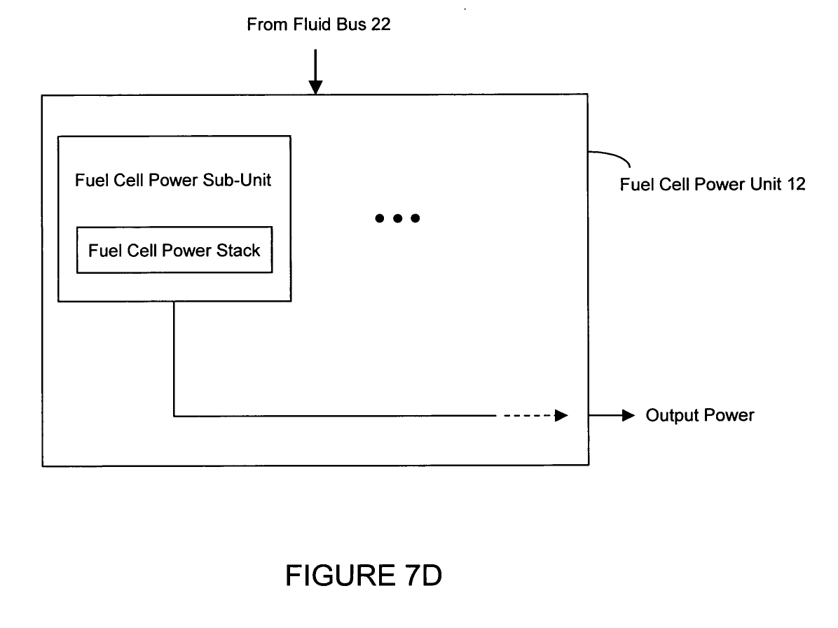

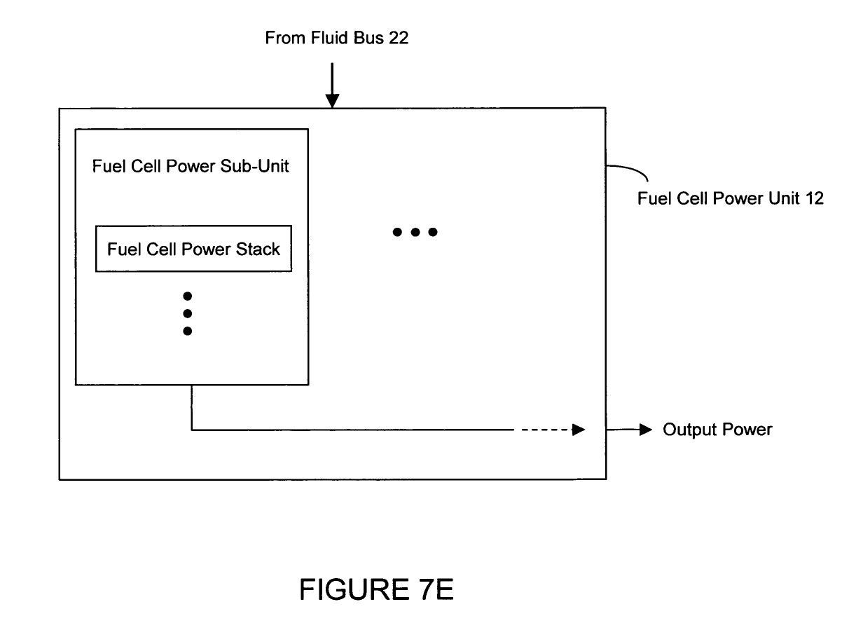

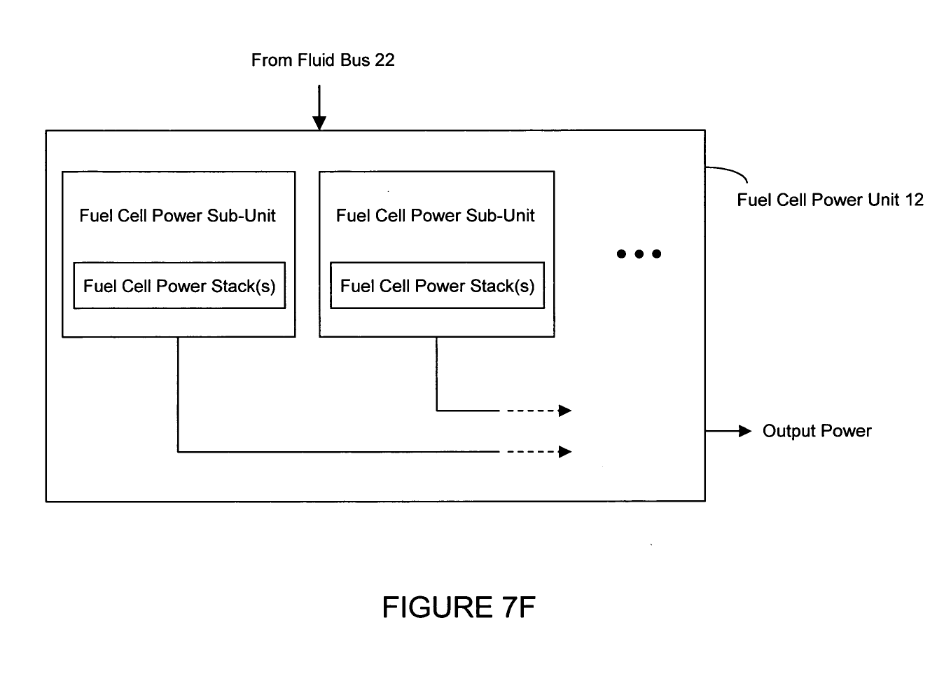

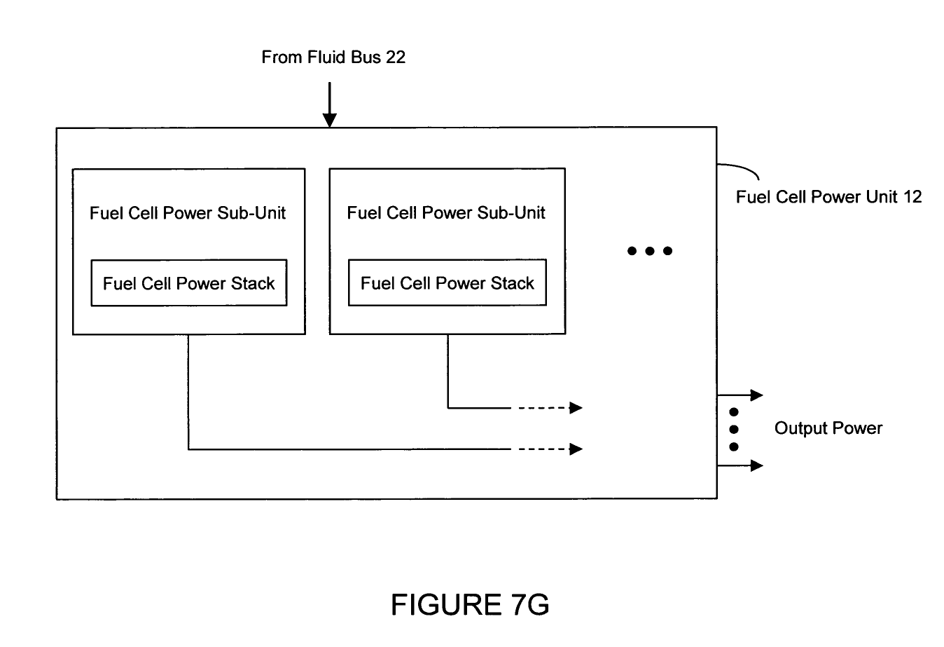

In operation, the fuel cell power unit generates electrical power from fuel provided by one or more fuel storage canisters or cartridges. In one embodiment, the fuel cell power unit includes one or more fuel cell stacks. (See, for example, FIG. 7A). The fuel cell power unit may include, for example, one or more fuel cell power sub-units, each including one or more fuel cell stacks. (See, for example, FIGS. 7B-7E). In this embodiment, the fuel cell stacks are arranged in groups according to one or more fuel cell power sub-units. As such, in this embodiment, the fuel cell power sub-units generate electrical power from fuel provided by the one or more fuel storage canisters or cartridges wherein the output electrical power of the fuel cell power unit may be distributed, allocated and/or partitioned according to one or more fuel cell power sub-units. (See, for example, FIGS. 7F and 7G).

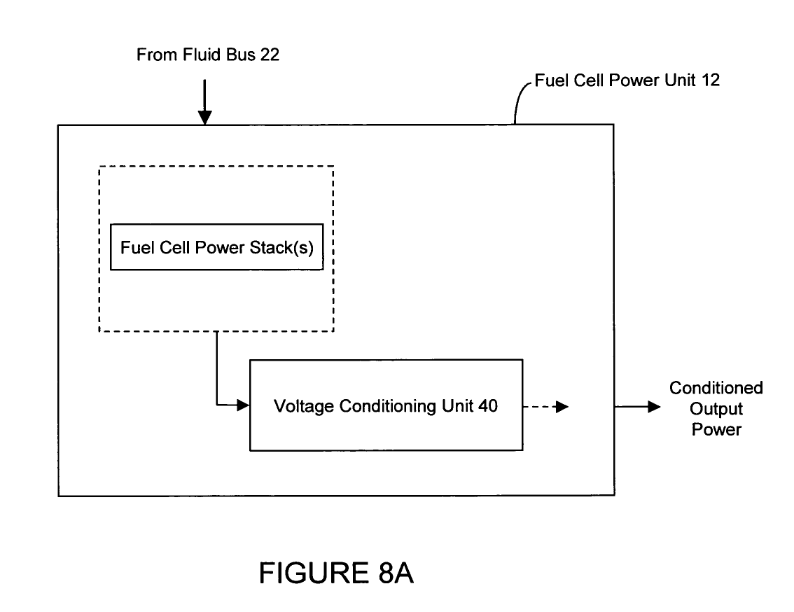

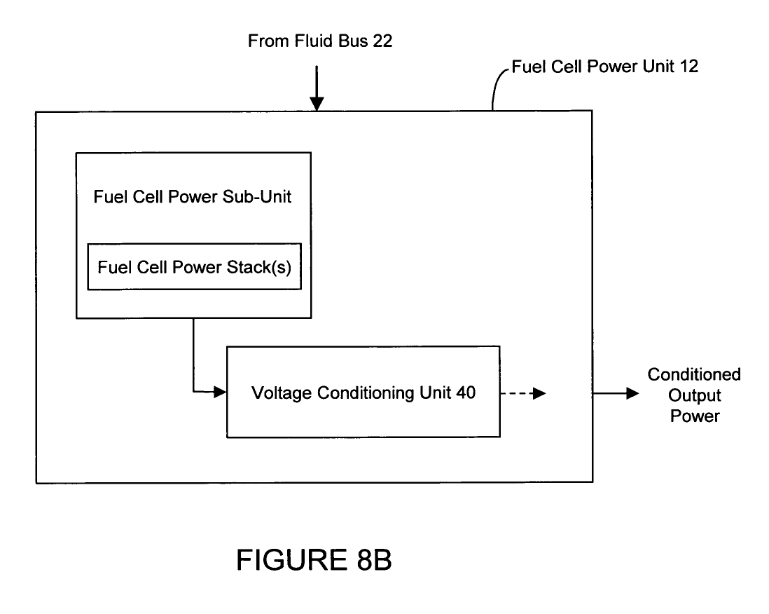

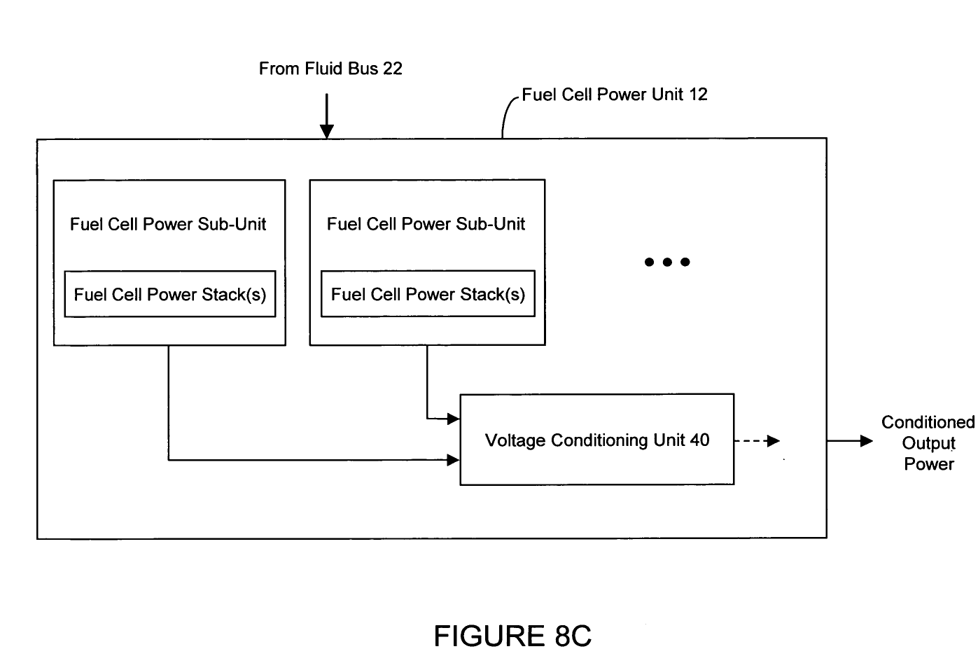

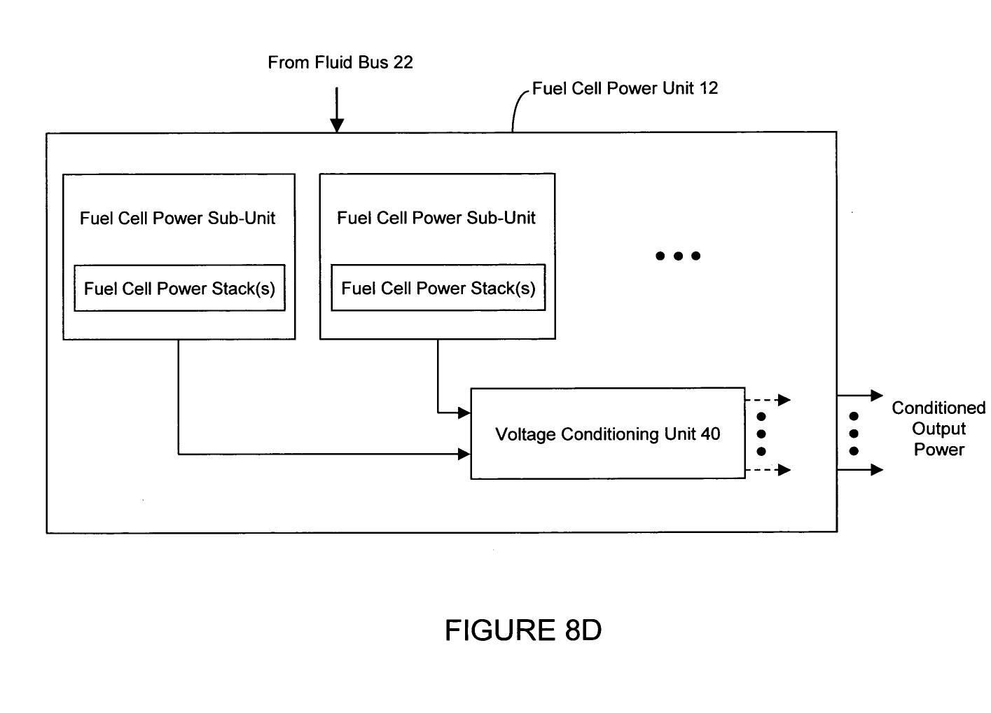

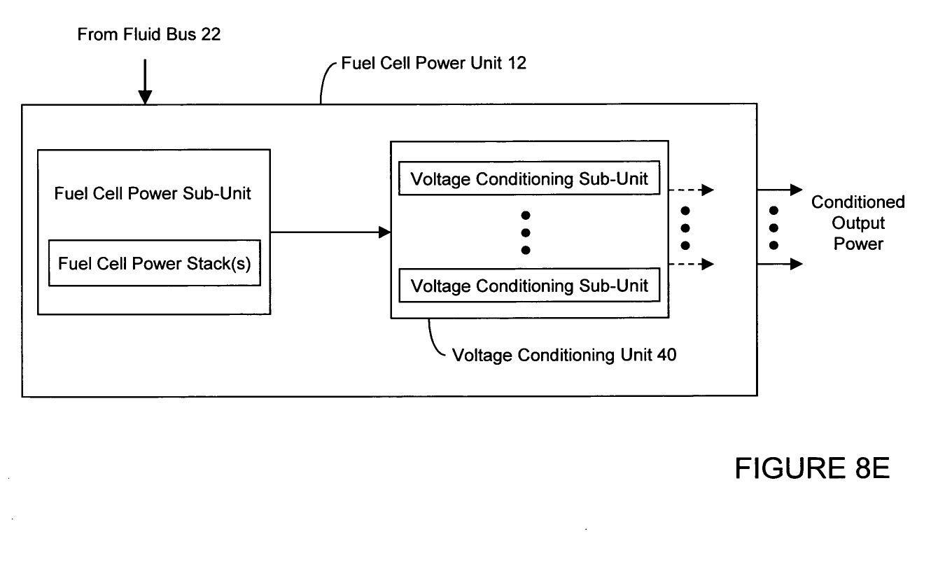

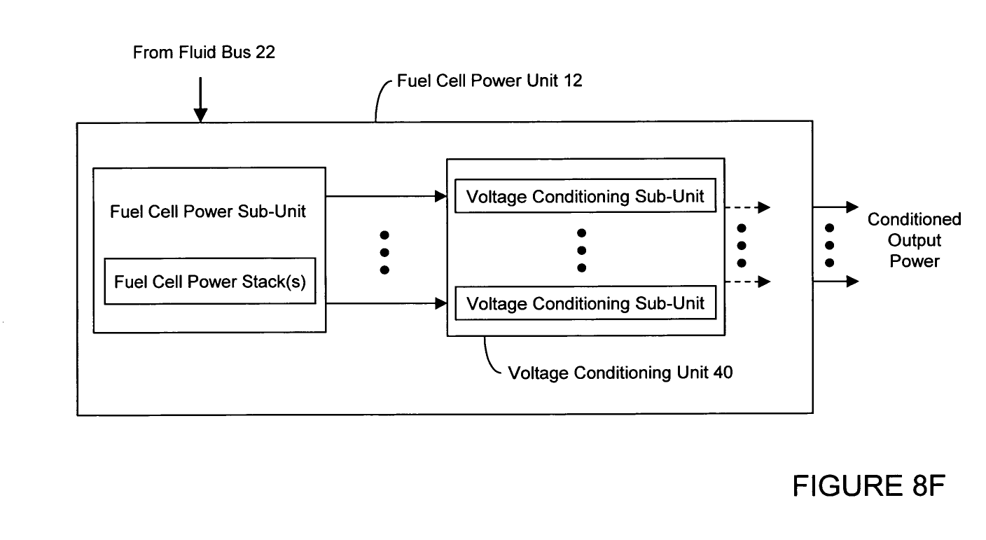

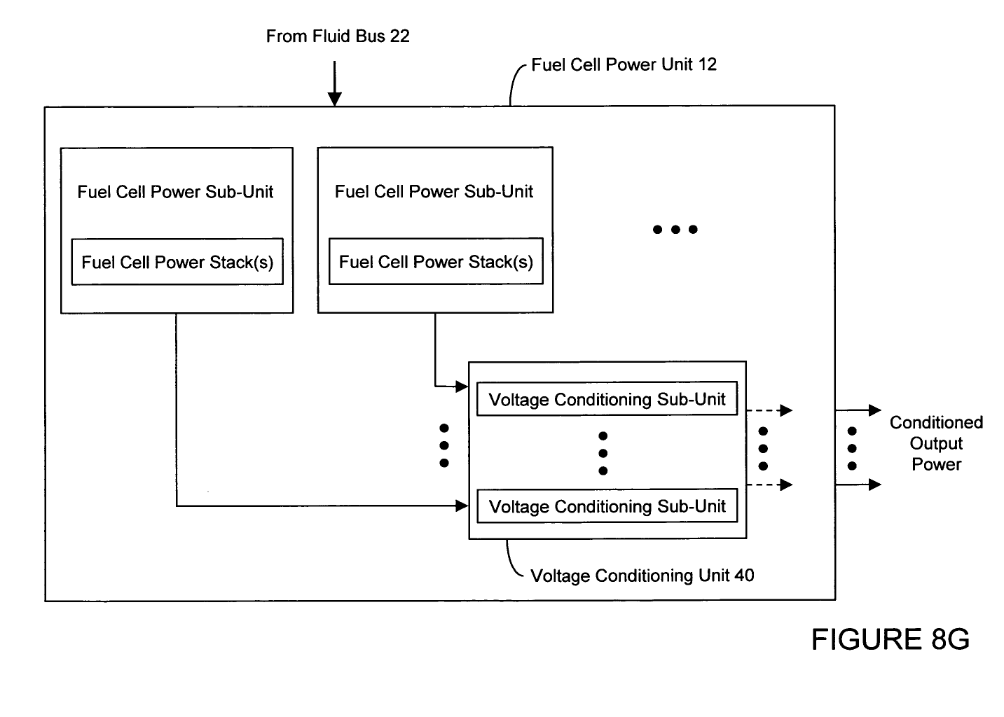

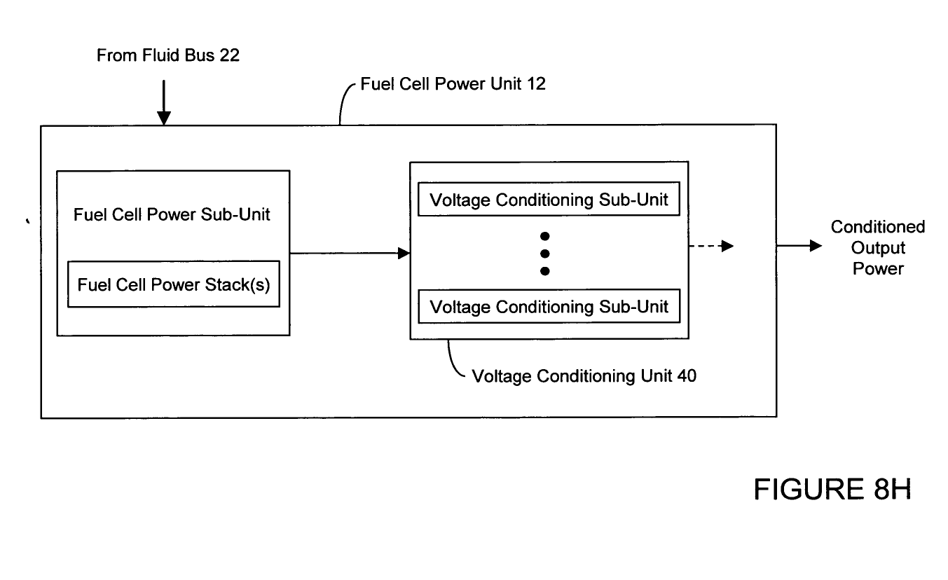

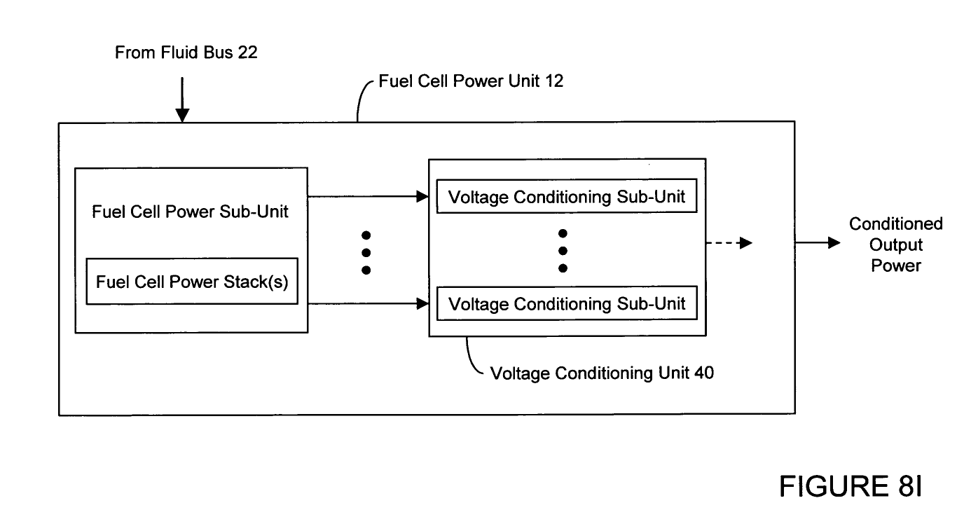

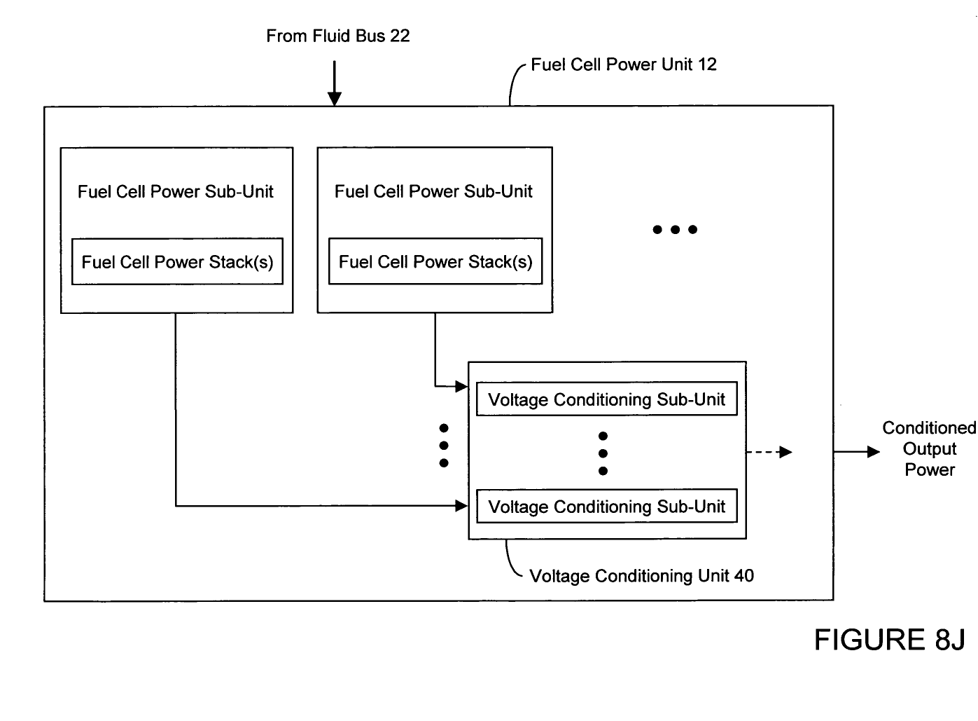

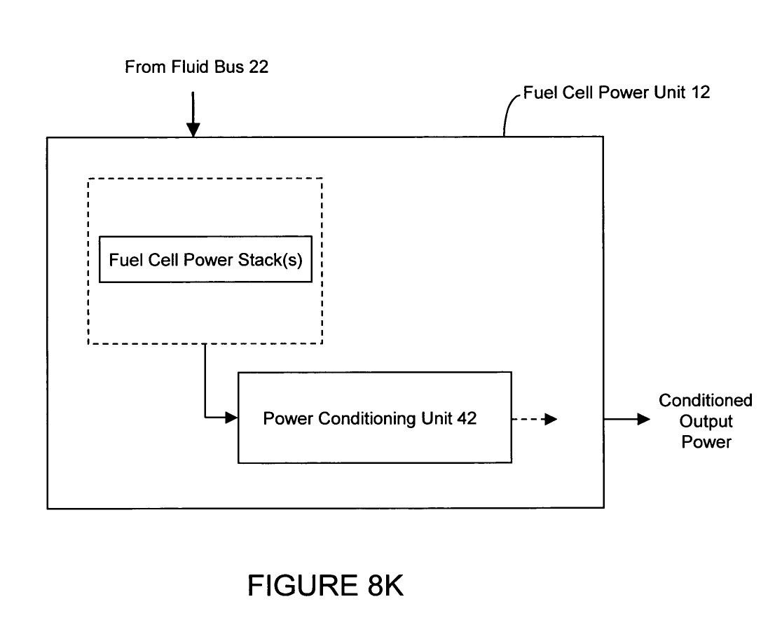

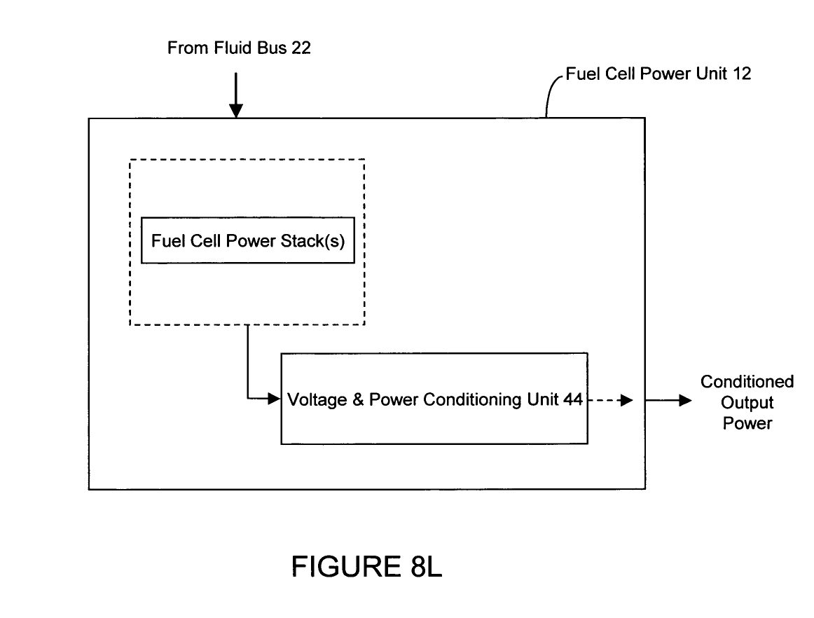

The fuel cell power unit may include a voltage conditioning unit and/or a power conditioning unit to generate a conditioned voltage (for example, 110V AC or 220V AC) and/or conditioned power (respectively) from the electrical signals generated by the fuel cell stacks. The voltage conditioning unit includes one or more electrical components (for example, DC-DC converter(s) or DC-AC inverter device(s)) to condition the output voltage of one or more fuel cell stacks. In one embodiment, each fuel cell stack of the fuel cell power unit is electrically connected to a common voltage conditioning unit 40 (for example, a DC-DC converter or a DC-AC inverter device) which generates a conditioned voltage from the output of each fuel cell stack. (See, for example, FIGS. 8A and 8B).

The voltage conditioning unit 40 may output one conditioned voltage or a plurality of conditioned voltages. (See, for example, FIGS. 8C and 8D). The plurality of conditioned voltages may be the same or different voltages. Indeed, in one embodiment, the voltage conditioning unit 40 may include a programmable or user/operator selection unit that allows selection or programmability of one or more conditioned output voltages (for example, an 110V AC output and a 24V DC output). Notably, any combination of conditioned voltages is intended to fall within the scope of the present invention.

The voltage conditioning unit may include one or more voltage conditioning sub-units, each including one or more electrical components (for example, DC-DC converter(s) or DC-AC inverter device(s)) to condition the output electrical power of the one or more fuel cells. (See, for example, FIGS. 8E-8J). In this embodiment, one or more fuel cell stacks may be connected to an associated or dedicated voltage conditioning sub-unit wherein the associated or dedicated voltage conditioning sub-unit provides or outputs a conditioned voltage using the output of the associated fuel cell stacks. The associated fuel cell stacks may be the fuel cell stacks of one or more fuel cell power sub-units. Each output of the voltage conditioning sub-units may be provided as an independent conditioned voltage (which may or may not be programmable). (See, for example, FIGS. 8E-8G). In another embodiment, one or more of the outputs of the voltage conditioning sub-units may be provided in a “ganged” architecture. (See, for example, FIGS. 8H-8J). Notably, as mentioned above, any combination or architecture of fuel cell stack to voltage conditioning device is intended to fall within the scope of the present inventions.

As mentioned above, the fuel cell power unit may include a power conditioning unit to generate a conditioned power from the electrical power generated by the fuel cell stacks. The power conditioning unit includes one or more electrical components (for example, DC-DC converter(s) or DC-AC inverter device(s)) to condition the output power of the fuel cell stack(s). The configurations, architectures and circuitry of the power conditioning unit may be the same as or similar to configurations, architectures and circuitry of the voltage conditioning units as exemplary illustrated in FIGS. 8A-8J. For example, in one embodiment, each fuel cell stack of the fuel cell power unit is electrically connected to a common power conditioning unit 42 which generates conditioned power from the output of each fuel cell stack. (See, for example, FIG. 8K). Indeed, the fuel cell power unit may include a voltage and power conditioning unit 44. (See, for example, FIG. 8L). Again, the configurations, architectures and circuitry of the voltage and power conditioning unit 44 may be the same as or similar to configurations, architectures and circuitry of the voltage conditioning units.

Notably, in multi-fuel cell applications which output a range of voltages or the same voltage, the system may program certain fuel cell(s) to provide a voltage and current having predetermined characteristics. However, in another embodiment, the dock-type device/unit may output one or more “raw” voltages (i.e., without voltage and/or power conditioning) as well as conditioned voltages/power (via one or more voltage and/or power conditioning unit(s)).

Moreover, certain fuel technologies may require a particular voltage to operate. For example, a fuel storage cartridge containing ammonia borane may require 12V while a cartridge containing a metal hydride or a sodium borohydride may require 5V. The control circuitry on/in the dock-type unit and/or fuel storage cartridge or canister may adjust the operating voltage at the appropriate electrical interface to accommodate the fuel technology of the cartridge. Notably, however, where the cartridge includes voltage adjustment circuitry, such circuitry may adjust an input voltage (for example, 5V) to a required operating voltage (for example, 12V).

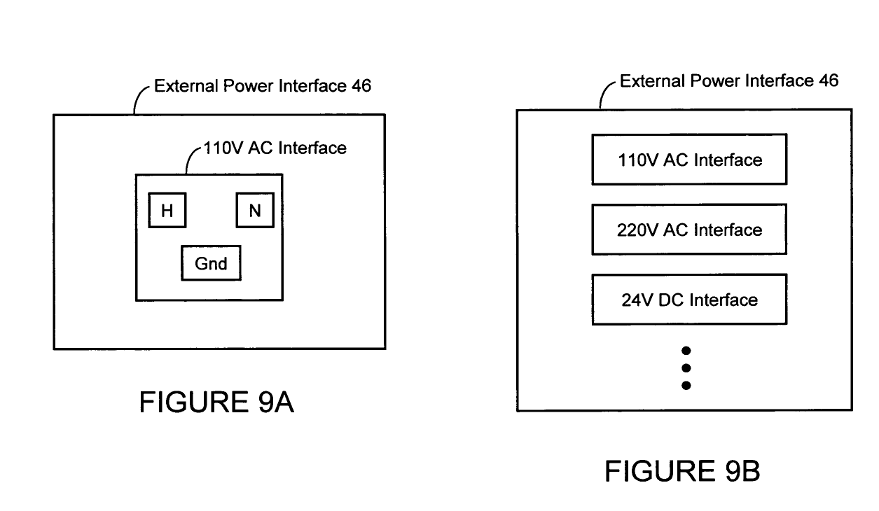

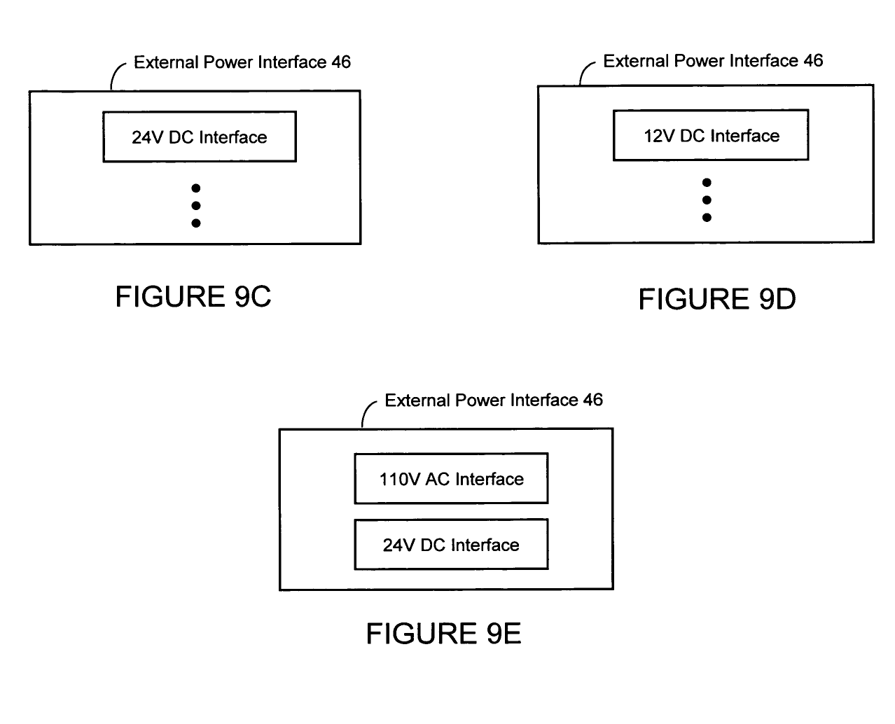

The dock-type device/unit may include one or more external output power interfaces to allow an external device to obtain the output power of the fuel cell power unit. The external output power interface 46 may include one or more standard-type interfaces to supply, for example, 110V AC, 220V AC, 12V DC, 14V DC, 24V DC, etc. (See, for example, FIGS. 9A-9E). Each interface 46 may be standard receptacle (for example, a standard 110V AC interface or a 24V DC automobile utility socket (often referred to as the cigarette lighter socket or the like)) or a non-standard type of interface which provides a standard or non-standard power supply. Indeed, one or more of the interfaces may be hardwired to an external device.

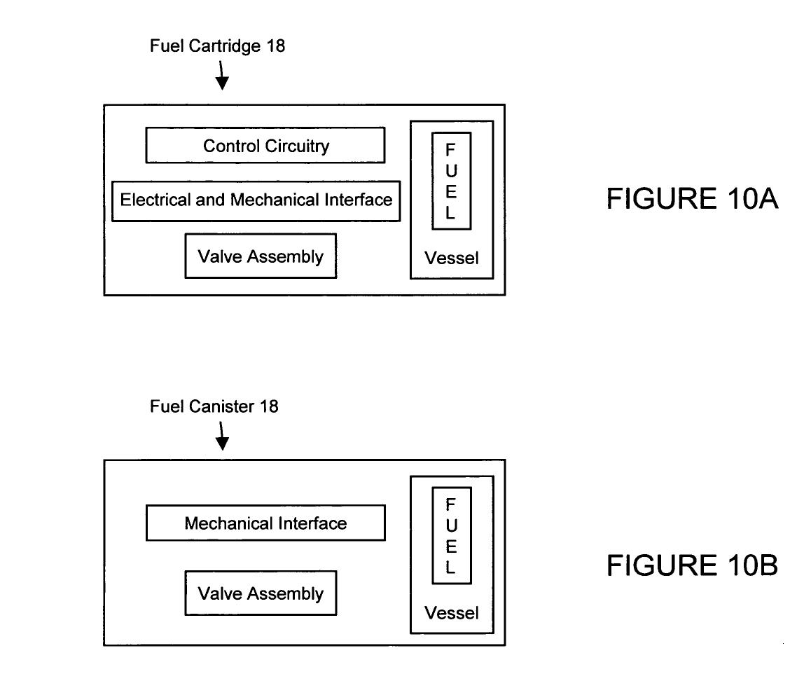

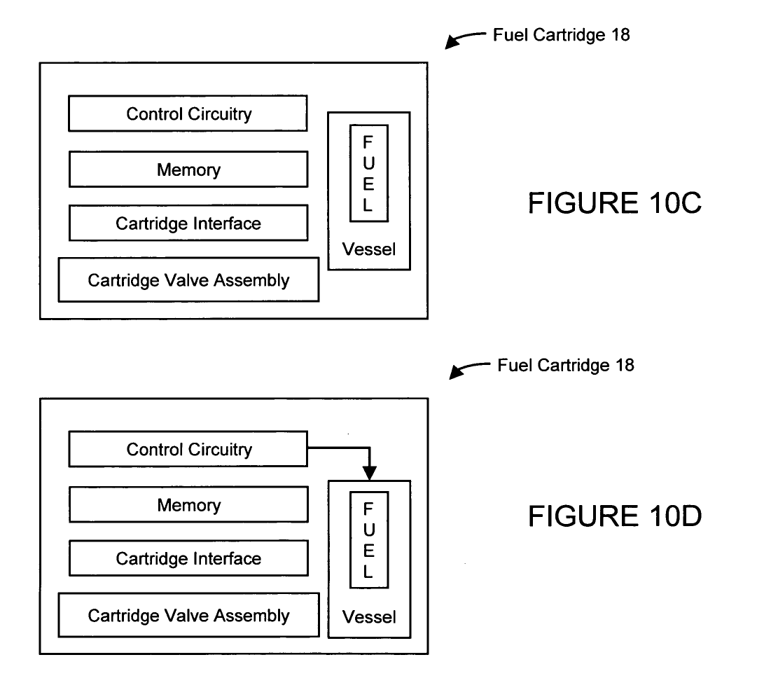

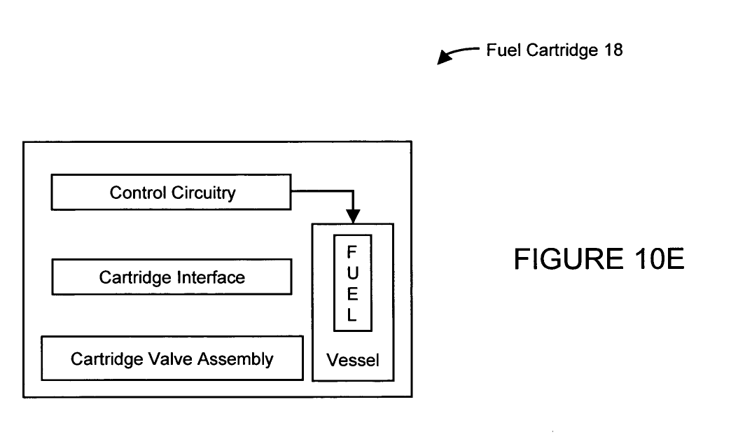

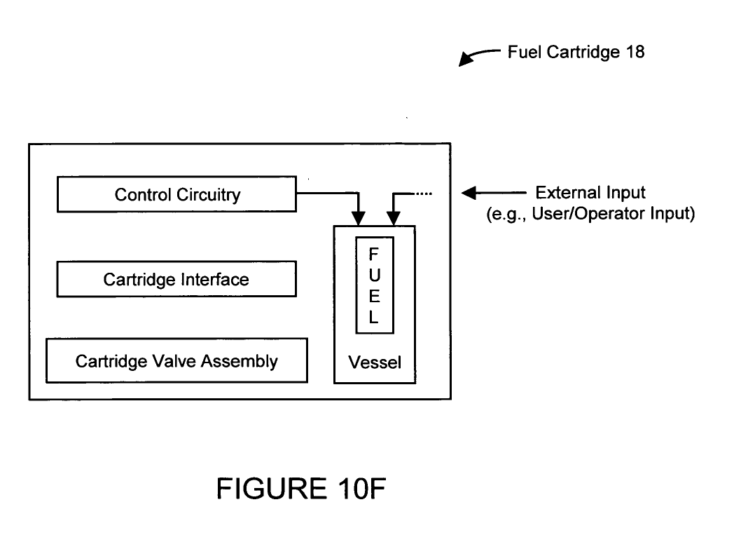

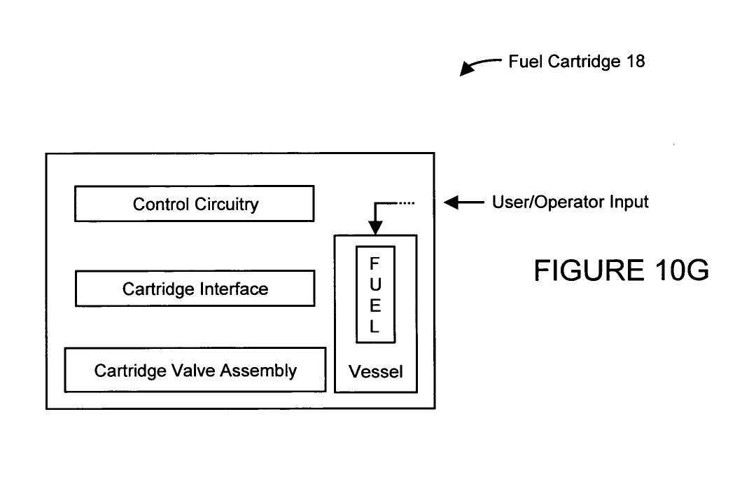

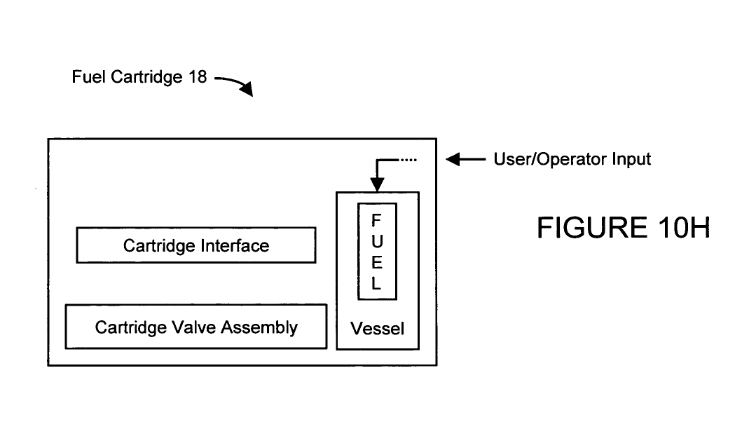

The fuel storage canisters or cartridges may be any type of unit that stores and provides a fuel (in the form of a fluid (whether in a gas or liquid form), for example, hydrogen) whether now known or later developed. In one embodiment, an exemplary fuel storage cartridge 18 includes an interface, a valve assembly and electrical circuitry to maintain, store and/or monitor one or more characteristics and/or operating parameters (for example, the type of fuel, the fuel capacity, the state of fill, maximum flow rate, minimum flow rate, start-up time (if any), shut-down time (if any), required instructions/voltages and/or the number of refill operations the canister or cartridge has undergone) of the fuel cartridge. (See, for example, FIG. 10A). In one embodiment, an exemplary fuel canister 18 includes a mechanical interface, a valve assembly and a fuel vessel to store or maintain a fuel. The fuel canister does not include electrical circuitry. (See, for example, FIG. 10B). The fuel canisters or cartridges may include one or more (or all) of the mechanisms (for example, valve assemblies), designs (for example, the mechanical interface design), fuel types, features, circuits, functions and operation/control techniques of any embodiment of the fuel cartridge module described and/or illustrated in the Fuel Cell Power and Management System Patent Application and/or the Modular Fuel Cell Power System Patent Application.

In one embodiment, the mechanical interface, electrical interface and fluid interface of the fuel storage canisters or cartridges connect to reciprocal interfaces on the dock-type device/unit. In another embodiment, an adapter may be employed to interconnect one or more interfaces of the fuel storage canisters or cartridges to the one or more of the corresponding interfaces of the dock-type device/unit. In this regard, the electrical, mechanical and/or fluid interface of the dock-type device/unit may not reciprocate with the corresponding interface of the fuel storage canisters or cartridges. As such, an adapter may be employed to provide suitable interconnection of the electrical, mechanical and/or fluid paths. In this way, although the interface of the fuel cartridge or canister may be different from the interface of the dock-type device/unit, the dock-type device/unit may make suitable interconnection and/or communication with such fuel cartridge or canister (for example, include a reciprocal or “mating” interface).

The electrical circuitry of the fuel storage cartridge, in one embodiment, includes memory and/or control circuitry to maintain, store and/or monitor one or more characteristics and/or operating parameters (for example, the type of fuel, the fuel capacity, the state of fill) of the fuel cartridge 18. (See, for example, FIG. 10C). The control circuitry may include circuitry to activate the fuel in the vessel or enable the flow of fuel from the vessel to the interface/valve assembly. (See, for example, FIG. 10D). In this regard, the control circuitry may receive a command to activate or enable the availability of the fuel (for example, a sodium borohydride in the vessel. (See, for example, FIG. 10E). The command or instruction may be issued from control circuitry in/on the dock-type unit and/or external thereto (for example, a user/operator or an external device such as a computer). (See, for example, FIGS. 10F-10H).

Notably, where the control circuitry in/on the dock-type unit and/or external thereto (for example, user/operator or an external device such as a computer) inputs the command, the user/operator may activate or enable the availability of the fuel via a mechanism such as a switch or button or issuing an electrical signal via an external device. Where the command or instruction is issued by the control circuitry in/on the dock-type unit and/or an external device, such command or instruction may be issued, for example, via wireless (for example, optical (such as IR), RF or inductive coupling) and/or wired communications. As mentioned above, in one embodiment, the fuel canisters or cartridges may include one or more (or all) of the mechanisms, designs, types, features, functions and operation/control techniques of any embodiment of the fuel cartridge module described and/or illustrated in the Fuel Cell Power and Management System Patent Application and/or the Modular Fuel Cell Power System Patent Application.

Thus, the type of fuel stored in the vessel may include, but are not limited to:
Metal-Hydrides
Sodium Borohydride;
Ammonia Borane;
Methanol Reformer; and
Other fuels such as diesel, propane, butane, kerosene, etc reformers.

Notably, a fuel storage canister or cartridge may include practical limitations regarding maximum and/or minimum fuel delivery rates. For example, a metal hydride and ammonia borane canister or cartridge may include a maximum flow rate limitation/consideration and no limitation/consideration pertaining to a minimum flow rate. In contrast, sodium borohydride or reformer type systems often have both maximum and minimum flow rate limitations/considerations. Indeed, in a fuel storage canister or cartridge containing sodium borohydride, because the internal reactor is heated by sodium borohydride delivery and/or hydrogen generation, where the hydrogen generation rate is too “low”, the internal reactor temperature will drop to an unacceptably level, thereby slowing or stopping the generation of hydrogen. Such circumstances may be factors when considering a fuel cell power unit which includes a maximum power rating and/or a minimum desired power input (which is typically based on reliability issues at low environmental temperatures or balance of plant losses). In these situations, control circuitry in/on the dock-type device/unit may “handshake” with both fuel cells and fuel cartridges to optimize operating conditions. For example, where the fuel cell power unit requires hydrogen sufficient to output 100 W and two fuel storage canisters or cartridges are connected to the dock-type device/unit that, singly, are capable of providing an amount of fuel whereby the fuel cell power unit is capable of generating only 75 W and at a desired minimum of 10 W, the dock-type device/unit would employ both cartridges to support the 100 W load.

Notably, if at some period of time, the fuel cell power unit is outputting 15 W using the same configuration, the dock-type device/unit may adjust the operating configuration to use one fuel storage canisters or cartridges, for example, to avoid operating the fuel storage canisters or cartridges at too low of an output level. In this embodiment, the dock-type device/unit may communicate with the fuel storage canisters or cartridges or measure the outputs thereof to determine the hydrogen flow requirement. In addition, the dock-type device/unit may communicate with the fuel storage canisters or cartridges and/or measure or sense the parameters of each fuel storage canister or cartridge to match multiple the fuel storage canisters or cartridges configuration and operation to the operating requirements of the fuel cell power unit (or components thereof).

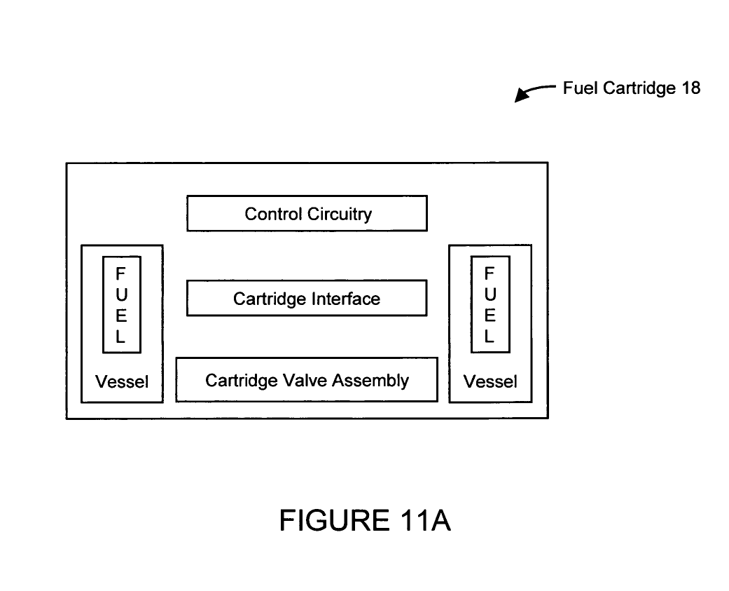

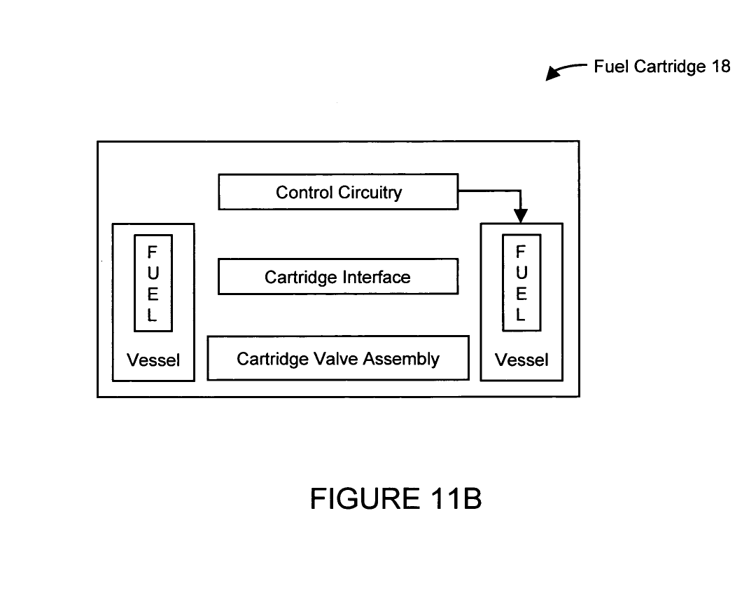

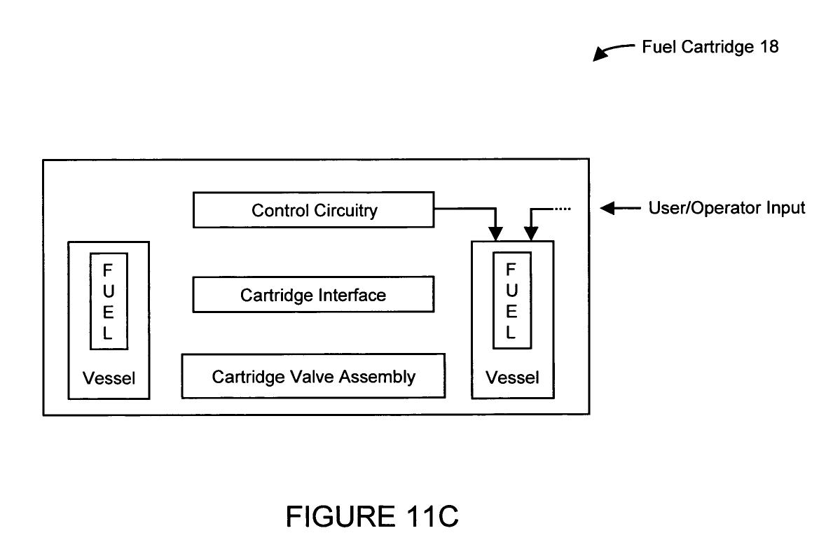

The fuel storage canister or cartridge 18 may include a plurality of vessels, each containing one or more fuels. (See, for example, FIGS. 11A-11C). The fuel vessels may store or contain the same or different types of fuels. The vessels may have the same or different capacities (i.e., store the same or different amount of fuel), and/or may store the fuel in the same or different forms. Moreover, such fuel storage canister or cartridge allows sequential or simultaneous use of the fuels in the plurality of vessels. Notably, the fuel storage canister or cartridge having a plurality of vessels may include or employ any or all of the features of the embodiments described herein with respect to fuel storage canister or cartridge having one fuel vessel. For the sake of brevity, those discussions will not be repeated and are incorporated herein by reference.

In operation, the fuel cell power unit generates electrical power via fuel provided by one or more fuel storage canisters or cartridges connected to the dock-type device/unit. One or more external devices (for example, computer(s), construction equipment and/or communication equipment) may then use the electrical power generated by the fuel cell power unit via connection to the external output power interface.

At start-up or during an initialization process, the control circuitry of the dock-type device/unit may receive information from the fuel cell power unit and one or more of the fuel storage canisters or cartridges. In this regard, such control circuitry may request or receive data which is representative of the operating parameters or characteristics of the fuel cell power unit (or components thereof) including suitable/permissible/required fuel type(s), fuel consumption rate, maximum consumption rate of the fuel, minimum consumption rate of the fuel, maximum power, minimum power, start-up time, and shut-down time. In addition, the control circuitry may request or receive data which is representative of one or more unique characteristics of the fuel storage canister(s) or cartridge(s). In this regard, the characteristics may include at least one of a serial number of the canister or cartridge, date of manufacture and/or assembly thereof, the type of fuel contained in fuel storage canister or cartridge and capacity thereof, maximum flow rate, minimum flow rate, start-up time (if any), shut-down time (if any), and/or required instructions/voltages. With this information, the control circuitry may provide an enhanced, optimum, pre-programmed and/or suitable performance of the system.

In one embodiment, the fuel canister(s) or cartridge(s) may populate or connect to any of the interfaces of the dock-type device/unit. As noted above, the fuel canisters or cartridges may have the same or different fuel quantity (i.e., store the same or different amount of fuel), may have the same or a different type of fuel, and/or may store the fuel in the same or different forms. The control circuitry of the dock-type device/unit may receive, detect and/or store information regarding the particular characteristics of the fuel storage canisters or cartridges connected thereto in order to facilitate orderly operation. For example, such information may be obtained by the control circuitry when the fuel storage canisters or cartridges engage the dock-type device/unit. Notably, the control circuitry may poll the individual interfaces of the dock-type device/unit to detect the population of the interface and/or may detect a fuel canisters or cartridges upon connection to an interface of the dock-type device/unit. Indeed, the control circuitry of the dock-type device/unit may employ any detection technique whether now known or later developed; all such techniques are intended to fall within the scope of the present invention.

Upon detecting the presence of a fuel canister or cartridge connected to the interface of the dock-type device/unit, the control circuitry may request or receive one or more unique characteristics of the fuel storage canister or cartridge. The characteristics may include at least one of a serial number of the canister or cartridge, date of manufacture and/or assembly thereof, the type of fuel contained in fuel storage canister or cartridge and capacity thereof, maximum flow rate, minimum flow rate, start-up time (if any), shut-down time (if any), required instructions/voltages and/or the number of refill operations the canister or cartridge has undergone. The data which is representative of one or more characteristics of the fuel storage canister or cartridge may be accessed by or provided to the control circuitry as described above. For the sake of brevity, such discussions will not be repeated.

Notably, the interface unit (for example, the control circuitry therein/thereon) may detect the presence of a canister or cartridge using any technique whether now known or later developed. For example, the canister or cartridge may be detected using direct techniques, for example, detection of the canister's or cartridge's engagement of the electrical and/or fluid buses. In addition thereto, or in lieu thereof, indirect techniques may be employed including one or more pressure, contact, inductive, optical, magnet/reed switches and/or magnet or Hall-effect sensors may detect a canister or cartridge populating or connecting to an interface of the dock-type device/unit.

The system (for example, the control circuitry resident on/in the dock-type device/unit) may implement sequential or simultaneous use of fuel in one or more fuel canisters or cartridges. Such use may be temporally based in that during a first time the system implements a sequential use of the fuel in the fuel canisters or cartridges and during a second time, the system implements a simultaneous use of the fuel in the fuel canisters or cartridges. Such use may be based on a fuel-type. For example, in one embodiment, when all fuel storage canisters or cartridges are connected in parallel, those having metal-hydrides may be accessed first and consumed first and thereafter other fuel technologies may be selected sequentially. All permutations and combinations are intended to fall within the scope of the present inventions.

During operation, the state of fill of the fuel storage canister(s) or cartridge(s) may be monitored and/or controlled via the control circuitry (for example, a controller or processor) in the dock-type device/unit. In addition thereto, or in lieu thereof, the state of fill of the fuel storage canisters or cartridges may be monitored, managed and/or controlled via the control circuitry in the fuel cell power unit. Indeed, the state of fill of a fuel storage canister or cartridge may be monitored, managed and/or controlled by control circuitry resident in the fuel storage canister or cartridge. (See, for example, the Fuel Cell Power and Management System Patent Application).

In one embodiment, control circuitry in the fuel cell power unit determines the state of fill, decrements the state of fill and provides that information to the control circuitry (for example, controller or processor) in/on the dock-type device/unit. In response, the control circuitry of the dock-type device/unit determines (based on, for example, individual canister state of fill, as well as other factors) the amount of fuel that is delivered by each canister or cartridge attached to the dock-type device/unit, and decrements the state of fill of the associated canister or cartridge accordingly.

The fuel storage canister or cartridge may provide the “initial” state of fill to the control circuitry and using that data, the control circuitry may determine, calculate, monitor, manage, maintain and/or control the state of fill of the fuel storage canister or cartridge based on usage and/or operating parameters (for example, pressure and/or temperature). The control circuitry may employ the “initial” state of fill of the fuel storage canister or cartridge to determine an absolute measure, for example, based on an amount of time the fuel storage canister or cartridge has been connected to and providing fuel to fuel cell power unit. (See, for example, FIG. 15). In addition to, or in lieu thereof, in another embodiment, the control circuitry may receive, sample and/or acquire data from sensors (for example, temperature and/or pressure) disposed on, in or near the vessel of the fuel storage canister or cartridge and, using such data, calculate, determine and/or estimate an initial state of fill of fuel in the storage canister(s) or cartridge(s). As noted above, the control circuitry may calculate, determine and/or estimate the state of fill using mathematical relationships, empirical data and/or modeling.

In one embodiment, the control circuitry of the dock-type device/unit may determine, monitor, manage and/or control the state of fill based on an amount of time fuel storage canister or cartridge has been connected to and providing fuel to fuel cell power unit. In another embodiment, in addition to, or in lieu thereof, control circuitry may receive, sample and/or acquire data from sensors (for example, temperature, pressure and/or flow rate type sensors) disposed on, in or near the vessel or output valve of the fuel storage canister or cartridge and, using such data, calculate, determine and/or estimate the state of fill of one or more of fuel storage canisters or cartridges. Again, the control circuitry may calculate, determine and/or estimate the state of fill using mathematical relationships, empirical data and/or modeling. For example, control circuitry may obtain data which is representative of the temperature and pressure of the fuel in the fuel storage canister or cartridge and, based thereon, calculate/estimate the amount of fuel in the vessel.

In another embodiment, the control circuitry may obtain data which is representative of the flow rate of fluid (i) through a valve assembly on/in the fuel storage canister or cartridge, and/or (ii) into the fluid interface and/or manifold of the dock-type device/unit. The sensors may be discrete elements, such as one or more microelectromechanical devices, temperature sensors, pressure sensors, and/or flow rate sensors. Such sensors may be integrated into one or more other components of the fuel storage canister or cartridge and/or dock-type device/unit (for example, one or more temperature elements integrated into and disposed within the walls of the fuel vessel of the fuel storage canister or cartridge or in a valve assembly of the fuel storage canister or cartridge and/or interface of the dock-type device/unit. Notably, any type of sensor, whether now known or later developed, which may be employed to provide information to the control circuitry may be implemented herein; indeed, such sensors are intended to fall within the scope of the present inventions.

The control circuitry in the dock-type device/unit may calculate, determine and/or estimate a total or aggregate state of fill of the fuel storage canister(s) or cartridge(s). Such information may be “reported” to, for example, the user/operator and/or the fuel cell power unit. Thus, in this embodiment, the system is capable of determining state of fill of each canister or cartridge attached to the dock-type device/unit as well as determining a total amount of available fuel (or aggregate state of fill of the fuel storage canister(s) or cartridge(s)). The user/operator may access the user/operator interface to obtain the entire state of fill status of the multiple fuel canisters or cartridges and also the state of fill of each individual fuel canister or cartridge. The control circuitry may provide information which is representative of the amount of electrical power which is available for a given configuration. That information may be provided for a given load and/or run time.

Notably, the state of fill calculations by the control circuitry (for example, controller or processor) in the dock-type device/unit may be performed for any combination of fuel storage method or canister capacity. Moreover, under those circumstances where the fuel storage technologies require start-up power, the system may control the start-up of fuel delivery by providing power to one or more canisters or cartridges and/or by sending a start control signal to such canisters or cartridges. As discussed above, the command or instruction may activate the fuel in the vessel or enable the flow of fuel from the vessel to the interface/valve assembly. (See, for example, FIGS. 10D-10F).

In one embodiment, fuel from each canister or cartridge attached to the dock-type device/unit may be delivered to the fuel cell power unit in a free flowing manner or in a controlled manner. Where the fuel is allowed to flow freely from the canisters or cartridges to the fuel cell power unit, the proportion of the total fuel flow delivered by each cartridge or canister is inferred by the control circuitry (for example, by the logic of the controller or processor) of the dock-type device/unit. The control circuitry may estimate the amount of fuel delivered by each cartridge or canister based on the amount of fuel in each cartridge or canister. In this regard, the amount of fuel in each cartridge or canister is related to the pressure of the fuel being delivered wherein the cartridges or canisters having fuel under the higher pressures will deliver more fuel than cartridges or canisters having fuel under lower pressures. In this embodiment, the control circuitry may estimate the proportional delivery of the total fuel flow by each cartridge or canister based on the relative states of fill of each cartridge or canister.

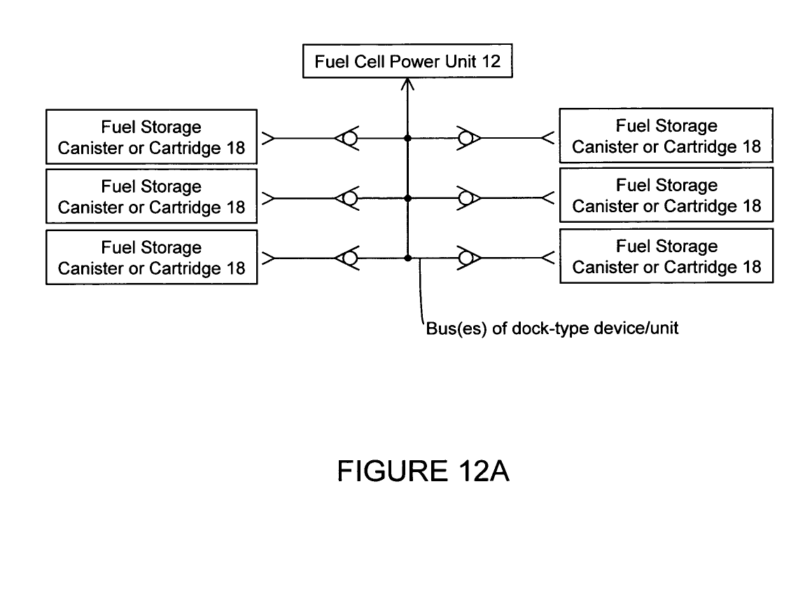

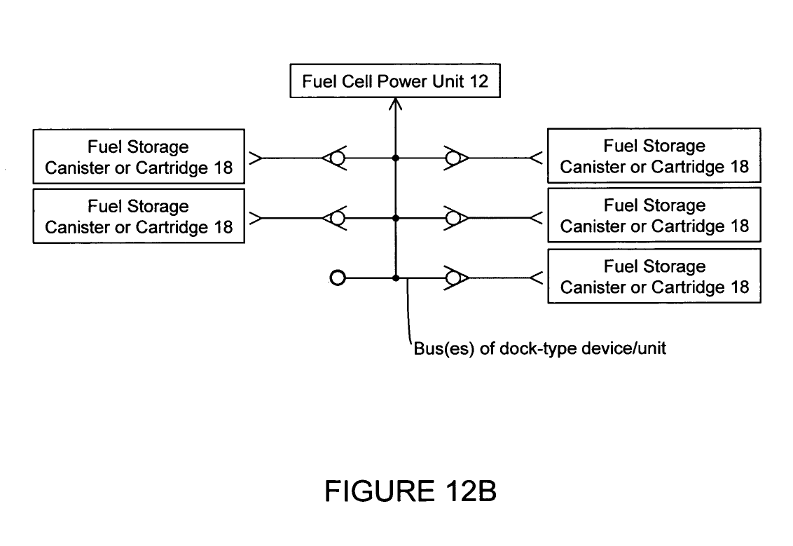

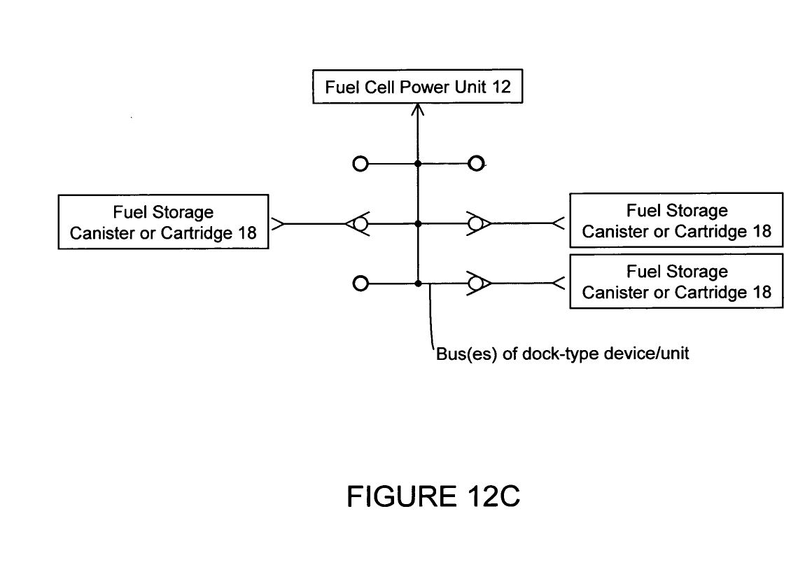

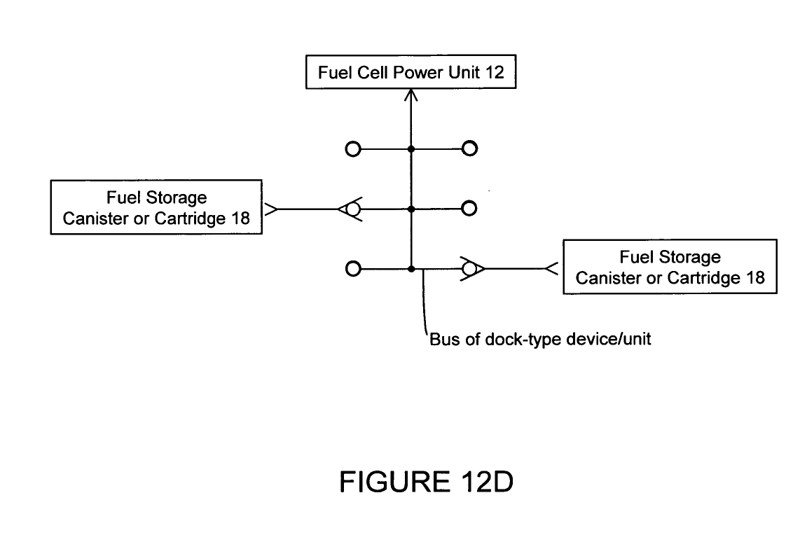

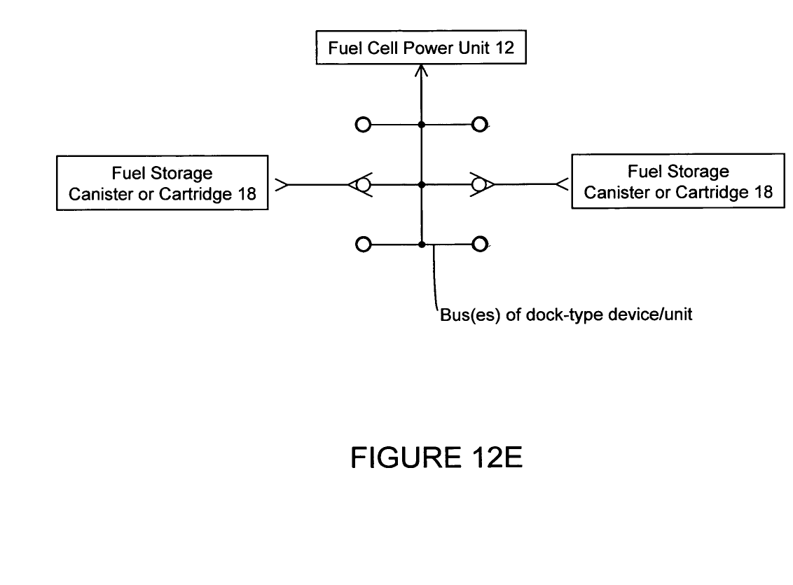

Notably, one-way check valves in the manifold unit may be employed to control the direction of the fluid flow as well as isolate each canister or cartridge. Among other things, in this way, an accurate individual canister state of fill knowledge is maintained; and so that less than M canisters or cartridges 18 may be connected to the dock-type device/unit without fuel escaping from unused interface ports. (See, for example, FIGS. 12A-12E).

Notably, the control circuitry (for example, controller or processor) resident in or on the dock-type device/unit may include one or more (or all) of the designs, types and/or features, as well as perform one or more (or all) of the functions and operation/control techniques of any embodiment of the resident controller described and illustrated in the Modular Fuel Cell Power System Patent Application. For the sake of brevity, those discussions/illustrations will not be repeated but are incorporated by reference herein.

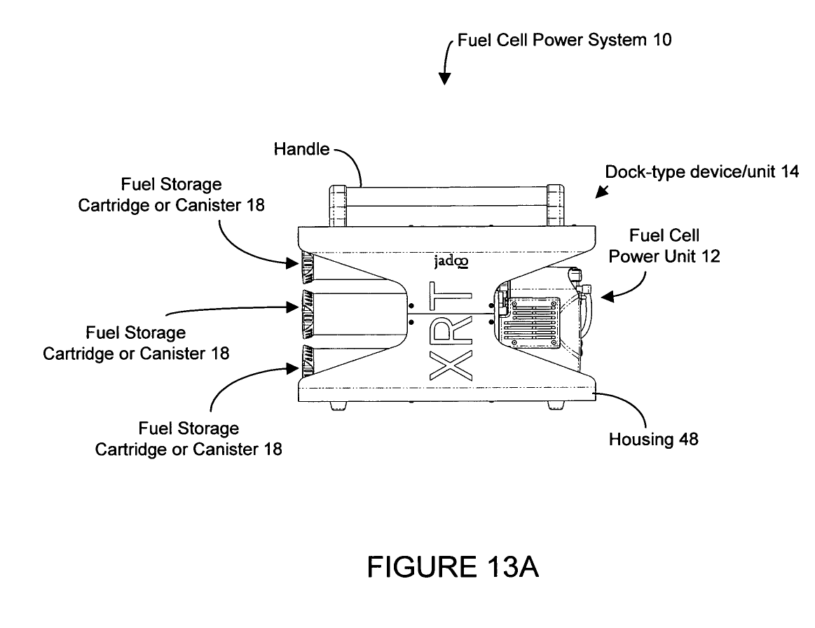

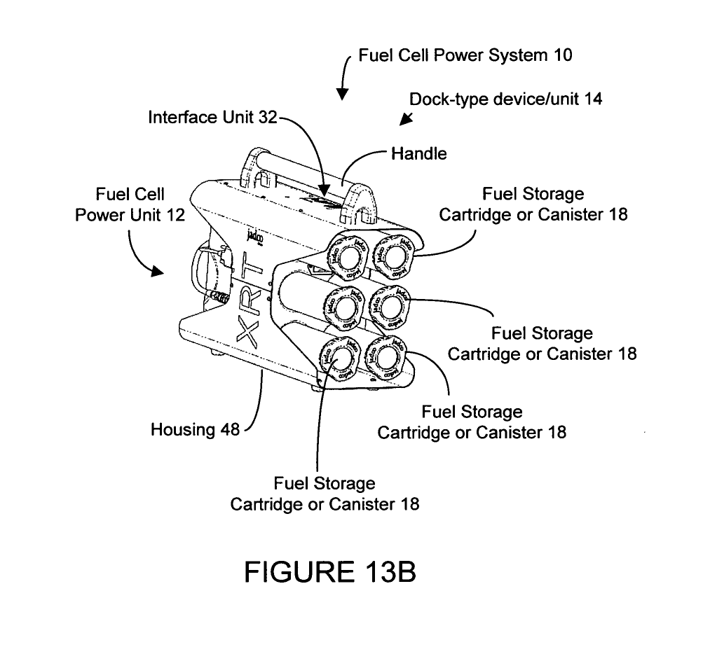

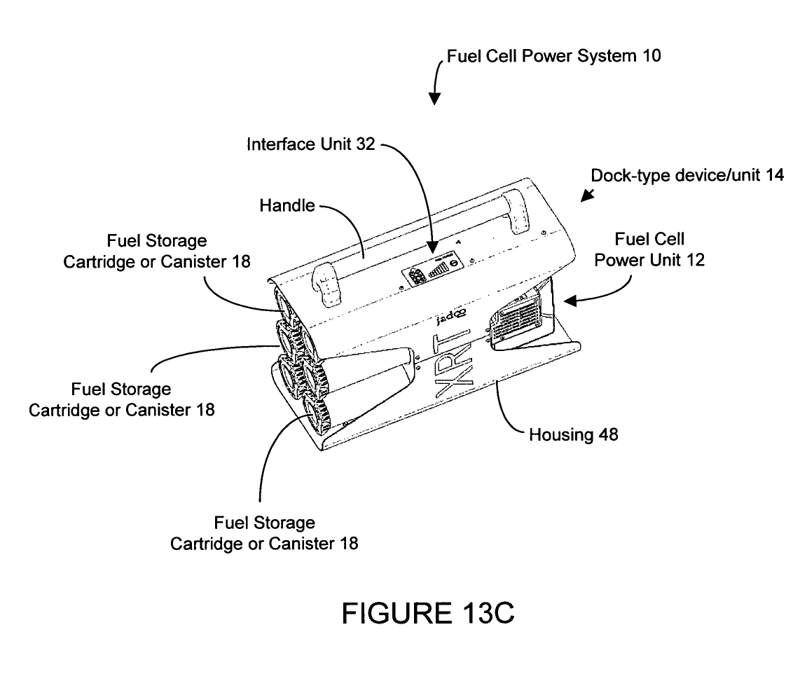

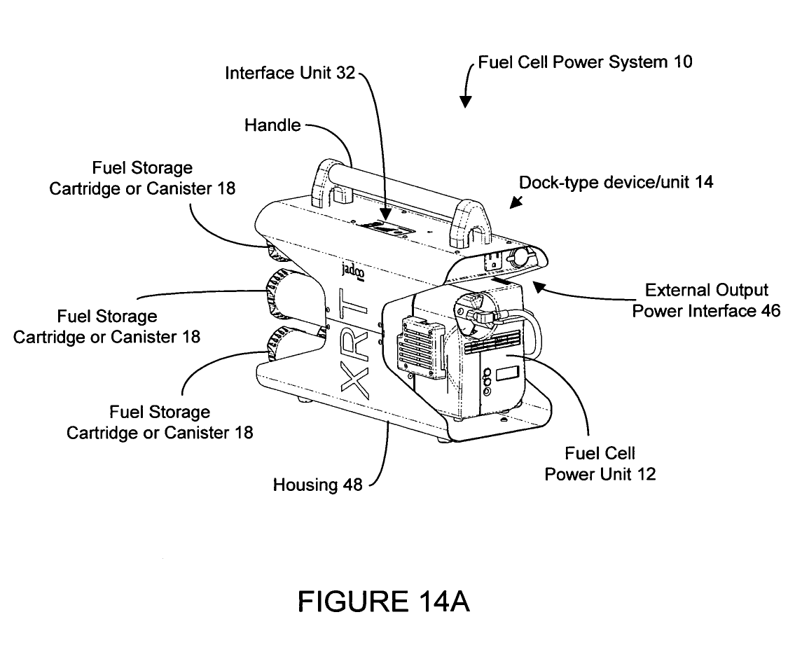

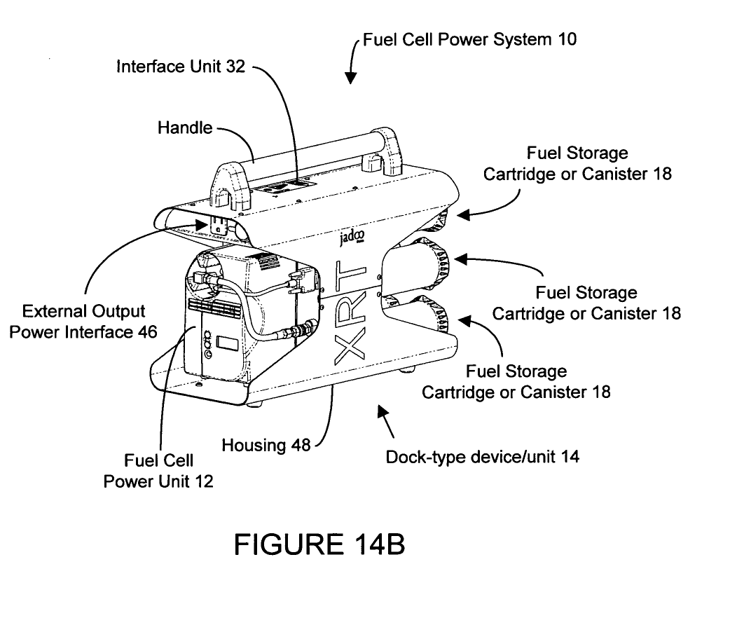

With reference to FIGS. 13A-13C, 14A and 14B, in one exemplary embodiment, the dock-type device/unit 14 includes an electrical, mechanical and fluid interface that connects directly to a reciprocal interface disposed on the fuel cartridge or canister. In this embodiment, the dock-type device/unit includes six interfaces to connect to no more than six fuel storage canisters or cartridges 18. Notably, the dock-type device/unit 14 may employ any interface described and/or illustrated in the Fuel Cell Power and Management System Patent Application. (See, FIG. 1C).

In this exemplary embodiment, the chassis or housing 48 may be constructed of 0.060″ 6061-T6 aluminum sheet metal. Moreover, the chassis or housing 48 is designed to fully encompass all parts of the system in order to protect up to six fuel storage canisters or cartridges 18 and a fuel cell power unit 12 from impact as well as provide a compact, portable and/or configurable fuel cell power system 10. Indeed, the chassis or housing 48 may include wheels (not illustrated) to enhance the portability of the system.

Further, in this exemplary embodiment, the system includes a voltage and power conditioning unit. In this regard, the fuel cell power unit generates outputs ranging from 11.5V to 17.5V. The voltage and power conditioning unit may limit the voltage to 14V DC as well as provide a separate 110V or 220V AC output.

There are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein.

Indeed, the above embodiments of the invention are merely exemplary. They are not intended to be exhaustive or to limit the inventions to the precise forms, techniques, materials and/or configurations disclosed. Many modifications and variations are possible in light of this disclosure. It is to be understood that other embodiments may be utilized and operational changes may be made without departing from the scope of the present invention. As such, the scope of the invention is not limited solely to the description above because the description of the above embodiments has been presented for the purposes of illustration and description.

For example, the system may include over pressure relief mechanisms/features for fuel cell protection. In addition thereto, or in lieu thereof, a pressure or temperature relief mechanism/feature may be integrated into the fuel storage canister or cartridge. (See, for example, the Fuel Cell Power and Management System Patent Application). Moreover, the fuel cell power unit (and/or components thereof, such as the fuel cell stack and/or the conditioning circuitry) may be a modular-type component or an integrated-type component relative to the dock-type device/unit.

In addition, in a significant portion of this disclosure many of the control, management, monitoring and calculating operations are performed by control circuitry in the dock-type device/unit. Such operations may be accomplished by control circuitry in the fuel cell power unit, one or more of the fuel storage cartridges, and/or by external circuitry (for example, circuitry connected to an external connector). Thus, such operations may be performed in the control circuitry in the dock-type device/unit, the fuel cell power unit, one or more of the fuel storage cartridges, and/or by external circuitry. In addition thereto, or in lieu thereof, such operations may be distributed to the control circuitry in the dock-type device/unit, the fuel cell power unit, one or more of the fuel storage cartridges, and/or by external circuitry. All permutations and combinations are intended to fall within the scope of the present inventions.

Further the control circuitry may be distributed in one or more of the dock-type device/unit, the fuel cell power unit, one or more of the fuel storage cartridges, and/or by external circuitry. For example, functionality of the routines or programs may be combined or distributed in circuitry in one or more of the dock-type device/unit, the fuel cell power unit, one or more of the fuel storage cartridges, and/or by external device. Again, all permutations and combinations are intended to fall within the scope of the present inventions.

There are many inventions described and illustrated herein. While certain embodiments, features, materials, configurations, attributes and advantages of the inventions have been described and illustrated, it should be understood that many other, as well as different and/or similar embodiments, features, materials, configurations, attributes, structures and advantages of the present inventions that are apparent from the description, illustration and claims are possible by one skilled in the art (after consideration and/or review of this disclosure). As such, the embodiments, features, materials, configurations, attributes, structures and advantages of the inventions described and illustrated herein are not exhaustive and it should be understood that such other, similar, as well as different, embodiments, features, materials, configurations, attributes, structures and advantages of the present inventions are within the scope of the present inventions.

Each of the aspects of the present inventions, and/or embodiments thereof, may be employed alone or in combination with one or more of such aspects and/or embodiments. For the sake of brevity, those permutations and combinations will not be discussed separately herein. As such, the present inventions are not limited to any single aspect or embodiment thereof or to any combinations and/or permutations of such aspects and/or embodiments. Moreover, each of the aspects of the present inventions, and/or embodiments thereof, may be employed alone or in combination with one or more of such other aspects and/or embodiments.

As mentioned above, the interface of the dock-type device/unit may include an electrical bus may facilitate electrical communication between (i) control circuitry in/on the dock-type device/unit and one or more fuel cell canisters or cartridges, (ii) control circuitry in the fuel cell power unit and one or more fuel cell canisters or cartridges, and/or (iii) control circuitry in/on the dock-type device/unit and control circuitry in the fuel cell power unit. The electrical bus may be any type or architecture whether now known or later developed (for example, point-to-point, multiplexed, non-multiplexed, distributed, dedicated, etc). Indeed, the electrical bus may be comprised of a plurality of discrete busses, for example, a first bus connected between control circuitry in/on the dock-type device/unit and the fuel cell power unit and one or more other buses connected between control circuitry and one or more fuel cell canisters or cartridges.

Also mentioned above, the fluid bus of the interface of the dock-type device/unit provides for fluid input from the fuel storage canisters or cartridges. The fluid bus may also provide for fluid output from the dock-type device/unit. For example, the fluid employed in a fuel cell power unit such as direct methanol, direct sodium borohydride, or internal reforming fuel cell power unit, may flow both to and from a fuel cell power unit and/or to and from a fuel cell canister or cartridge.

In addition thereto, the fluid bus may also include a heat exchange fluid loop which facilitates heat exchange (removing or adding) with various components of the system (for example, the fuel cell power unit and/or one or more fuel storage canisters or cartridges). In this regard, the fluid (for example, liquid or liquid vapor) in the heat exchange fluid loop may increase or decrease the operating temperature of one or more components of the system. For example, the heat exchange fluid loop may maintain the canisters or cartridges at a relatively constant temperature or within a temperature range to enhance the operation of the system.

Notably, the system may include a thermal management unit (for example, a device/unit which provides or removes heat) to control or maintain the operating temperature of one or more of the components of the fuel cell system. For example, the system may include a hydrogen-powered catalytic heater, fan and heat exchanger for keeping metal hydride canisters warm and operable in cold climates in low power draw conditions. Any type or form of thermal management or exchange unit and/or technique, whether now known or later developed, is intended to fall within the scope of the present inventions.

Notably, in one embodiment, the exhaust of the fuel cell unit may be routed to one or more of components of the fuel cell system to adjust/change the temperature (eliminate heat from or provide heat to) of one or more of such components (for example, a fuel storage canister or cartridge). The exhaust may be coupled to a portion of the fluid bus of the dock-type device/unit and routed to each of the fuel storage canisters or cartridges.

The fuel cell power unit includes one or more fuel cells. In certain embodiments, the fuel cell power unit includes include control circuitry, for example, to control, manage and/or monitor one or more other components of the system (for example, one or more fuel cell canisters or cartridges). In certain embodiments, the fuel cell power unit includes voltage and/or power conditioning circuitry to condition the output electrical power of the one or more fuel cells. In certain embodiments, the fuel cell power unit does not include control circuitry and/or conditioning circuitry.

Notably, as mentioned above, the control circuitry, and the operations performed thereby, may be disposed exclusively in/on the dock-type device/unit or the fuel cell power unit. Alternatively, the control circuitry, and the operations performed thereby, may be distributed in one or more of the dock-type device/unit, the fuel cell power unit, one or more of the fuel storage cartridges, and/or by external circuitry. All permutations and combinations are intended to fall within the scope of the present inventions.

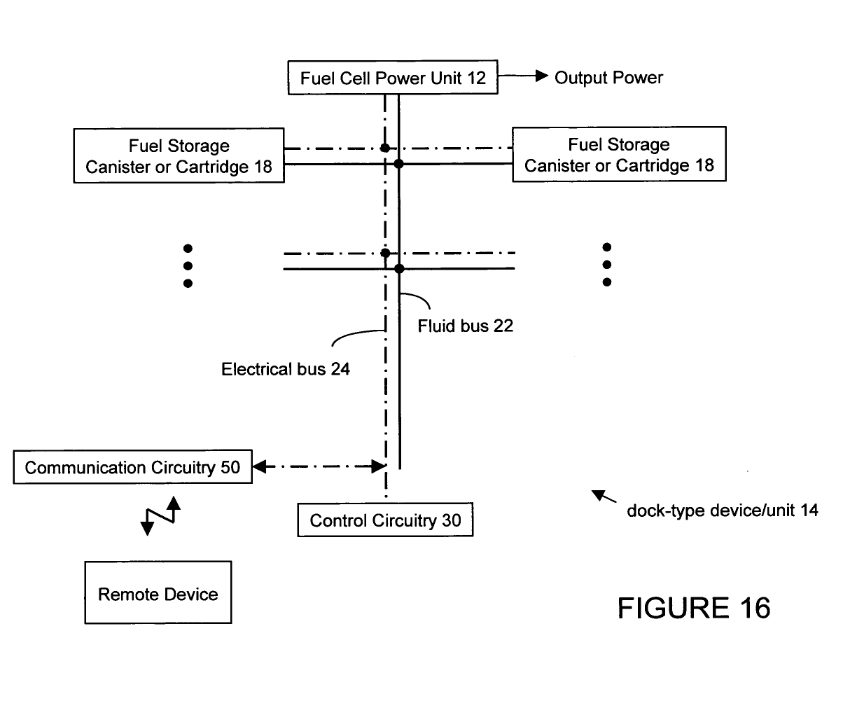

In addition to the external connector, or in lieu thereof, the fuel cell power system of the present inventions may also include communication circuitry to communicate with remote external devices and/or a remote user/operator. The communication circuitry 50 may include, for example, cellular, satellite, line-of-sight RF, optical or internet-based telemetry. (See, for example, FIG. 16). The discussions above with respect to the external circuitry and the user/operator are applicable to the embodiments including communication circuitry to provide communication with remote external devices and/or a remote user/operator. For the sake of brevity, such discussions will not be repeated.

Accordingly, there are many techniques for a user or an operator to access, control and/or manage such functions, operations, or states, all of which are intended to fall within the scope of the present invention. For example, the user/operator may access, control and/or manage such functions, operations, or states using a resident interface. (See, FIG. 5). In another embodiment, the user/operator may access, control and/or manage the operation of the system (or components thereof) remotely, via, for example, communication circuitry. (See, FIG. 16). The user/operator may communicate (locally or remotely) with the control circuitry to obtain operating information, parameters and/or characteristics of the system (or components thereof). Such information may assist the user/operator to control and/or manage the operation of the system (or components thereof).

The dock-type device/unit may include a removable non-volatile memory, for example, a removable memory card containing flash type memory (for example, SD). In this embodiment, the memory card may include data which is representative of the current and/or historical operating characteristics or performance of the system, the state of fill of one or more fuel storage canisters or cartridges.

Moreover, the fuel cell canister or cartridge may also include a removable non-volatile memory to retain/store data which is representative of the current and/or historical operating characteristics/performance of the canister or cartridge. In addition, the removable non-volatile memory may also retain/store data which is representative of one or more unique characteristics of the fuel storage canister or cartridge, for example, the serial number of the canister or cartridge, date of manufacture and/or assembly thereof, the type of fuel contained in fuel storage canister or cartridge and capacity thereof, maximum flow rate, minimum flow rate, start-up time (if any), shut-down time (if any), required instructions/commands/voltages, and/or the number of refill operations the canister or cartridge has undergone. As noted above, the one or more unique characteristics may also include a data log of the operation of the fuel cell unit and/or system during the “life” of that canister or cartridge, as well as a data log of operating parameters of that canister or cartridge (temperatures, pressures, etc) to, for example, debug canister or cartridge or other components of the system in the event of a failure.

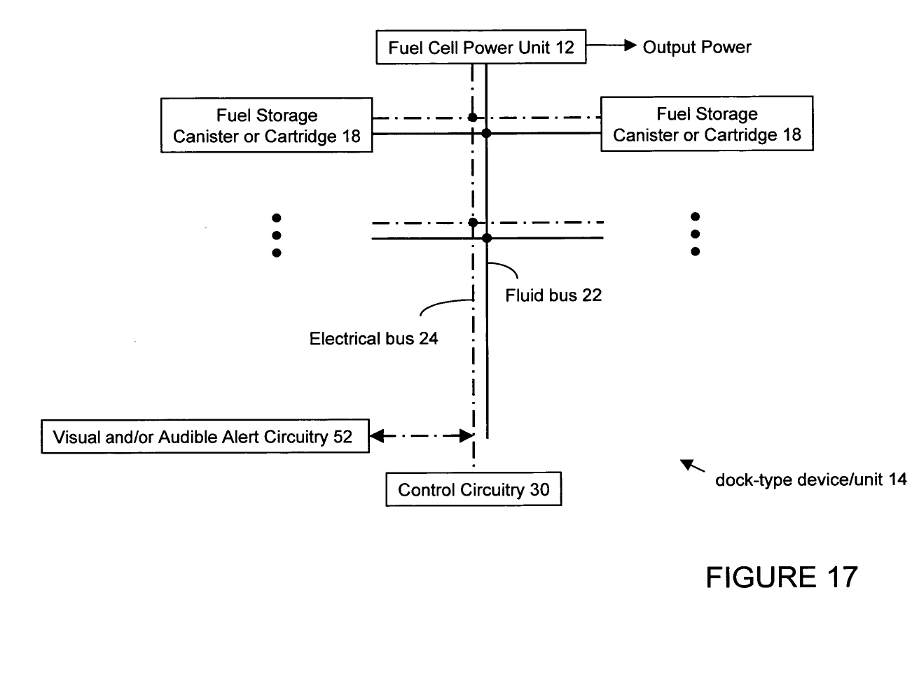

In another embodiment, the system includes visual and/or audible alert circuitry 52 to notify, for example, the user/operator or external circuitry of the status of the system (the existence of a fault or failure of the system or component thereof) and/or the current state of the available fuel. (See, for example, FIG. 17). The visual alert circuitry may include a light (for example, blinking LED). The audible alert circuitry may be recorded speech which is representative of the alert and/or a siren-like device.

Although FIGS. 13A-C, 14A and 14B illustrate housing or chassis as a portable, stand-alone unit, the housing or chassis may be any shape or architecture. For example, the housing or chassis may be modular in nature which facilitates implementation into standard modular environments, for example, military, industrial and/or commercial mounting systems (such as a standard 19″ rack mount system).

Notably, in one embodiment, the output power of the system including the dock-type device/unit may be coupled to another power source, for example, the power grid, a battery, solar power generating unit and/or wind power generating unit. In this embodiment, the system may serve as a back-up to the other power generating source(s), for example, to accommodate the start-up time of the one or more power sources. The system may also supplement the output of other power source(s), for example, during a peak loading condition or in the event of a failure of one or more other power source(s).

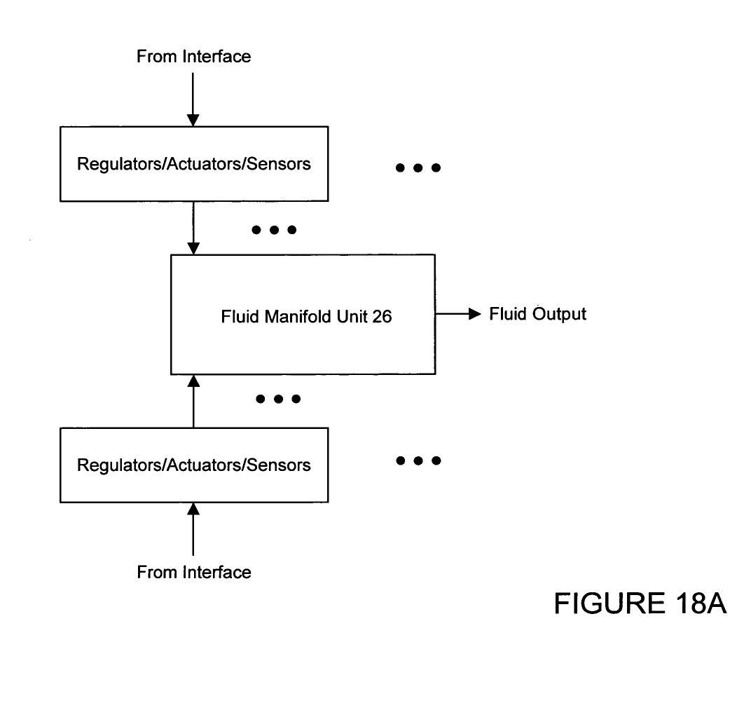

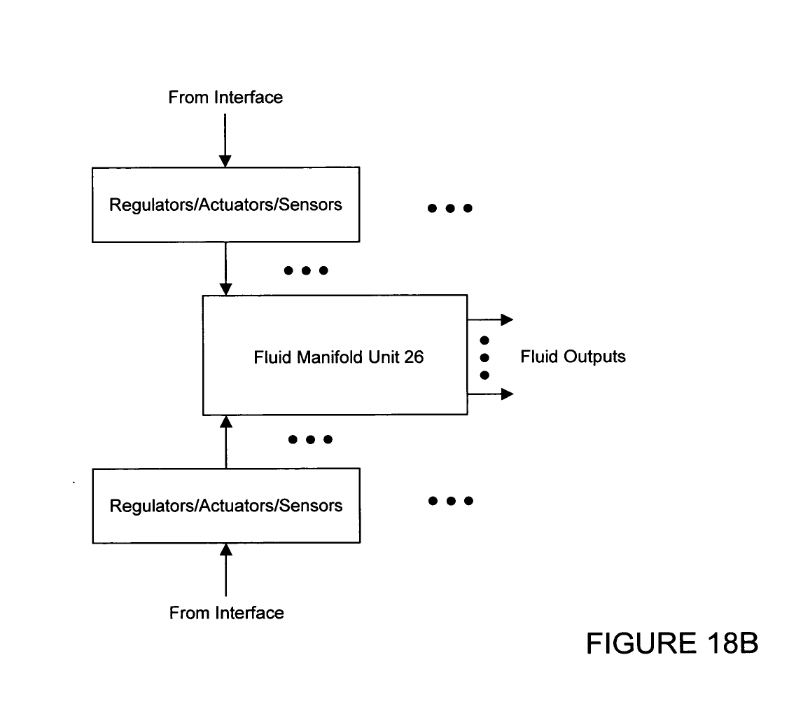

Further, the system may include fluid/fuel flow control, sensing and/or regulating devices/mechanisms (for example, electrically controlled valves) that are disposed within the fluid path of one, some or all of the fuel storage canisters or cartridges. In this way, the control circuitry may control the fuel flow therefrom. For example, such devices/mechanisms may be disposed in the fluid interface of the dock-type device/unit. The devices/mechanisms may also be disposed further “upstream”, for example, in a fluid manifold (see, for example, FIGS. 3C-3G) or before the input of a fluid manifold (see, for example, FIGS. 18A and 18B). Indeed, as indicated above, in another embodiment, the fuel flow control device may be disposed within the fuel storage canister or cartridge. In this regard, the fuel flow control device may be a flow value in, for example, a valve assembly of the storage canister or cartridge that is controlled via electrical signals from the control circuitry.

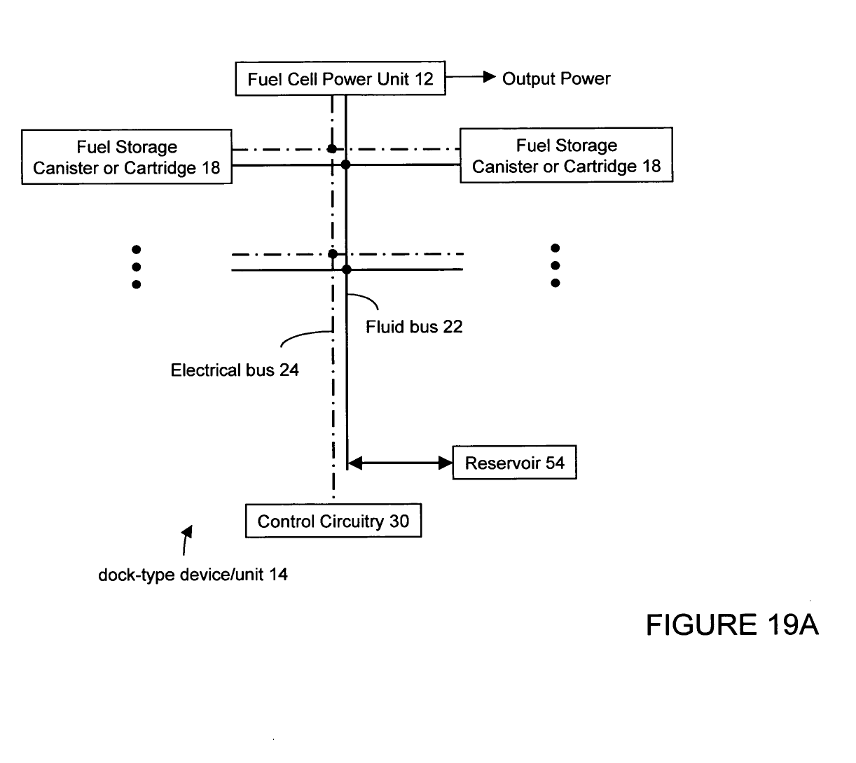

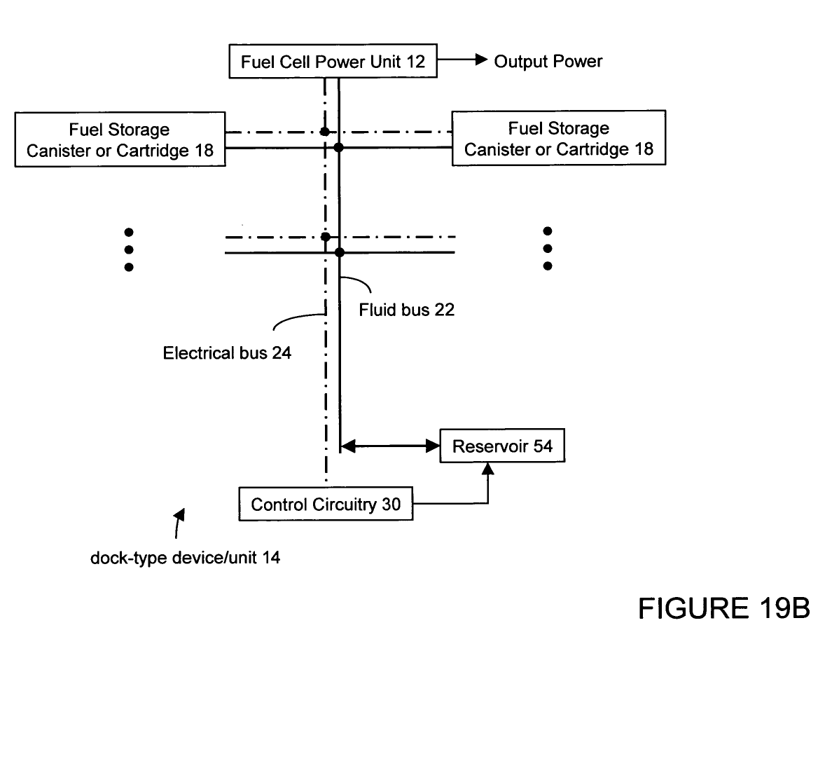

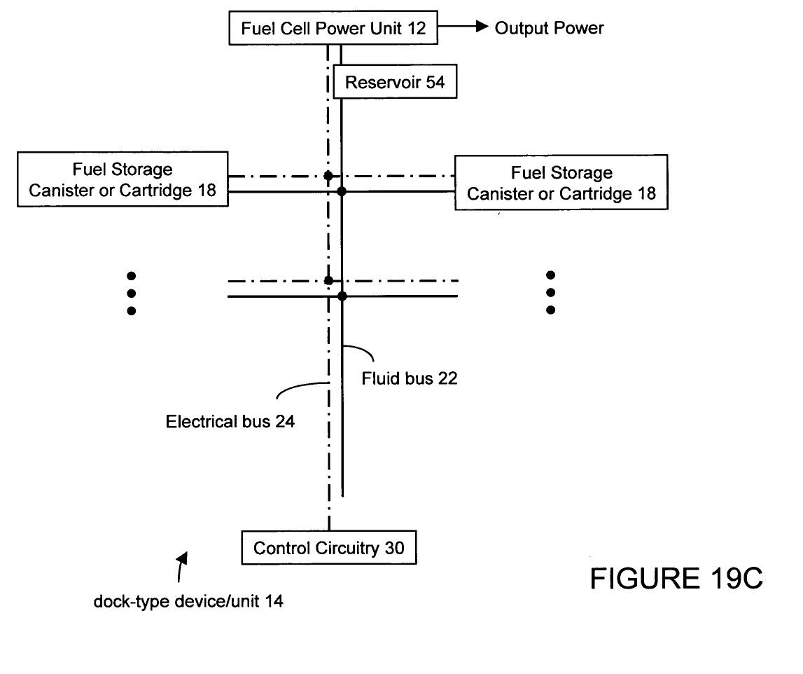

As mentioned above, the system may include a reservoir (for example, bladder, cavity, fixed storage container, and/or fuel storage canister or cartridge). The reservoir 54 may provide the user/operator with a sufficient amount of the time to (i) replace a “spent” or empty canister or cartridge with a “new” canister or cartridge, and/or (ii) to accommodate the “start-up” time for certain fuels that require a measurable start-up time. (See, for example, FIG. 19A). The reservoir 54 may automatically provide fuel to the fuel cell power unit (i.e., without intervention) (see, for example, FIG. 19B) and/or may, in response to commands/instructions from the control circuitry and/or user/operator (via, for example, the user/operator interface unit or communication circuitry, provide fuel to the fuel cell power unit (see, for example, FIG. 19C).

It should be further noted that the term “circuit” may mean, among other things, a single component (analog or digital) or a multiplicity of components (whether in integrated circuit form or otherwise), which are active and/or passive, and/or analog or digital (or combinations thereof), and which are coupled together to provide or perform a desired operation. The term “circuitry” may mean, among other things, a circuit (whether integrated or otherwise), a group of such circuits, one or more processors, one or more state machines, one or more processors implementing firmware/software, or a combination of one or more circuits (whether integrated or otherwise), one or more state machines, one or more processors, and/or one or more processors implementing firmware/software.

The term “conditioning circuitry”, in the claims, means power conditioning circuitry and/or voltage conditioning circuitry, whether alone or in combination.

The above embodiments of the present inventions are merely exemplary embodiments. They are not intended to be exhaustive or to limit the inventions to the precise forms, techniques, materials and/or configurations disclosed. Many modifications and variations are possible in light of the above teaching. It is to be understood that other embodiments may be utilized and operational changes may be made without departing from the scope of the present inventions. As such, the foregoing description of the exemplary embodiments of the inventions has been presented for the purposes of illustration and description. It is intended that the scope of the inventions not be limited to the description above.

What is claimed is:

1. A fuel cell power system comprising:
a plurality of removable fuel storage cartridges, each cartridge having a vessel to store hydrogen; and
a dock-type unit comprising,
a fluid bus;
an electrical bus;
a plurality interfaces, each interface including a fluid portion coupled to the fluid bus and an electrical portion coupled to the electrical bus, wherein the each fuel storage cartridge is coupled to an associated interface;
a fuel cell power unit, including a plurality of hydrogen fuel cells, connected to the fluid bus to (i) concurrently receive hydrogen from the plurality of fuel storage cartridges and (ii) generate unconditioned electrical power using the hydrogen; and
control circuitry, disposed in/on the dock-type unit and electrically coupled to the fuel storage cartridges via the electrical bus, to monitor the state of fill of each of the fuel storage cartridges during operation of the fuel cell power system.

2. The fuel cell power system of claim 1 wherein the control circuitry monitors the state of fill of each fuel storage cartridge during operation of the fuel cell power system using an initial state of fill provided by the plurality of fuel storage cartridges.

3. The fuel cell power system of claim 1 wherein the control circuitry calculates the state of fill of each fuel storage cartridge during operation of the fuel cell power system using an initial state of fill provided by the plurality of fuel storage cartridges.

4. The fuel cell power system of claim 3 wherein the control circuitry calculates an amount of hydrogen that each fuel storage cartridge outputs during operation of the fuel cell power system using the initial state of provided by the plurality of fuel storage cartridges.

5. The fuel cell power system of claim 4 wherein the each fuel storage cartridge includes a memory and wherein, during operation of the fuel cell power system, the control circuitry stores the state of fill of each fuel storage cartridge in the memory associated with the fuel storage cartridge.

6. The fuel cell power system of claim 5 wherein the control circuitry periodically stores the state of fill of each fuel storage cartridge in the memory associated therewith.

7. The fuel cell power system of claim 1 wherein the control circuitry calculates an amount of hydrogen that each fuel storage cartridge outputs during operation of the fuel cell power system.

8. The fuel cell power system of claim 1 wherein the each fuel storage cartridge includes a memory and wherein, during operation of the fuel cell power system, the control circuitry calculates the state of fill of each fuel storage cartridge and stores the state of fill in the memory associated therewith.

9. The fuel cell power system of claim 8 wherein the control circuitry periodically stores the state of fill of each fuel storage cartridge in the memory associated with the fuel storage cartridge.

10. The fuel cell power system of claim 1 wherein the control circuitry calculates an amount of hydrogen that each fuel storage cartridge outputs during operation of the fuel cell power system.

11. The fuel cell power system of claim 1 wherein the dock-type unit further includes a fluid manifold having a plurality of inputs coupled to the fluid portion of each interface of the dock-type unit and at least one fluid output coupled to the fuel cell power unit to provide hydrogen to fuel cell power unit.

12. The fuel cell power system of claim 1 wherein the dock-type unit further includes at least one pressure regulator, coupled to the fluid bus, to regulate the pressure of the hydrogen input to the fuel cell power unit.

13. The fuel cell power system of claim 1 wherein the dock-type unit further includes a plurality of pressure regulators, wherein at least one regulator is coupled to each fluid portion of the plurality interfaces of the dock-type unit to regulate the pressure of the hydrogen input to the fluid bus from each fuel storage cartridge connected to the plurality interfaces.

14. The fuel cell power system of claim 1 wherein the fuel cell power unit further includes conditioning circuitry, coupled to the plurality of hydrogen fuel cells, to generate conditioned electrical power using the unconditioned electrical power.

15. A fuel cell power system comprising:
a plurality of removable fuel storage cartridges, each cartridge having:
a vessel to store hydrogen; and
a non-volatile memory to store data which is representative of the state of fill of hydrogen in the vessel; and
a dock-type unit comprising,
a fluid bus;
an electrical bus;
a plurality interfaces, each interface including a fluid portion coupled to the fluid bus and an electrical portion coupled to the electrical bus, wherein the each fuel storage cartridge is coupled to an associated interface;
a fuel cell power unit, including a plurality of hydrogen fuel cells, connected to the fluid bus to (i) concurrently receive hydrogen from the plurality of fuel storage cartridges and (ii) generate unconditioned electrical power using the hydrogen; and
control circuitry, disposed in/on the dock-type unit and electrically coupled to the fuel storage cartridges via the electrical bus, to:
calculate the state of fill of each of the fuel storage cartridges during operation of the fuel cell power system; and
store data which is representative of the state of fill of fuel in the vessel of the fuel storage cartridge in the non-volatile memory associated with the fuel storage cartridge.

16. The fuel cell power system of claim 15 wherein the control circuitry calculates the state of fill of each fuel storage cartridge during operation of the fuel cell power system using an initial state of fill provided by the plurality of fuel storage cartridges.

17. The fuel cell power system of claim 16 wherein the initial state of fill of the fuel storage cartridge is stored in the non-volatile memory associated with the fuel storage cartridge.

18. The fuel cell power system of claim 15 wherein the control circuitry calculates an amount of hydrogen that each fuel storage cartridge outputs during operation of the fuel cell power system using the initial state of provided by the plurality of fuel storage cartridges.

19. The fuel cell power system of claim 15 wherein the control circuitry periodically stores the state of fill of each fuel storage cartridge in the non-volatile memory associated therewith.

20. The fuel cell power system of claim 15 wherein the control circuitry calculates an amount of hydrogen that each fuel storage cartridge outputs during operation of the fuel cell power system.

21. The fuel cell power system of claim 15 wherein the dock-type unit further includes a fluid manifold having a plurality of inputs coupled to the fluid portion of each interface of the dock-type unit and at least one fluid output coupled to the fuel cell power unit to provide hydrogen to fuel cell power unit.

22. The fuel cell power system of claim 15 wherein the dock-type unit further includes at least one pressure regulator, coupled to the fluid bus, to regulate the pressure of the hydrogen input to the fuel cell power unit.

23. The fuel cell power system of claim 15 wherein the dock-type unit further includes a plurality of pressure regulators, wherein at least one regulator is coupled to each fluid portion of the plurality interfaces of the dock-type unit to regulate the pressure of the hydrogen input to the fluid bus from each fuel storage cartridge connected to the plurality interfaces.

24. The fuel cell power system of claim 15 wherein the fuel cell power unit further includes conditioning circuitry, coupled to the plurality of hydrogen fuel cells, to generate conditioned electrical power using the unconditioned electrical power.
